(19) United States
(12) Patent Application Publication
(10) Pub. No.: US 2023/0334792 A1
(43) Pub. Date: Oct. 19, 2023

(54) INTERACTIVE REALITY COMPUTING EXPERIENCE USING OPTICAL LENTICULAR MULTI-PERSPECTIVE SIMULATION

(71) Applicant: Mobeus Industries, Inc., Sparta, NJ (US)

(72) Inventor: Dharmendra ETWARU, Sparta, NJ (US)

(21) Appl. No.: 18/073,365

(22) Filed: Dec. 1, 2022

Related U.S. Application Data
(63) Continuation-in-part of application No. 18/072,344, filed on Nov. 30, 2022.
Application No. 18/072,344 is a continuation-in-part of application No. 17/972,586, filed on Oct. 24, 2022.
(60) Provisional application No. 63/399,470, filed on Aug. 19, 2022.
(60) Provisional application No. 63/363,154, filed on Apr. 18, 2022.
(60) Provisional application No. 63/339,084, filed on May 6, 2022.

(51) Int. Cl. G06T 19/00; G06T 7/70; G06T 7/50; G06T 15/20

(52) U.S. Cl. CPC G06T 19/006; G06T 7/70; G06T 7/50; G06T 15/205; G06T 2207/30196; G06T 2207/10016

(57) ABSTRACT

Systems and methods of presenting an immersive virtual environment to a user are disclosed. The system can include processing circuitry, including a processing unit. The processing unit can collect visual data from a visual detection device. An image of a subject can be detected in the visual data. The processor can analyze the image of the subject and obtain orientation data from the analyzed image of the subject. The processor can further retrieve, based on the visual data, one or more digital objects. A projection can be generated, based at least in part on the visual data and the orientation data, and can include one or more layers. The one or more digital objects can be disposed in the one or more layers, and the processor can cause the projection to be displayed. Other aspects, embodiments, and features are also claimed and described.

### CROSS-REFERENCE TO RELATED APPLICATIONS

This application is a continuation-in-part of U.S. application Ser. No. 18/072,344, filed on Nov. 30, 2022, and entitled “INTERACTIVE REALITY COMPUTING EXPERIENCE USING OPTICAL LENTICULAR MULTI-PERSPECTIVE SIMULATION,” which is a continuation-in-part of U.S. application Ser. No. 17/972,586, filed on Oct. 24, 2022, and entitled “IMPLEMENTING CONTACTLESS INTERACTIONS WITH DISPLAYED DIGITAL CONTENT,” which claims the benefit of U.S. Provisional Application No. 63/399,470, filed on Aug. 19, 2022. This application further claims the benefit of U.S. Provisional Application No. 63/339,084, entitled “INTERACTIVE REALITY COMPUTING EXPERIENCE USING OPTICAL LENTICULAR MULTI-PERSPECTIVE SIMULATION TRANSMITTED OVER A COMMUNICATION NETWORK VIA PROCESSING CIRCUITRY”, and filed on May 6, 2022, and further claims the benefit of U.S. Provisional Application No. 63/363,154, entitled “THREE-DIMENSIONAL (3D) MIXED REALITY COMPUTING EXPERIENCE WITH PERCEPTION OF DEPTH”, and filed on Apr. 18, 2022.

### STATEMENT REGARDING FEDERALLY SPONSORED RESEARCH

N/A

### BACKGROUND

### Field of the Disclosure

The present disclosure relates to combining three-dimensional (3D) physical objects and two-dimensional (2D) digital objects into a computing experience that adjusts based on a user's positioning and perspective.

### Description of the Related Art

Displayed data has traditionally been presented within the bounds of a two-dimensional geometric screen. The visual experience of such displayed data is thus lacking in dynamism that allows for the layering of functionality within a given display frame.

The foregoing “Background” description is for the purpose of generally presenting the context of the disclosure. Work of the inventors, to the extent it is described in this background section, as well as aspects of the description which may not otherwise qualify as prior art at the time of filing, are neither expressly or impliedly admitted as prior art against the present disclosure.

### SUMMARY

The foregoing paragraphs have been provided by way of general introduction and are not intended to limit the scope of the following claims. The described embodiments, together with further advantages, will be best understood by reference to the following detailed description taken in conjunction with the accompanying drawings.

According to some embodiments, the present disclosure relates to an apparatus comprising processing circuitry that includes a processing unit. The processing unit is configured to collect visual data from a visual detection device, detect, in the visual data, an image of a subject, analyze the image of the subject and obtain orientation data from the analyzed image of the subject, retrieve, based on the visual data, one or more digital objects, generate, based at least in part on the visual data and the orientation data, a projection comprising one or more layers, the one or more digital objects being disposed within the one or more layers, and cause the projection to be displayed.

According to some embodiments, the present disclosure relates to a method for generating and displaying a mixed reality computing experience with the perception of depth. The method comprises collecting visual data from a visual detection device; identifying, within the visual data, a first image of a first subject; determining, from the first image, first orientation data for the first subject; retrieving, based on the visual data, display data of one or more digital objects; generating a projection comprising one or more layers; and causing the projection to be displayed, wherein each of the one or more layers includes visual content, and wherein the visual content of each of the one or more layers is at least partially determined by the visual data, first orientation data, and the display data for the one or more digital objects.

According to some embodiments, the present disclosure relates to a non-transitory computer-readable storage medium for storing computer-readable instructions that, when executed by a computer, cause the computer to perform a method for generating and displaying a mixed reality computing experience with the perception of depth. The method includes collecting visual data from a visual detection device; identifying, within the visual data, a first image of a subject; determining, from the first image, first orientation data; retrieving, based in part on the visual data, display data of one or more digital objects; generating, based at least in part on the first orientation data, a projection comprising one or more layers, and causing the projection to be displayed, wherein visual content of the one or more layers is at least partially determined by the visual data.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic view of user devices communicatively connected to a server, according to an exemplary embodiment of the present disclosure;

FIG. 2A is a flow chart of a method of generating a reference patch and embedding the reference patch into displayed data, according to an exemplary embodiment of the present disclosure;

FIG. 2B is a flow chart of a sub-method of generating the reference patch, according to an exemplary embodiment of the present disclosure;

FIG. 2C is a flow chart of a sub-method of associating the surface area with secondary digital content, according to an exemplary embodiment of the present disclosure;

FIG. 2D is a flow chart of a sub-method of integrating the reference patch into the displayed data, according to an exemplary embodiment of the present disclosure;

FIG. 3A is a flow chart of a method of inspecting the reference patch, according to an exemplary embodiment of the present disclosure;

FIG. 3B is a flow chart of a sub-method of identifying the reference patch with unique identifiers corresponding to the surface area from the stream of data, according to an exemplary embodiment of the present disclosure;

FIG. 3C is a flow chart of a sub-method of associating the unique identifiers with digital content, according to an exemplary embodiment of the present disclosure;

FIG. 4A is a flow chart of a method of identifying the reference patch included in the displayed data and overlaying the secondary digital content into displayed data, according to an exemplary embodiment of the present disclosure;

FIG. 4B is a flow chart of a sub-method of identifying the reference patch with the unique identifiers corresponding to the surface area from the stream of data, according to an exemplary embodiment of the present disclosure;

FIG. 4C is a flow chart of a sub-method of associating the unique identifiers with digital content, according to an exemplary embodiment of the present disclosure;

FIG. 5A is an illustration of a display, according to an exemplary embodiment of the present disclosure;

FIG. 5B is an illustration of a reference patch within a frame of a display, according to an exemplary embodiment of the present disclosure;

FIG. 5C is an illustration of an augmentation within a frame of a display, according to an exemplary embodiment of the present disclosure;

FIG. 6A is a flow chart outlining a method of generating a projection of a mixed reality display with the perception of depth and perspective adjustment, according to an embodiment of the present disclosure;

FIG. 6B is a flow chart outlining a sub-method for determining user parameters from obtained visual data, according to an embodiment of the present disclosure;

FIG. 6C is a flow chart outlining a sub-method for generating a projection of a 3D mixed reality experience with the perception of depth and perspective adjustment, according to an embodiment of the present disclosure;

FIG. 7A shows a schematic view of a user's perspective of an office, with a corresponding 3D projection of the office from the user's perspective;

FIG. 7B shows a schematic view of a user's perspective of the office of FIG. 7A, with a corresponding 3D projection of the office from the user's perspective, wherein the user's perspective is shifted left relative to the perspective shown in FIG. 7A;

FIG. 7C shows schematic views of an office similar to the office shown in FIG. 7A, illustrating objects in the office within Layers A and B;

FIG. 7D shows a schematic view of a user's perspective of the office of FIG. 7C, with a corresponding 3D projection of the office from the user's perspective;

FIG. 7E shows schematic views of the office shown in FIG. 7C, illustrating objects in the office within Layers U-Z;

FIG. 7F shows a schematic view of a user's perspective of the office of FIG. 7E, with a corresponding 3D projection of the office from the user's perspective;

FIG. 7G shows a schematic view of a user's perspective of an office, with a corresponding 3D projection;

FIG. 7H shows schematic views of a user's perspective of an office, with different fields of view shown for the user's perspective;

FIG. 7I shows a schematic view of a user's perspective of an office, including a focal point, as well as a 3D projection of the office from the user's perspective;

FIG. 7J shows a schematic view of the office shown in FIG. 7I, with a corresponding 3D projection, wherein the focal point is positioned closer to the user relative to the focal point shown in FIG. 7I;

FIG. 7K shows a schematic view of an office illustrating a global perspective, along with a corresponding 3D projection;

FIG. 8 is a schematic of a user device for performing a method, according to an exemplary embodiment of the present disclosure;

FIG. 9 is a schematic of a hardware system for performing a method, according to an exemplary embodiment of the present disclosure;

FIG. 10 is a schematic of a hardware configuration of a device for performing a method, according to an exemplary embodiment of the present disclosure;

FIG. 11 is an example of transparent computing;

FIG. 12 illustrates a system that can be used for managing, manipulating, and merging multiple layers of content, according to an embodiment of the present disclosure;

FIG. 13A shows a schematic of a user in a first orientation relative to a display;

FIG. 13B is a schematic of the user of FIG. 13A in the first orientation relative to the display with a digital object shown in a first position on the display;

FIG. 13C is a schematic of the user of FIG. 13A in a second orientation relative to the display with the digital object shown in a second position on the display;

FIG. 13D is a schematic of the user of FIG. 13A in a third orientation relative to the display with the digital object shown in a third position on the display;

FIG. 14A is a flow chart outlining a method of generating a projection of a mixed reality display with the perception of depth and perspective adjustment, according to an embodiment of the present disclosure;

FIG. 14B is a flow chart outlining a sub-method for determining orientation parameters of a subject from obtained visual data, according to an embodiment of the present disclosure; and

FIG. 14C is a flow chart outlining a sub-method for generating a projection of a 3D mixed reality experience with the perception of depth and perspective adjustment, according to an embodiment of the present disclosure.

### DETAILED DESCRIPTION

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). Reference throughout this document to “some embodiments”, “certain embodiments”, “an embodiment”, “an implementation”, “an example”, or similar terms means that a particular feature, structure, or characteristic described in connection with the embodiment is included in at least some embodiments of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

According to an embodiment, the present disclosure relates to augmentation of a digital user experience. The augmentation may include an overlaying of digital objects onto a viewable display area of a display. As used herein, the term “display data” or “displayed data” includes any element displayed to a user on a viewable area of a display, which can include the augmentations and projections displayed to a user or viewer of the display. The display may be a display of a mobile device such as a smartphone, tablet, and the like, a display of a desktop computer, or another interactive display. The digital objects can include text, symbols, images, videos, and other graphical elements, among others. The digital objects can be interactive. The digital objects can be associated with third-party software vendors. As used

This disclosure is directed towards a new mixed reality experience that combines physical and digital data into a three-dimensional (3D) projection that maintains the perception of depth and observed displacement of an object caused by the change of an observer's (user's) point of view (POV) experienced in the real world without requiring external hardware to experience the same in the virtual environment. Also described herein is an optical lenticular multi-perspective environment including parallax adjustment.

When participating in a virtual meeting (conference, presentation, etc.), the virtual environment can combine many streams of data, for example the user's (e.g., a presenter's) video, the user's computer screen, and participants' video streams. These streams of data can also include many data points, such as the user's position, physical objects in the user's space, and the text and pictures in the slides that the presenter shares from the user's computer screen. When combined into the virtual environment, the result is that all data is displayed in two dimensions (2D) on the screen but retains a 3D experience (e.g., a 3D appearance and interactivity) for the user that mimics what the user would see and feel in real life, while incorporating additional functionality corresponding to predetermined movements and gestures. Some combined hardware and software solutions can present a 3D virtual environment, but these require specialized external hardware. Additionally, traditional virtual reality headsets work by tracking orientation of the headset and not the positioning of the user (e.g., a body of the user or a portion of the user's body) to the screen because the screen is attached to the user's head and locked at a fixed angle relative to the user's eyes and head.

Here, determining the position of the user (or viewer) can be an important or even integral step in creating an observed mixed reality projection. In some cases, determining the position of the user, (e.g., of the user's body or portions of the user's body which can include hands, arms, head, eyes, etc.) is advantageous as it can remove the need for external hardware attached to the user. Furthermore, the observed projection that the user sees can be continuously updated to reflect the changing position of the user. As the user shifts position, the observed mixed reality environment can also change to provide a more life-like experience. Objects in the observed mixed reality projection can adjust size and position via an object z-index and layered distances in the environment so that the objects continue to appear as they would in real life. Additionally, since the observed mixed reality projection can be based on the input of multiple data streams, the placement of data in the observed mixed reality projection can model the real-life placement of objects. In some cases, placement of objects can be modified to decrease overlap of objects or to move more important data to a location of prominence on the screen. In an example including more than one user interacting, the position of user A (a first user) is also important to other users (for example, a second user or user B) who are viewing the video stream of user A. As user A changes position, the projection user A sees changes due to the parallax or perspective adjustment. Notably, the position of user A changes the projection viewed by user B as well to account for user A's movement. For example, user A and user B can be in a video conference. User A's device can create a projection based on user A's position. When user A changes positions, the projection created by user A's device can change to maintain the illusion of depth and POV or perspective. At the same time, user B's device also creates a projection based on user B's position and when user B changes positions, the projection created by user B's device changes to maintain user B's illusion of depth and POV.

Additionally, as user A and user B move, their position in the virtual environment shifts so that the content processed to create the projection reflects the new positions. Depending upon the environment parameters (e.g., the number of data streams or the type of meeting or activity), the changes can occur within a layer or between layers. That is, if user A moves away from the screen, the virtual environment can change user A's location in a z-dimension of the current layer or move user A to another layer to present a projection that makes user A appear farther from the screen. Simultaneously, user A's device can present a projection to user A accounting for user A's movement away from the screen, and in some examples, objects farthest from view in the projection become less detailed to user A as user A moves away from the screen.

In some embodiments, the depth of the mixed reality projection can be created using layers of content. These layers can contain data in x- and y-dimensions or in the x-, y-, and z-dimensions. That is, the observed mixed reality environment can support layered distances and objects with a z-index. The z-index can be the third dimension of the arrangement of the objects on the screen or display. The z-index can provide the ability to manage what is virtually overlaying or occluding another object. Notably, some objects in some applications can include a z-index, but the potential and full implementation of the z-index to generate and supplement a mixed reality environment for a user may not be fully actualized yet.

The layers can be aligned immediately adjacent to other layers or can be set at a specified distance from another layer. By separating data into different layers at different distances from the observer or user, the data in each layer can be interacted with and controlled differently than data in other layers. Giving a layer depth and distance allows for the creation of depth within the mixed reality environment. The layer depth can be adjusted to provide additional control over the user's experienced simulated reality in the environment. That is, an environment with a greater number of layers within a set depth than another environment can provide a more accurate (e.g., a more realistic) movement of objects in the environment (e.g., in response to movement of the user), as the objects can be assigned to a layer at a depth that is more representative of the depth assigned to the object in the environment, and there is greater flexibility in assigning object depth.

Once the depth has been created using the layers, the layers can be manipulated to mimic real world physics. The layers, and objects within them, can shift left and right (e.g., along an x-direction) as a user changes position so that the mixed reality projection portrays what would be seen if the same movement were made in the real world. Correspondingly, the layers and objects within them can shift up and down (e.g., along a y-direction) when the user moves vertically up or down. That is, the objects within the layers can adjust to account for the parallax as the user moves. For example, if the user begins watching a presenter speak and is positioned directly in front of the screen, the mixed reality view would be straight on, but if the user shifts to the right during the presentation, then the mixed reality view would shift to incorporate the new viewpoint. In this case, the user would see the presenter as if the user had moved to the right while in the room with the presenter (i.e., the right side of the presenter's face would be more visible now than the left side). This orientation shift would apply not only to the presenter's display but to all objects in the mixed reality projection. In some examples, the response of layers and objects in the layers can be defined within specific environments or configured by a user. For example, in a first virtual environment, layers and objects within them can shift left when the user moves left, and in a second environment, layers and objects within them can shift right when a user moves left. In some examples, a user can configure (e.g., through settings of an environment) a response of the environment to movement of the user. For example, the user can define a speed at which a layer and objects in the layer move in response to movement of the user, or a direction in which the layers and objects therein move, or a degree to which layers and objects therein move.

According to some embodiments, physical objects and digital objects may be combined into a projection of a mixed reality computing experience that maintains the perception of depth and POV. The projection can include an overlaying of one or more virtual objects onto a layer stack in the viewable display area of a display of an electronic device. The electronic device may be a mobile device such as a smartphone, tablet, and the like, a desktop computer, or any other electronic device that displays information. The virtual objects can include physical objects (from visual data of a viewer, background, and physical objects) and digital objects (e.g., text in a window, slide deck, pay button). The virtual objects can be interactive. The virtual objects may be associated with objects from or produced by third-party software vendors.

In some embodiments, the present disclosure relates to the use of visual data to generate projections and provide functionality to users or viewers of a virtual environment. As used herein, visual data includes any data that includes visual elements, or anything that can be represented as an image. Examples of visual data can include data detected by visual detection devices (e.g., cameras), visual elements stored in a memory of a computing device, image data, data relating to the visual presentation of files (e.g., presentations, word processer documents, web pages, videos, pdf documents, etc.), or any other data that can contain visual elements. In some embodiments, a computing device can analyze visual data using data processing techniques, including using machine learning techniques such as computer vision. In some embodiments, visual data can be processed without displaying the visual data at a display of a computing device.

Presently, traditional display hardware comprises a single layer of controllable picture elements (pixels), which can be individually addressable to create a collection of visual information (display). Because the display hardware has only a single pixel layer, processing hardware, firmware, and software are used to create a single 2D representation to be displayed on the hardware. There are methods and apparatuses which can model a 3D virtual environment, but to display such a virtual environment, complicated mathematical techniques must be used to create a single 2D projection of the 3D virtual environment capable of being displayed on display hardware. The creation of such a single 2D projection imposes a fundamental limitation on the visual information or how it is displayed. The present disclosure provides for the creation of a projection that appears to be 3D with the perception of a third dimension orthogonal to the plane of display. Using layering and changes in the detected visual data, including viewer perspective, the projection can change to maintain the perception of depth and compensate for a parallax effect without requiring changes in the 3D virtual environment. This creates the perception of a true, immersive, interactive, 3D reality. Such a reality creates a wide array of new capabilities for computing experience. This can be achieved by moving from a single 2D projection of a 3D environment to a layer stack comprising multiple layers onto which a 3D virtual environment may be projected, each layer of which can be independently controlled.

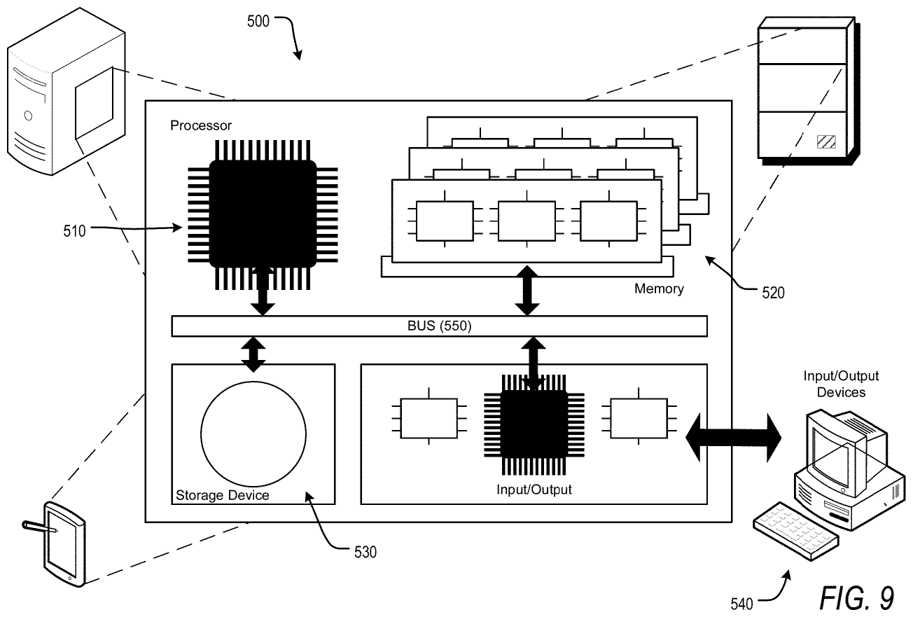

The above-described projections are particularly relevant to environments where there are physical objects included in the projection. Physical objects are naturally 3D. The process of creating a 2D projection fundamentally removes 3D information. Adding information relating to their depth back into the projection improves user experience and engagement. In some examples, physical objects can be sensed in an environment (e.g., a background) of a user, and can be visually represented by a 3D digital object in a layer of the projection, which can allow a visual perception of the physical object to provide an illusion of depth for the object to any users viewing the object on a display. In some examples, a physical object in a 3D environment is not correlated to a sensed object but can be added into a layer of the 3D projection from a digital library of physical objects. For example, a digital library can be stored on a memory or at a storage device of a computer or server (e.g., as shown in FIG. 9) and can include 3D representations of physical objects including furniture, plants, books, decorations, or any other physical object a user may want to display in a 3D projection at a layer thereof.

In some examples, a reference patch can be used to augment a digital user experience. In some embodiments, the reference patch or other visually detectable element may serve to indicate a position at which digital content is to be placed onto a display. In some examples, and as described herein, the reference patch can include encoded information that can be used to retrieve digital content and place that digital content into a desired location or locations in displayed data. The digital content can include at least one digital object. The reference patch can be embedded within displayed data (e.g., including, but not limited to, an image, a video, a document, a webpage, or any other application that may be displayed by an electronic device). The reference patch can include unique identifying data in the form of a marker, or encoding corresponding to predetermined digital content. The marker or encoding can correspond to a unique identifier which can indicate to the electronic device the particular digital content that is to be displayed, the position at which the digital content is to be placed, and the size of the digital content to be displayed. Accordingly, when a portion of displayed data comprising the reference patch is visible, the corresponding augmentation can be overlaid on the current frame of the displayed data with the augmentation including secondary digital content (i.e., content that is secondary to, or comes after, the primary displayed data), herein referred to as “digital content,” and/or digital objects. For example, an augmentation can include additional images to be displayed with the current frame of displayed data for a seamless visual experience. In some embodiments, as discussed further below, an augmentation can be overlaid onto the current frame when the reference patch is detected, but not visible on a display.

In some embodiments, including as described further below, a reference patch can be any visually identifiable element on a display, or identified in an image captured by an image capturing device (e.g., a camera, or other visual sensor). For example, a reference patch can be identified in visual information provided by an image capturing device, and the reference patch can be used to augment a projection. In one example, a university logo can be a reference patch, and when the university logo is detected by an image capturing device (e.g., in a physical environment of the user), a virtual environment of the user can be augmented with elements (e.g., visual elements, audio elements, haptic elements, lighting elements, etc.) corresponding to the university logo. Other visual objects can comprise reference patches, and in some non-limiting examples identified text, physical objects, photographs, artworks, books, albums, articles of clothing, etc. can be reference patches which can produce augmentation for a virtual environment. In some embodiments, a developer of an environment can select any visual pattern as a visual marker, and can provide instructions (e.g., through software or computer code) indicating an augmentation to be added to the virtual environment upon identification of the visual pattern, including layer at which to place visual augmentations. For example, in one non-limiting example, a text string can be identified in visual information from an image capturing device, and the text string can be a lyric, or a passage in a literary work. The virtual environment can be configured (e.g., by a developer thereof) to recognize the text string as a reference patch and provide augmentations including information relevant to the text string (e.g., information about a book, a song, an author, a writer, price information, concert venues, ticket prices, etc.). In some examples, a virtual environment can be integrated with third-party systems and applications (e.g., via API), and the third-party systems and applications can provide reference patch definitions for the virtual environment to generate augmentations when the defined reference patches are identified either on a display of the user, or in visual information obtained by an image capturing device of the user.

In a non-limiting example, a window containing a portion of the displayed data (e.g., a word processing document, a presentation document, a spreadsheet, a webpage, etc.) to be augmented can provide a region, or a surface area, for augmentation resulting from an identified reference patch within the displayed data. The window may thereby function as an anchor for the digital content, indicating where digital content can be relatively arranged. In some embodiments, digital content can be confined within a viewable area of a device software application or may reside within an entire viewable display area of the display. For instance, if a user is viewing a portable document format (PDF) document, a reference patch corresponding to given digital content may be within a viewable area of the PDF document and the digital content can be generated in a corresponding window through which the PDF document is being viewed. Additionally or alternatively, the digital content can be generated within the entire viewable display area of the display and may not reside only within the corresponding window through which the PDF document is being viewed.

The above-described augmentations can be particularly relevant to environments where the underlying content is static. Static content may include textual documents or slide decks. Often, the static content is stored locally in the electronic device. Due to its nature, the static content is not capable of being dynamically adjusted according to complex user interactions, in real-time, during a user experience. Such a digital user experience is cumbersome and inefficient. Thus, a heightened, augmented user experience is desired to provide increased convenience, engagement, and agility. The augmentations described herein reduce cumbrousness by providing a visual representation/aid of retrieved external digital content, and provide improved engagement of the user, agility of navigation through the displayed data, and overall performance of the user device.

Described herein is a device and method to incorporate a reference patch with encoded identifier attributes, where the reference patch serves as a conduit for delivering content into the displayed data.

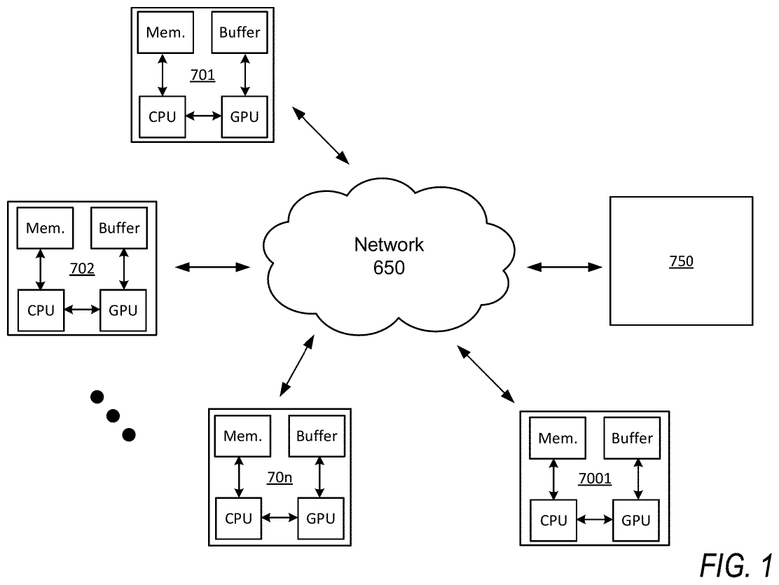

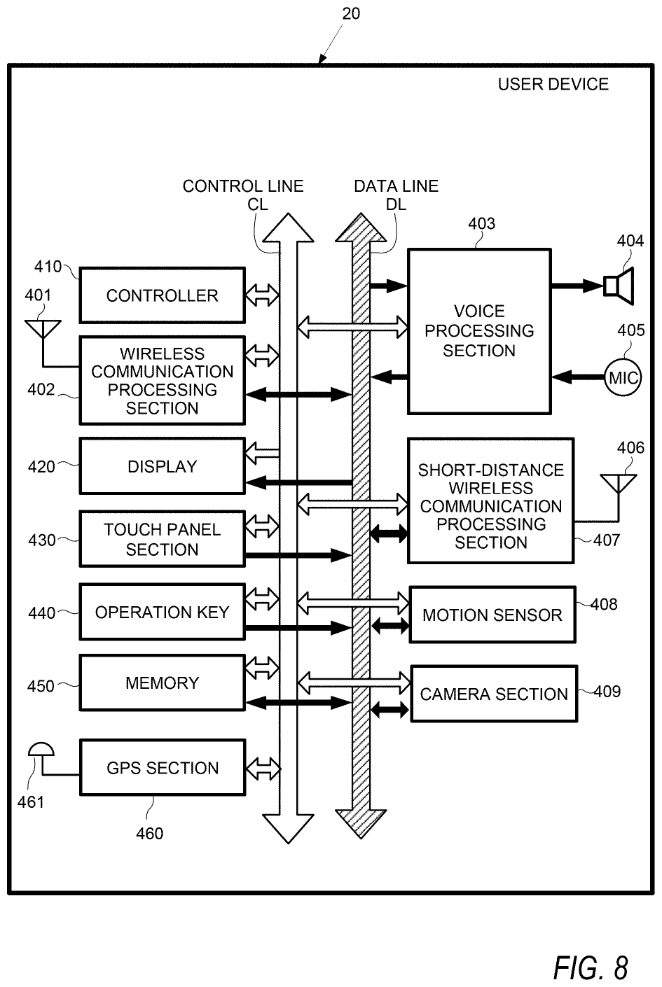

Referring now to the figures, FIG. 1 is a schematic view of an electronic device, such as a client/user device (a first device 701) communicatively connected, via a network 650, to a second electronic device, such as a server (a networked device 750), and a generating device 7001, according to an embodiment of the present disclosure. Further, in some embodiments, additional client/user devices can be communicatively connected to both the first device 701 and the networked device 750. A second client/user device 702 can be communicatively connected to the first device 701 and the networked device 750. As shown, a plurality of the client/user devices can be communicatively connected to, for example, an nth user device 70n. The devices can be connected via a wired or a wireless network. In some embodiments, the first device 701 can be responsible for transmitting displayed data over the communication network 650 to the second client/user device 702 and/or the nth user device 70n. In some cases, one or more of the devices 701, 702, 7001, 750, and 70n can be similar or identical to the user device 20 described with respect to FIG. 8, or the computer 500 shown in FIG. 9.

An application may be installed or accessible on the first device 701 for executing the methods described herein. The application may also be integrated into an operating system (OS) of the first device 701. The first device 701 can be any electronic device such as, but not limited to, a personal computer (pc), a tablet pc, a smart-phone, a smart-watch, an integrated Augmented Reality/Virtual Reality (AR/VR) headset with the necessary computing and computer vision components installed (e.g., a central processing unit (CPU), a graphics processing unit (GPU), integrated graphics on the CPU, etc.), a smart-television, an interactive screen, a smart projector or a projected platform, an Internet of Things (IoT) device or the like.

As illustrated in FIG. 1, the first device 701 includes a CPU, a GPU, a main memory, and a frame buffer, among other components (discussed in more detail in FIGS. 8-10). In some embodiments, the first device 701 can call graphics that are displayed on a display. The graphics of the first device 701 can be processed by the GPU and rendered in frames stored on the frame buffer that is coupled to the display. In some embodiments, the first device 701 can run software applications or programs that are displayed on a display. In order for the software applications to be executed by the CPU, they can be loaded into the main memory, which can provide a faster access time than a secondary storage, such as a hard disk drive or a solid-state drive. The main memory can be, for example, random access memory (RAM) and is physical memory that is the primary internal memory for the first device 701. The CPU can have an associated CPU memory and the GPU can have an associated video or GPU memory. In a non-limiting example, the CPU 229 includes the GPU 228 with the associated video or GPU memory incorporated into the CPU 229. The frame buffer can be an allocated area of the video memory. The CPU may have multiple cores or may itself be one of multiple processing cores in the first device 701. The CPU can execute commands in a CPU programming language, an example of which is C++. The GPU can execute commands in a GPU programming language, an example of which is HLSL. The GPU may also include multiple cores that are specialized for graphic processing tasks. Although the above description was discussed with respect to the first device 701, it is to be understood that the same description applies to the other devices (702, 70n, and 7001) of FIG. 1. Although not illustrated in FIG. 1, the networked device 750 can also include a CPU, GPU, main memory, and frame buffer.

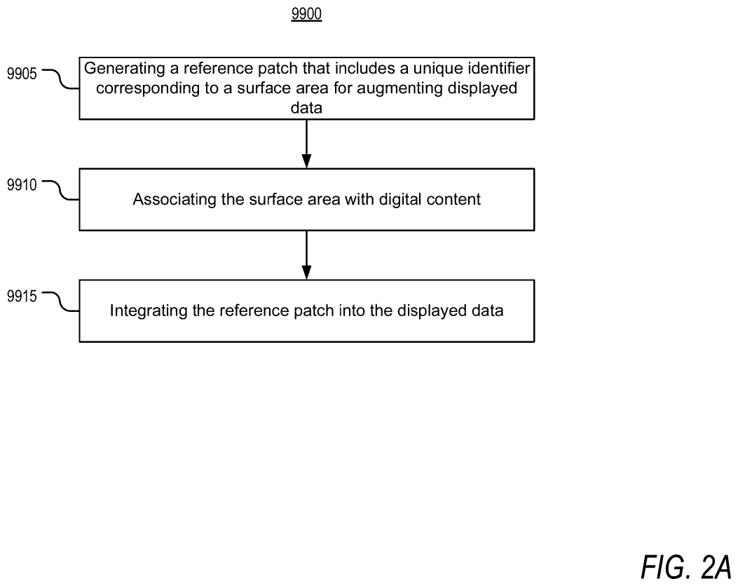

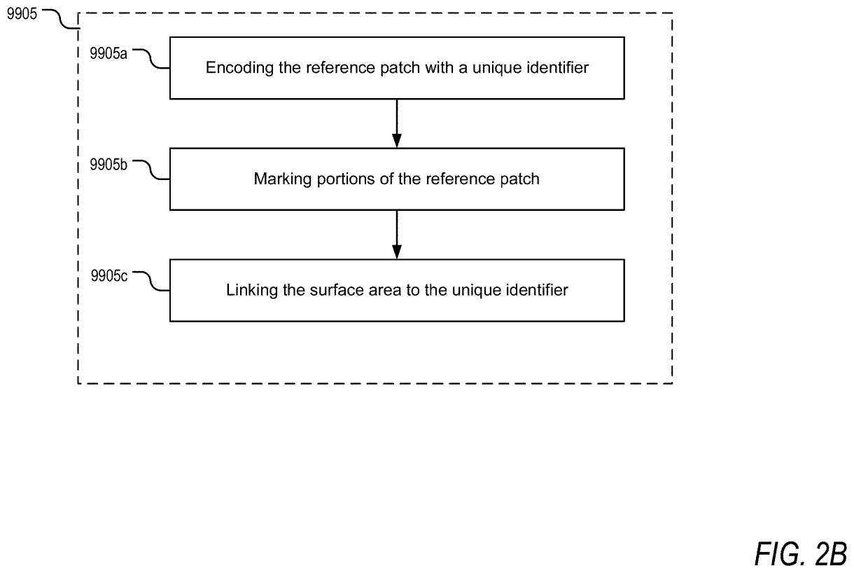

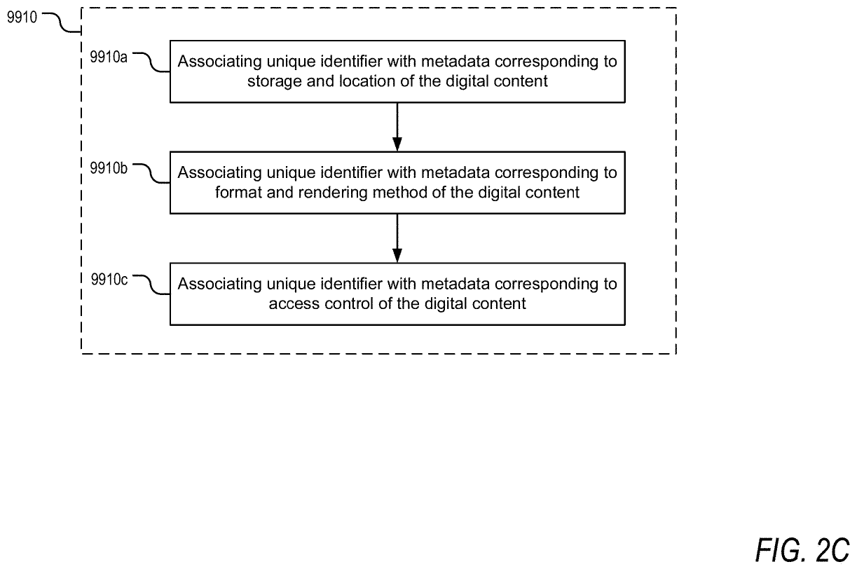

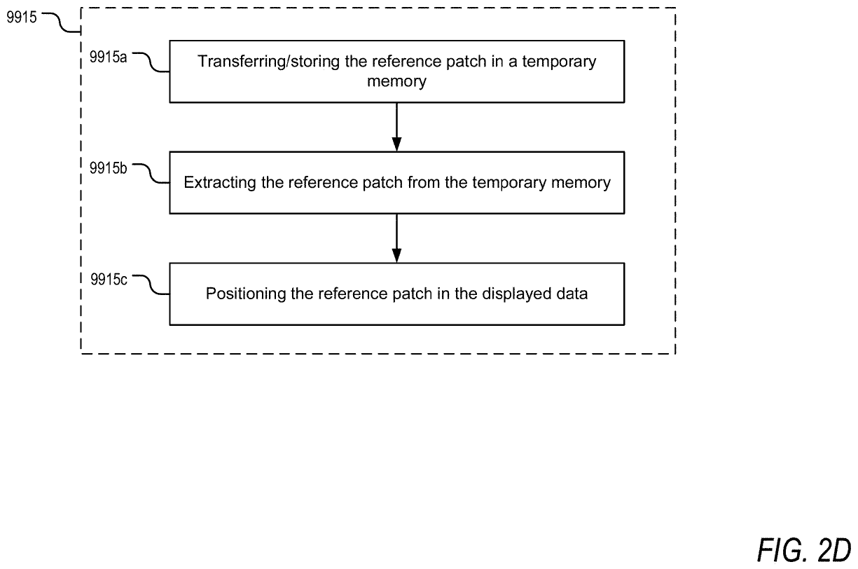

FIG. 2A is a flow chart for a method 9900 for generating a reference patch and embedding the reference patch into displayed data according to some embodiments of the present disclosure. The present disclosure describes generation of the reference patch, embedding of this patch into the displayed data content, and generating additional digital content based on the reference patch. In some embodiments, the first device 701 can incorporate (secondary) digital content into what is already being displayed (displayed data) for a more immersive experience.

In this regard, as illustrated in FIG. 2A, the first device 701 can generate the reference patch in step 9905. The reference patch can be an object having an area and shape that is embedded in the displayed data at a predetermined location. For example, the reference patch can be a square overlayed and disposed in a corner of a digital document (an example of displayed data), and the reference patch can be fixed to a predetermined page for a multi-page (or multi-slide) digital document. The reference patch can thus correspond to a surface area in the digital document. The reference patch can be an object that, when not in a field of view of the user, is inactive. The reference patch can, upon entering the field of view of the user, become active. For example, the reference patch can become active when detected by the first device 701 in the displayed data. When active, the reference patch can enable the first device 701 to retrieve digital content and augment the displayed data by incorporating the retrieved digital content into the displayed data. In some examples, the digital content can be retrieved from the memory of the first device. In other examples, the digital content can be received from any of the other devices 702, 750, 7001, or 70n over the network 650. The reference patch can become active when located within the frame of the screen outputting the displayed data. For example, when another window or popup is placed over top of the reference patch, the reference patch may continue to be active so long as the reference patch remains in the same location after detection and the window including the document incorporating the reference patch is not minimized or closed. As will be described further below, the reference patch can have a predetermined design that can be read by the first device 701, leading to the retrieval and displaying of the digital content.

In some embodiments, the first device 701 can use a geometrical shape for the reference patch and place the reference patch into displayed data using applications executed in the first device 701. The reference patch can take any shape such as a circle, square, rectangle or any arbitrary shape. Still referring to FIG. 2A, in step 9910, the reference patch can include one or more markers within its shape that can be associated with predetermined data. The predetermined data can be, for example, unique identifiers that correspond to a surface area of the displayed data. In some embodiments, the unique identifier can include encoded data that identifies the digital content, a location address of the digital content (e.g., a uniform resource locater (URL), an internet protocol (IP) address, or any other address accessible at the networked device 750), a screen position within the surface area at which the digital content is insertable in the displayed data, and a size of the digital content when inserted in the displayed data (adjustable before being displayed). In some embodiments, the unique identifier can be associated with a single marker, and can be encoded into the marker (e.g., the marker can be a QR code, and the unique identifier can be a URL encoded into the QR code). In some examples, predetermined data can be associated with a reference patch or with a marker of a reference patch in other ways. For example, a database can be provided including predetermined data (e.g., the unique identifier, location address, screen position, size of the digital content, etc.), and when a reference patch is detected or identified in the display, the database can be queried for the predetermined data based on the detected reference patch or one or more markers of the reference patch. In some examples, predetermined data can be obtained through an API.

As will be described below, the reference patch can include one or more markers, which each can take the form of patterns, shapes, pixel arrangements, pixel luma, and pixel chroma, among others. Digital content can be displayed at surface areas, or locations in the displayed data, corresponding to unique identifiers associated with the one or more markers. In some embodiments, the surface areas are reference points for the relative location of digital content. In some embodiments, surface area refers to empty space wherein additional digital content can be inserted without obscuring displayed data. In some embodiments, the designation of empty space prioritizes preserving visibility of the reference patch. In some embodiments, the surface area within displayed data that is available for displaying digital content corresponding to unique identifiers can be individually defined for a given application or virtual environment. In some examples, the surface area can be a slide of a slide presentation, or a page of a document within the displayed data. In other embodiments, a surface area virtual environment can include a panel for displaying digital content associated with a unique identifier (e.g., a left side panel, a right side panel, or a horizontal panel). In some embodiments, the surface area for displaying digital content associated with a unique identifier of a reference patch can be dynamically set, and can be updated to correspond to changes in a virtual environment. For example, when a user is represented in display data surface area available for displaying digital content can exclude the portion of the display including the representation of the user, and when the user's position changes, the surface area can dynamically update to exclude the area of the display newly occupied by the representation of the user.

For example, the first device 701 can use computer vision (described below) to detect displayed data and/or visual data. The first device 701 can inspect an array to determine locations of objects in the displayed data and/or visual data. In some examples, a slide in a slide deck can include text, pictures, logos, and other media, and the surface area is the blank space or spaces around the aforementioned objects. Thus, the digital content can be displayed somewhere in the blank spaces. In some embodiments, the surface area of the displayed data can include portions of the displayed data that already include objects and the digital content can be displayed at the same location as the objects. A slide in a slide deck can include a picture of a user, and the reference patch can be the area representing a face of the user and the additional digital content can be displayed at the same location as a body of the user. In another example, a slide in a slide deck can include an image of a vehicle wherein the image of the vehicle is the surface area for the digital content. The reference patch can be disposed in a blank space of the displayed data, and digital content retrieved as a result of the reference patch (e.g., images of a new car paint color and new rims) is displayed over the image of the vehicle to modify the appearance of the vehicle. In other words, the digital content may be placed in a blank area of the displayed data and/or in an area that is not blank (i.e., an area that includes text, image(s), video(s), etc.).

Still referring to FIG. 2A, at step 9915, the first device 701 can embed, or otherwise incorporate, the reference patch into the displayed data, such as a word processing document file (i.e., DOC/DOCX) provided by, e.g., Microsoft® Word, in a Portable Document Format (PDF) file such as the ones used by Adobe Acrobat®, in a Microsoft® PowerPoint presentation (PPT/PPTX), or in a video sequence file such as MPEG, MOV, AVI or the like. These file formats are illustrative of some file types which a user may be familiar with; however, applications included in the first device 701 are not limited to these types and other applications and their associated file types are possible.

The reference patch (or similar element) can be embedded into any displayed data, where the displayed data may be generated by an application running on or being executed by the first device 701. The reference patch can encompass the whole area designated by the displayed data, or just a portion of the area designated by the displayed data. The method of generating the reference patch and incorporating the reference patch into the displayed data has been described as being performed by the first device 701, however, the networked device 750 can instead perform the same functions. In order to be detected in the displayed data on the first device 701, the reference patch may only be simply displayed as an image on the screen. The reference patch may also simply be a raster image or in the background of an image. The reference patch is readable even when the image containing the reference patch is low resolution. Data associated with the reference patch (e.g., a unique identified) can be encoded in a hardy and enduring manner such that even if a portion of the reference patch is corrupted or undecipherable, the reference patch can still be activated and used. In some embodiments, the reference patch can be included in visual data that is not displayed on a display. For example, when a user is viewing a document at a display, a reference patch can be detected in a portion of the document that is not currently displayed to the user (e.g., a page that is not currently visible, a slide, etc.). In some examples, when the reference patch is identified in a portion of the document not yet visible to the user, the virtual environment can display digital content associated with the reference patch, or alert the user to the existence of the reference patch. In another example, a portion of visual data obtained by a visual detection device can be displayed to a user, and another portion of the obtained visual data can be outside of a display (e.g., a user can zoom in on a video feed so that a portion of the video feed is not visible to the user). If a reference patch is detected in that portion of the video feed not included in the displayed data, the application or virtual environment can display digital content associated with the reference patch to the user or alert the user to the presence of the reference patch, or otherwise provide functionality within the virtual environment based on the reference patch. Details of how to identify and utilize reference patches, including reference patches that are not visible to a user (e.g. are not displayed on a viewable area of a display) are described in U.S. Pat. No. 11,481,933 and in provisional patent applications 63/172,640 and 63/182,391, all of which are incorporated by reference herein in their entirety.

In some embodiments, the reference patch can be embedded inside of a body of an email correspondence. The user can use any electronic mail application such as Microsoft Outlook®, Gmail®, Yahoo®, etcetera. As the application is executed on the first device 701, it allows the user to interact with other applications. In some embodiments, the reference patch can be embedded on a video streaming or two-way interface such as a Skype® video call or a Zoom® video call, among others. In some embodiments, the reference patch can be embedded in displayed data for multi-party communication on a live streaming interface such as Twitch®. In other non-limiting examples, the reference patch can be embedded in a web page, in a video game, or in an AR/VR environment such as a metaverse.

One way in which the first device 701 can embed the reference patch into the displayed data is by arranging the generated reference patch in the displayed data such as in a desired document or other media. The reference patch can include a facade of the digital content which becomes an integrated part of the displayed data. The facade can act as a visual preview to inform the user of the digital content linked to the reference patch. The facade can include, for example, a screenshot of a video to be played, a logo, an animation, or an image thumbnail, among others. In some embodiments, the facade can be an altered version of the digital content. For example, the facade is a more transparent version of the digital content. The facade can be a design overlay. The design overlay can be a picture that represents the digital content superimposed over the reference patch. In some embodiments, the facade can indicate the content that is represented by the reference patch. The facade can be contained within the shape of the reference patch or have a dynamic size. For example, attention of the user can be brought to the facade by adjusting the size of the facade when the reference patch is displayed. The adjustment of the size of the facade can also be dynamic, wherein the facade can enlarge and shrink multiple times. By the same token, a position and/or a rotation of the facade can also be adjusted to produce a shaking or spinning effect, for instance.

Unlike traditional means of sending displayed data, in some embodiments the first device 701 may not send the whole digital content with a header file (metadata) and a payload (data). Instead, the reference patch that may include a facade of the underlying digital content is placed within the displayed data. If a facade is present, it indicates to the first device 701 that the surface area can have digital content that can be accessed with contact or contact-less selection by a human or non-human (clicking with a mouse, touchpad, eye contact, eye blinks, via voice command, robotic arm, or via photonic peripherals) of the facade. The digital content can also be accessed or activated automatically, e.g., when the reference patch is displayed on the display of the first device 701. Other means of visualization can be employed to indicate to the user that the surface area is likely to include information for obtaining digital content. For example, a highlighting effect can be applied along a perimeter of the reference patch with varying intensity to bring attention to the presence of the reference patch. As another example, dashed lines perpendicular to the perimeter of the reference patch can appear and disappear to provide a flashing effect. Other means can be employed to indicate to the user that the surface area is likely to include information for obtaining digital content, such as an audio cue.

The first device 701 employs further processes before embedding the reference patch into the displayed data. These processes and schemas are further discussed in FIG. 2B, which is a flow chart of sub-methods of the step 9905 of generating the reference patch, according to an embodiment of the present disclosure. The first device 701 can associate the digital content with the surface area corresponding to the reference patch (e.g., via the unique identifier associated with the reference patch or markers of the reference patch) generated by the first device 701. In some embodiments, the surface area may encompass the whole of the displayed data or a portion of it. The reference patch, which is associated with the unique identifiers corresponding to the surface area associated with the digital content, is then embedded into the displayed data by the first device 701. In some use cases, the displayed data including the reference patch can be sent or transmitted to the second client/user device 702 including the same application, which then allows the second client/user device 702 to access information within the surface area and obtain the digital content for display. That is, the second client/user device 702 can overlay the augmenting digital content on the displayed data on the display of the second client/user device 702 in the location or locations (surface areas) defined by the reference patch.

In FIG. 2B, the generating device 7001 uses additional processes to generate the reference patch, which is obtained and embedded by the first device 701. In a non-limiting example, the generating device 7001 encodes data into the reference patch with the unique identifiers corresponding to the surface area in step 9905a. The generating device 7001 can mark areas of the reference patch in step 9905b to form a marker. The marker can take the form of patterns, shapes, pixel arrangements, or the like. In an example, the marker can have a shape that corresponds to the shape of the reference patch. In an example, the marker can have a size that corresponds to the size of the reference patch. In an example, the marker can have a perimeter that corresponds to the perimeter of the reference patch. The marker can use any feasible schema to provide identifying information that corresponds to the surface area within the displayed data. In some embodiments, the marker can incorporate hidden watermarks that are only detectable by the first device 701, which has detection functionality implemented therein, for example having an application installed or the functionality built into the operating system. The generating device 7001 can further link the surface area with unique identifiers in step 9905c. A unique identifier can be used to define or reference a surface area on the display. In some examples, the unique identifiers are used to set the content, position, sizing, and/or other visual properties of augmenting digital content. The unique identifiers can be hashed values (such as those described above) that are generated by the generating device 7001 when the reference patch is generated (such as the one having the area of the reference patch divided into the subset of squares). A reference patch can include multiple markers, each associated with a unique identifier, and the unique identifiers can define one or more surface areas of displayed data in which to display digital content.

The marker can incorporate patterns which can then be extracted by the first device 701. In an example, the first device 701 can perform the embedding, then send the displayed data having the embedded reference patch to the second client/user device 702. The encoding can be performed by the generating device 7001 and may use any variety of encoding technologies, such as those used to generate ArUco markers, to encode data associated with the reference patch by marking the reference patch with the marker. The first device 701 may also be used as the generating device 7001. In some cases, the networked device 750, the second client/user device 702, and/or the nth client/user device 70n can obtain, embed, and/or detect the reference patch from the generating device 7001.

The marker can include a set of points. In some examples, the set of points can be equidistant from each other and/or make up equal angles when measured from a reference point, such as the center of the reference patch. That is, the fiducial points corresponding to the marker can provide a set of fixed coordinates or landmarks within the displayed data with which the surface area can be mapped. In an example, the marker can be comprised of a set of unique shapes, wherein combinations of the unique shapes can correspond to a target surface area (or available area, or areas) for displaying the displayed data. The combinations of the unique shapes can also correspond to digital content for displaying in the surface area. The combinations of the unique shapes can also correspond to or indicate a position or location where the digital content should be displayed at the surface area relative to a portion of the surface area and/or the displayed data. A combination of the set of points and unique identifiers can be used as well. In some embodiments, pixel coordinates of the reference patch can be determined, and the objects can be displayed relative to the pixel coordinates of the reference patch.

For example, the unique identifiers can be digital values (and/or instructions) that correlate to digital content and indicate where the digital content should be overlayed on the display (the screen position). In one example, the position of the digital content is determined relative to a set of points marked on the reference patch. The unique identifiers can also indicate a size of the digital content to be overlayed on the display, which can be adjustable based on the size of the surface area (also adjustable) and/or the size of the display of the first device 701. The unique identifiers can be associated with markers that are relatively (e.g., completely) invisible or undetectable to the user, but readable by the first device 701 and can further cover predetermined portions of the reference patch. In some embodiments, the markers associated with unique identifiers use metamers or other visual effects so that the difference between the markers and other portions of the reference patch is only fully discernible by an electronic device. For example, the area of the reference patch can appear white to the user and the markers that can also appear white to the user but may have a slightly darker pixel color that can be detected and interpreted by a device, such as the first device 701. In another example, the appearance of the markers associated with unique identifiers can be 0.75% darker than the white color of the area of the reference patch. Such a small difference can be identified and discerned by the first device 701 while being substantially imperceptible to the user.

In some embodiments, the area of the reference patch can be divided into sections (e.g., a set of squares), wherein a marker is included within each section. An example of a marker includes a letter. For example, a reference patch can be divided into 16 squares, wherein each square is designated to represent different information (e.g., a timestamp, a domain, or a version). Thus, the marker in each square is interpreted according to the designation of that square. An identification based on the set of squares can be, for example, an 18-character (e.g., 18-“letter”) hexadecimal. The set of squares can further include additional subsets for a randomization factor, which can be used for calculating a sha256 hash prior to encoding the data of the reference patch with the hash. Together, the set of squares having the marker included therein can comprise the unique identifiers.

Moreover, the generating device 7001 can also employ chroma subsampling to mark the reference patch with attributes represented by a particular pattern. In some examples, the generating device 7001 can mark parts of the reference patch with predetermined patterns of pixel luma and chroma manipulation that represent a shape, a size, or a position of the surface area for displaying the digital content. In one example, the generating device 7001 can mark a perimeter of the reference patch with a predetermined edging pattern of pixel luma and chroma manipulation that represents a perimeter of the surface area for displaying the digital content. In some embodiments, chroma subsampling can be used to generate a facade for a reference patch, as discussed above.

FIG. 2C is a flow chart of sub-methods of step 9910 of associating the surface area with digital content, according to some examples. In FIG. 2C, the generating device 7001 uses additional processes to associate the surface area with digital content. The generating device 7001 can associate the unique identifiers corresponding to the surface area with metadata. In step 9910a, the unique identifiers can be associated with or include metadata embodying information about the storage and location of the digital content. In step 9910b, the generating device 7001 can associate markers of the reference patch with the unique identifier including metadata which embodies information about the format and rendering information used for the digital content. In step 9910c, the generating device 7001 can associate the unique identifiers with metadata which embodies access control information to the digital content.

In some non-limiting examples, digital content can be stored or hosted on a remote server, such as the networked device 750, and the location of the digital content can be the location address (e.g., the URL or IP address) of the memory upon which it is stored at the remote server. The storage and location of the digital content can thus be linked with the metadata and/or the unique identifier wherein the metadata and/or the unique identifier point to how a device can obtain the digital content. The digital content is thus not directly embedded into the displayed data. In an example, the format and rendering information about the digital content can be embodied in the metadata and associated with the unique identifiers. This information is helpful when the first device 701 or the second client/user device 702 are on the receiving end of the transmitted displayed data and need to properly retrieve and process the digital content.

Moreover, in a non-limiting example, metadata associated with the unique identifiers corresponding to the surface area can include information associated with or defining access controls for the digital content. The access control can be information defining whether the digital content can be accessed by certain devices or users. In some cases, the access controls can restrict access to digital content based on geographical location, time, date, device type, display type, software version, and/or operating system version. For example, a user may wish to restrict access to the digital content to certain types of devices, such as smartphones or tablets, or to devices executing specific operating systems (OS). For example, access may be controlled by providing access to certain devices and not others based on assigned security and/or privacy privileges. Thus, the metadata defining a display requirement would encompass such an access control parameter. In one example, the access control further includes how long a device can access the digital content, sharing settings, and/or password protection of the digital content. In some cases, the digital content can include input fields through which a user can enter authentication information (e.g., a password, a PIN, a one-time password, an access code, etc.) and upon successful authentication, additional content can be displayed to the user.

FIG. 2D is a flow chart of sub-methods of the step 9915 for integrating the reference patch into the displayed data, according to an embodiment of the present disclosure. In some embodiments, the generating device 7001 can temporarily transfer to or store the reference patch in a storage of the first device 701 in step 9915a. The storage can be accessed by the first device 701 for embedding the reference patch into the displayed data at any time. The first device 701 can extract the reference patch from the storage for embedding purposes in step 9915b. The first device 701 can also arrange the reference patch at a predetermined location and with a predetermined reference patch size in step 9915c. The first device 701 can further embed the reference patch such that a document, for example, having the reference patch embedded therein can be sent to a recipient, for example the second client/user device 702, where the second client/user device 702 can access the document using an application. Note that the features of the generating device 7001 can be performed by the first device 701.

The displayed data can be output from a streaming application or a communication application with a data stream having the reference patch embedded therein. The actual digital content may not be sent along with the underlying displayed data or data stream, but only the reference patch, the unique identifier, and/or a facade of the digital content is sent. In some embodiments, the unique identifier and/or the metadata can be stored in a database (e.g., including relational databases, non-relational databases, object storage systems, etc.) which can point to the networked device 750 or a cloud-based file hosting platform that houses the digital content. The order of the operations discussed herein are not to be construed as limiting; the sub-methods performed by the first device 701 can be carried out synchronous to one another, asynchronous, dependently, or independently of one another, or in any combination. These stages can also be carried out in series or in parallel.

There can be numerous ways to identify a reference patch within a frame of displayed data. In some embodiments, the displayed data can be stored in a frame buffer. A frame buffer is a segment of memory that stores frames of pixel data as a bitmap, or an array of bits. Each pixel in the display is defined by a color value. The color value is stored in bits. In some embodiments, the frame buffer can include a color lookup table, wherein each pixel color value is an index that references a color on the lookup table. A frame buffer can store a single frame of displayed data or multiple frames of displayed data. In order to store multiple frames of displayed data, the memory can include a first buffer and at least one additional buffer. A currently displayed frame of displayed data is stored in the first buffer, while at least one subsequent frame is stored in the at least one additional buffer. When the subsequent frame is displayed, the first buffer is then filled with a new frame containing data, which can then be displayed on the display. Frame buffers can be stored in a graphics processing unit (GPU). In some embodiments, each of the second electronic devices (e.g., the first device 701, the second client/user device 702, the nth user device 70n) can access the frame buffer in the GPU and analyze the pixel data in order to identify a reference patch.

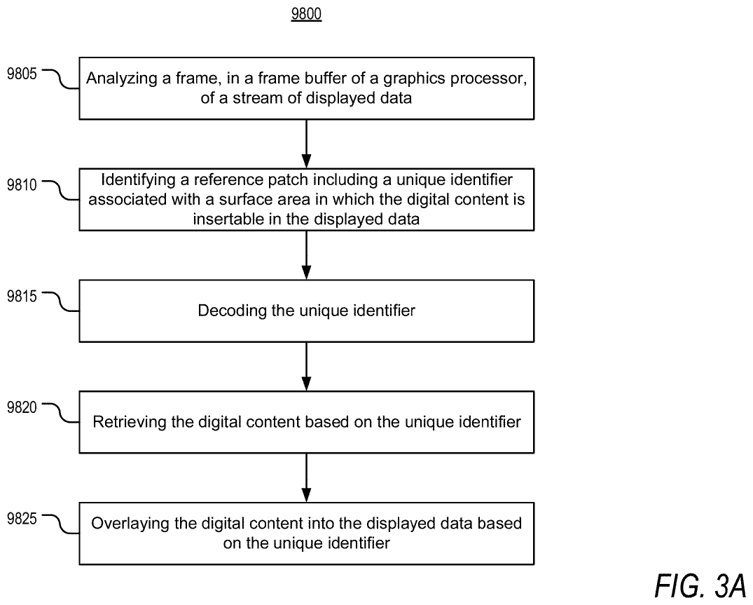

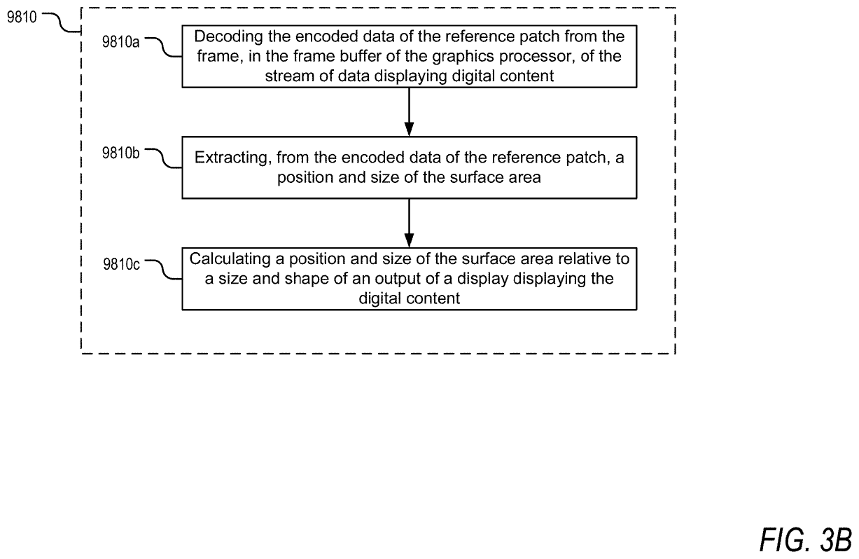

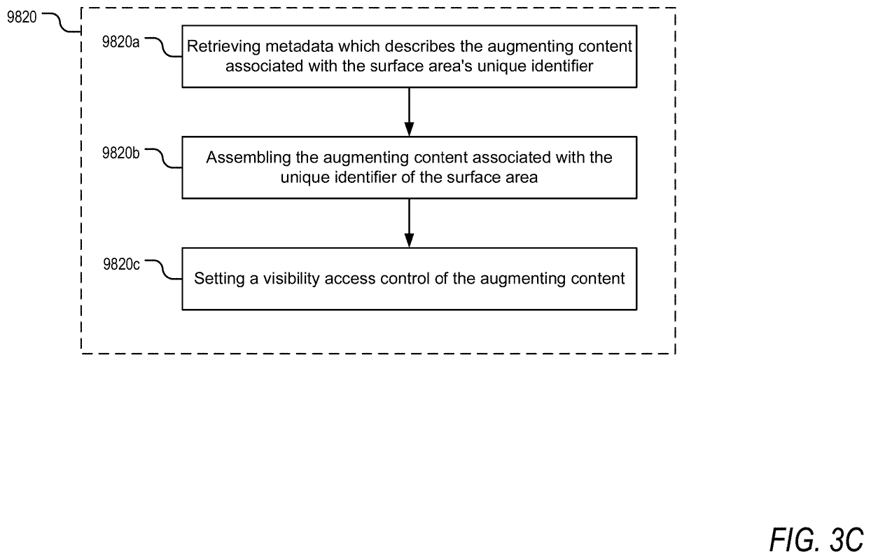

FIG. 3A is a flow chart for a method 9800 of identifying the reference patch included in the displayed data and overlaying the digital content onto displayed data according to an embodiment of the present disclosure. In some examples, at step 9805, the first device 701 can inspect the stream of data being outputted by the first device's 701 video or graphics card and onto the display of the first device 701. That is, the first device 701 can access a frame buffer of the GPU and analyze, frame by frame, in the frame buffer, the outputted stream of data which can include the displayed data. In some cases, a frame represents all or a portion of the displayed data that is being displayed by the first device 701. In that regard, the first device 701 can inspect the outputted stream of data. The first device 701 can achieve this by intercepting and capturing data produced from the first device 701's video card or GPU that is communicated to the first device 701's display. Inspecting the frame buffer is a method for visually identifying the reference patch as part of the display content. In some embodiments, the reference patch can be identified before the frame is generated within the frame buffer.

Still referring to FIG. 3A, at step 9810, the first device 701 can process attributes of each pixel included in a single frame and detect groups of pixels within that frame with a known predetermined pattern of pixel luma and chroma manipulation in order to find the reference patch. In some cases, the first device 701 can identify the reference patch based on a confidence level for a predetermined pattern of pixel luma and chroma manipulation and/or a predetermined edge pattern of pixel luma and chroma manipulation. For example, the first device 701 can identify a reference patch wherein the reference patch is a uniform gray rectangle surrounded by a white background. The pattern of chroma manipulation of gray rectangle in contrast with the surrounding pixel data is identifiable as a reference patch. In another example, the first device 701 can identify a line segment separating a reference patch from the remainder of the displayed data based on the color and/or brightness of the line segment. In yet another example, the first device 701 can inspect pixels in batches. In some embodiments, identifying the reference patch is done by inspecting the frame buffer using computer vision, including, but not limited to, image recognition, semantic segmentation, edge detection, pattern detection, object detection, image classification, and/or feature recognition. Examples of artificial intelligence computing systems and techniques used for computer vision include, but are not limited to, artificial neural networks (ANNs), generative adversarial networks (GANs), convolutional neural networks (CNNs), thresholding, and support vector machines (SVMs). Computer vision is useful when the displayed data includes complex imagery and/or when the reference patch would otherwise blend into the displayed data. For example, an image of a car is a reference patch, and the displayed data includes multiple images of cars. Computer vision enables the first device 701 to accurately identify the specific image of the car that is the reference patch in the displayed data.

In a non-limiting example, the processor-based computer vision operation can include sequences of filtering operations, with each sequential filtering stage acting upon the output of the previous filtering stage. For instance, when the processor is a graphics processing unit (GPU), these filtering operations are carried out by fragment programs. In the event an input to the operation is an image, the input images are initialized as textures and then mapped onto quadrilaterals. Displaying the input in quadrilaterals ensures a one-to-one correspondence of image pixels to output fragments. Similarly, when the input to the operation is an encoded image, a decoding process may be integrated into the processing steps described above. A complete computer vision algorithm can be created by implementing sequences of these filtering operations. After the texture has been filtered by the fragment program, the resulting image is placed into texture memory, either by using render-to-texture extensions or by copying the frame buffer into texture memory. In this way, the output image becomes the input texture to the next fragment program. This creates a pipeline that runs the entire computer vision algorithm. However, often a complete computer vision algorithm will require operations beyond filtering. For example, summations are common operations. Furthermore, more-generalized calculations, such as feature tracking, can also be mapped effectively onto graphics hardware.

In an example, the reference patch can be identified by use of edge detection methods. In an example, the edge detection method may be a Canny edge detector. The Canny edge detector may be run on the GPU. In one instance, the Canny edge detector can be implemented as a series of fragment programs, each perform a step of the algorithm.

In an example, the identified reference patch can be tracked from frame to frame using feature vectors. Calculating feature vectors at detected feature points is a common operation in computer vision. A feature in an image is a local area around a point with some higher-than-average amount of “uniqueness.” This makes the point easier to recognize in subsequent frames of video. The uniqueness of the point is characterized by computing a feature vector for each feature point. Feature vectors can be used to recognize the same point in different images and can be extended to more generalized object recognition techniques.

Feature detection can be achieved using techniques similar to the Canny edge detector that instead search for corners rather than lines. If the feature points are being detected using sequences of filtering, the GPU can perform the filtering and read back to the central processing unit (CPU) a buffer that flags which pixels are feature points. The CPU can then quickly scan the buffer to locate each of the feature points, creating a list of image locations at which the feature vectors will be calculated on the GPU.

Referring still to FIG. 3A, at step 9815, the first device 701 can decode the encoded unique identifier (e.g., from one or more markers of the reference patch) included with the reference patch wherein the unique identifier corresponds to (e.g., defines) a surface area for augmentation. In one example, a reference patch includes more than one marker associated with a corresponding unique identifier. In some examples, the unique identifier is a hashed value. In some examples, the unique identifier was generated by the first device 701. In some examples, the unique identifier was generated by an external device, e.g., the networked device 750, the second client/user device 702, the nth user device 70n.

As further shown in FIG. 3A, at step 9820, the first device 701 uses the unique identifier to retrieve digital content. In some cases, the unique identifier describes the content, the location address, metadata, or other identifying information about the digital content. In some examples, the first device 701 retrieves the digital content from a server (e.g., the networked device 750). In some examples, the first device 701 retrieves the digital content from main memory.

With continued reference to FIG. 3A, at step 9825, the first device 701 overlays digital content as an augmentation of the displayed data. In an example, the location of the digital content is the surface area described by the unique identifier. The digital content is overlaid as an additional layer to the displayed data. Although the digital content is visually merged with the displayed data, the data itself is isolated from the displayed data and can be modified independently of the rest of the displayed data.

Again, the method of identifying the reference patch included in the displayed data and the resulting augmentation of the displayed data is described as performed by the first device 701, however, the networked device 750 can instead perform the same functions.

In a non-limiting example, the first device 701 identifies the surface area corresponding to the reference patch by employing further processes to process the frames. To this end, FIG. 3B is a flow chart of a sub-method of identifying the reference patch with the unique identifiers corresponding to the surface area from the stream of data, according to an embodiment of the present disclosure.

As illustrated in FIG. 3B, at step 9810a, the first device 701 can decode data that is encoded in the reference patch from frame (e.g., a frame of pixel data store in a frame buffer). The data can be decoded from the marker associated with the unique identifiers of the reference patch incorporated previously. The reference patch can also include other identifying information. The marker can be disposed within the reference patch, such as within the area of the reference patch or along a perimeter of the reference patch, or alternatively, outside of the area of the reference patch.

Whatever schema is used to encode data associated with the marker in the reference patch is also used in reverse operation to decode the underlying information contained within the reference patch. As stated above, data can be encoded into patterns of marker that are generated and decoded using the ArUco algorithm or by other algorithms that encode data according to a predetermined approach.

Still referring to FIG. 3B, at step 9810b, the first device 701 can also extract attributes of the surface area from the reference patch. In an example, the position, size, shape, and perimeter of the surface area are extracted, although other parameters can be extracted as well. Other parameters can include boundary lines, area, angle, depth of field, distance, ratio of pairs of points, or the like. In some cases, where shape and perimeter are designated as the attributes, the first device 701 makes determinations of size, shape, and perimeter and outputs that result. Specifically, the size or shape of the surface area can be determined by evaluating a predetermined or repeatable pattern of pixel luma and chroma manipulation in the reference patch. The predetermined pattern can be marked on, within the area, or outside of the area of the reference patch. The predetermined pattern can correspond to the size or shape of the surface area. The predetermined pattern can correspond to the size or shape of the digital content. The perimeter of the surface area can also be determined by evaluating a predetermined edging pattern of pixel luma and chroma manipulation. The predetermined edging pattern can be marked on, within the area, or outside of the area of the reference patch. That is, the predetermined edging pattern of the refence patch can correspond to the perimeter of the surface area. The predetermined edging pattern of the refence patch can correspond to the perimeter of the digital content.

As further illustrated in FIG. 3A, at step 9810c, the first device 701 can also calculate a position and size of the surface area relative to the size and shape (dimensions) of the display that is displaying the displayed data and can output a signal to the display, the signal including the displayed data. In an example, calculating the size of the surface area relative to the size and shape of the outputted signal from the display includes determining the size of the surface area by inspecting a furthest measured distance between the edges of the surface area. Furthermore, calculating a location of the surface area relative to the size and shape of the display includes determining the location of the surface area relative to the size and shape of the displayed data outputted through the display. This includes calculating the distance between the outer edges of the surface area and the inner edges of the displayed data being outputted by the display. The determined size and location of the surface area can be outputted as a result. Notably, prior to overlaying the digital content into the displayed data, the first device 701 can adjust, based on the predetermined pattern and the predetermined edging pattern, the size and perimeter of the digital content for displaying in the display of the first device 701. For example, the size and perimeter of the digital content for displaying in the display of the first device 701 can be scaled based on the size and perimeter of the surface area and/or the size of the display.

The first device 701 can provide information regarding the characteristics of the displayed data, which can include characteristics of the output video signal provided to the display to display the displayed data, such that the digital content that is later overlaid can correctly be displayed to account for various manipulations or transformations that may take place due to hardware constraints, user interaction, image degradation, or application intervention. Such manipulations and transformations may be the relocation, resizing, and scaling of the reference patch and/or the surface area, although the manipulations and transformations are not limited to those enumerated herein.

In some embodiments, the reference patch itself can be used as the reference for which the digital content is displayed on the surface area. In one example, the location at which to display the digital content in the surface area can be determined relative to the location of the reference patch on the displayed data. In one example, the size of the surface area can be determined relative to the size of the reference patch on the displayed data. In an example employing a combination of the two properties of the reference patch, the reference patch displayed in the displayed data on a smart phone having a predetermined size and a surface area can be scaled relative to the predetermined size of the display of the smart phone. This can be further adjusted when the reference patch in the same displayed data is displayed on a desktop monitor, such that the predetermined size of the reference patch in the displayed data displayed on the desktop monitor is larger and thus the size of the surface area can be scaled to be larger as well. Furthermore, the location of the surface area can be determined via a function of the predetermined size of the reference patch. For example, the location at which to display the digital content in the surface area can be disposed some multiple widths laterally away from the location of the reference patch as well as some multiple heights longitudinally away from the location of the reference patch. As such, the predetermined size of the reference patch can be a function of the size of the display of the first device 701. For example, the predetermined size of the reference patch can be a percentage of the width and height of the display, and thus the location and the size of the surface area are also a function of the width and height of the display of the first device 701.

In a non-limiting example, the first device 701 can determine an alternative location at which to display the digital content based on behaviors of the user. For example, the first device 701 can compare the encoded data corresponding to the location at which to display the digital content in the surface area to training data describing movement and focus of the user's eyes while viewing the displayed data. Upon determining that the location at which to display the digital content in the surface area (as encoded in the reference patch) is not the same as the training data, the first device 701 can instead display the digital content at the location described by the training data as being where the user's eyes are focused in the displayed data at a particular time. For example, the user's eyes may be predisposed to view a bottom-right of a slide in a slide deck. The first device 701 can decode the reference patch and determine the digital content is to be displayed in a bottom-left of the slide deck. The training data can indicate that, for example, the user's eyes only focus on the bottom-left of the slide 10% of the time, while user's eyes focus on the bottom-right of the slide 75% of the time. Thus, the first device 701 can then display the digital content in the bottom-right of the slide instead of the bottom-left. The training data can also be based on more than one user, such as a test population viewing a draft of the slide deck. For example, the training data can be based on multiple presentations of the slide deck given to multiple audiences, wherein eye tracking software determines the average location of the audience's focus on each of the slides.

In an example, the first device 701 employs other processes to associate the unique identifiers with the digital content. To this end, FIG. 3C is a flow chart of a sub-methods of step 9820 of associating the unique identifiers with digital content, according to some examples. As shown, at step 9820a, the first device 701 can send the unique identifiers to the networked device 750 and the networked device 750 can retrieve metadata that describes the digital content, the digital content being associated with the surface area through the unique identifiers. This can be done by querying a remote location, such as a database or a repository, using the unique identifiers of the surface area as the query key. In an example, the first device 701 sends the unique identifiers to the networked device 750 and the networked device 750 associates the unique identifier of the reference patch to corresponding digital content based on the metadata. The metadata associated with the surface area's unique identifier can be transmitted to the first device 701 with the augmentation content.

As further shown in FIG. 3C, at step 9820b, the first device 701 can assemble the digital content that is associated with a unique identifier of the reference patch, or of a marker of the reference patch. The assembly can entail loading the necessary assets for assembling the digital content. In some embodiments, this can entail loading manipulation software or drivers in order to enable the first device 701 to process the digital content. Other assembling processes can be the loading of rendering information in order to transform and manipulate an individual portion of the digital content. Furthermore, the loaded manipulation software, drivers, or rendering information can be used to compile all the individual portions of the entire digital content together. In some embodiments, this can include adapting the file formats of the digital content, delaying the playback for the digital content, converting from one format to another, scaling the resolution up or down, converting the color space, etc.

Still referring to FIG. 3C, at step 9820c, the first device 701 can provide access control parameters for the digital content. The access control parameters can dictate whether the digital content is visible to some users, or to some geographical locations, or to some types of displays and not others, as well as the date and time or duration of time a user can access the digital content. In some cases, visibility of the digital content can be defined for an individual. For example, the digital content can be a video that is appropriate for users over a certain age. Visibility of the digital content can be defined for a geographic location. For example, the digital content can be a video that is region-locked based on a location of the first device 701. In another example, visibility of the digital content can be defined for a type of display displaying the displayed data. For example, the digital content can be VR-based and will only display with a VR headset. In yet another example, visibility of the digital content can be defined for a predetermined date and a predetermined time. For example, the digital content can be a video that will only be made publicly available after a predetermined date and a predetermined time. In further examples, visibility of the digital content can be defined for a time period. For example, the digital content can be a video that is only available for viewing during a holiday. The first device 701 thus calculates the user's access level based on those parameters and provides an output result as to the user's ability to access the digital content, i.e., whether the digital content will be visible or invisible to the user. Note that the access control parameters can be global, for all the displayed data, or it can be localized per surface area and the underlying digital content.

Referring again to FIG. 3A, at step 9825, the first device 701 can carry on the processes of overlaying the surface area of the displayed data with the digital content into the displayed data, the position, shape, and/or size of the digital content being identified by the unique identifier (e.g., the unique identifier can be used to perform a lookup to obtain the position, shape, and size data from memory or over a network as from a database or API). The first device 701 can determine or adjust the size and location of the assembled digital content on the surface area relative to the size and shape of the displayed data being outputted by the display. Then, the first device 701 can render the associated digital content (or the assembled individual portions) over the surface area's shape and perimeter using the size and location information. Thus, the digital content is superimposed on top of the surface area.

In one example, a device (e.g., the first device 701) can inspect the memory of the device in order to identify the reference patch. A frame buffer stores a limited number of frames of displayed data. Displayed data can also be stored in the main memory of a device, wherein the main memory refers to internal memory of the device. The operating system (OS) and software applications can also be stored in the main memory of a device (e.g., the memory 450 of the user device shown in FIG. 8).

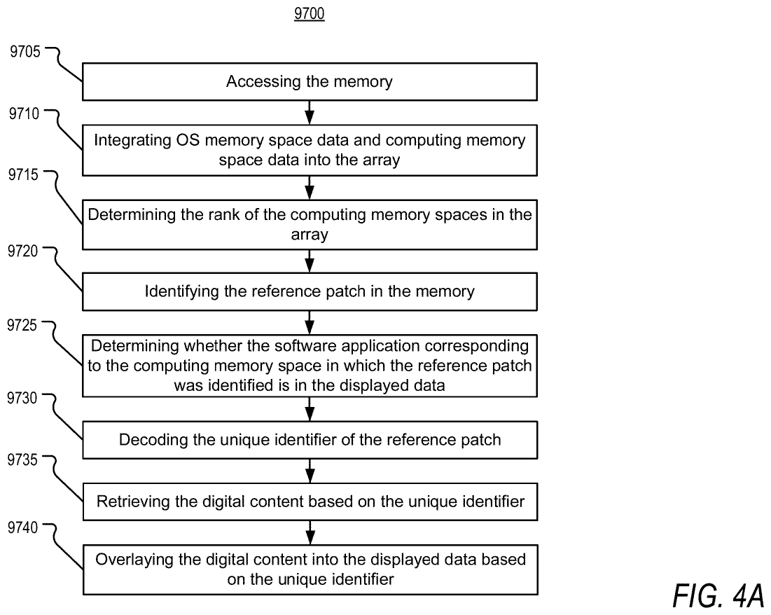

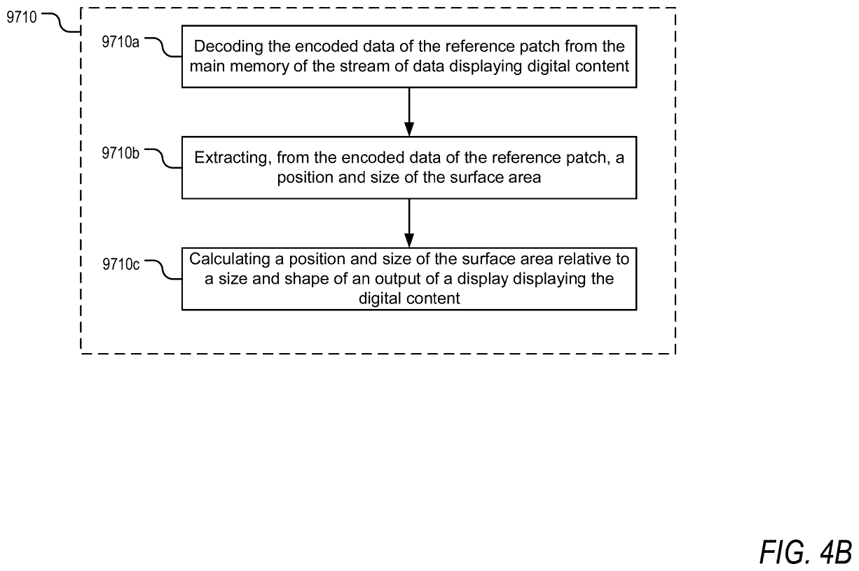

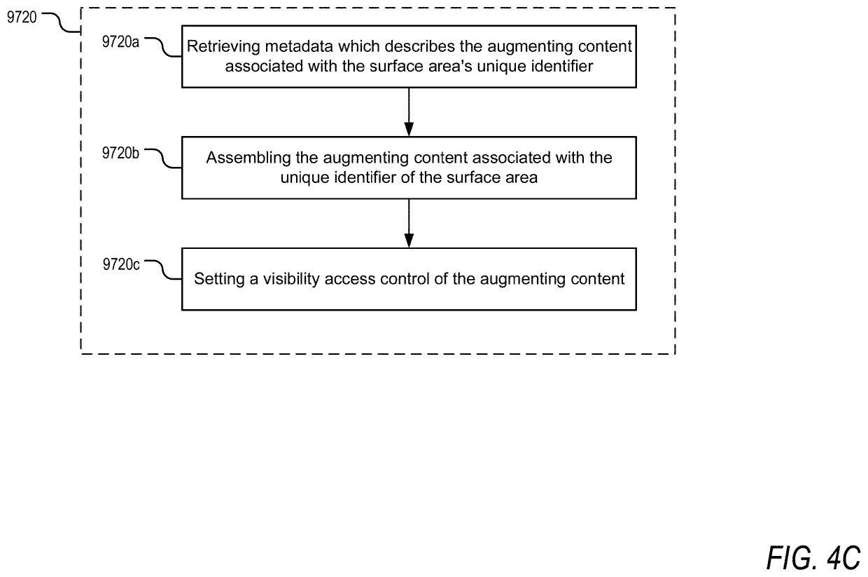

FIG. 4A is a flow chart for a method 9700 of identifying the reference patch included in the displayed data and overlaying the digital content onto displayed data, according to some examples of the present disclosure. As shown, at step 9705, the first device 701 can inspect the main memory on the first device 701. Again, the main memory of the first device 701 refers to physical internal memory of the first device 701 where all the software applications are loaded for execution. In some cases, complete software applications can be loaded into the main memory, while in other cases a certain portion or routine of the software application can be loaded into the main memory only when it is called by the software application. The first device 701 can access the main memory of the first device 701 including an operating system (OS) memory space, a computing memory space, and an application sub-memory space for the computing memory space in order to determine, for example, which software applications are executing (computing memory space), how many windows are open for each software application (application sub-memory space), and which windows are visible and where they are located (or their movement) on the display of the first device 701 (OS memory space). That is to say, the OS memory takes up a space in (or portion of) the main memory, the computing memory takes up a space in (or portion of) the main memory, and the application sub-memory takes up a space in (or portion of) the computer memory. This information can be stored, for example, in the respective memory spaces. Other information related to each software application can be obtained and stored and is not limited to the aforementioned features.

As further shown in FIG. 4A, at step 9710, the first device 701 can aggregate the various memory spaces into an array (or table or handle). That is, the first device 701 can integrate data corresponding to the OS memory space and data corresponding to the computing memory space into the array. The array can be stored on the main memory of the first device 701 and include information regarding the software applications executing on the first device 701. In an example, the computing memory spaces (including the application sub-memory spaces) can be aggregated into the array. This can be achieved by querying the main memory for a list of computing memory spaces of all corresponding software applications governed by the OS and aggregating all the computing memory spaces obtained from the query into the array (e.g., aggregating the computing memory space of a PowerPoint® file and the computing memory space of a Word® file into the array). The information in the computing memory spaces stored in the array can include metadata of the corresponding software application. For example, for PowerPoint®, the information in the array can include a number of slides in a presentation, notes for each slide, etc. Moreover, each window within the PowerPoint® file and/or the Word® file can be allocated to a sub-memory space. For example, the array can include the location of each window for each software application executing on the first device 701, which can be expressed as an x- and y-value pixel coordinate of a center of the window. For example, the array can include the size of each window for each software application executing on the first device 701, which can be expressed as a height and a width value.

Referring still to FIG. 4A, at step 9715, the first device 701 can determine a rank or a hierarchy of the computing memory spaces in the array. The rank can describe whether a window of a software application or the software application itself is active or more active as compared to another software application executing on the first device 701. An active window or software application can correspond to the window or software application that is currently selected or clicked in or maximized. For example, an active window can be a window of a web browser that the user is scrolling through. In some examples, this can be achieved by querying the OS memory space and each computing memory space in the main memory for existing sub-memory spaces, querying the OS memory space and each computing memory space in the main memory for a rank or hierarchical relationship between (software application) sub-memory spaces found, recording the list of sub-memory spaces and the rank relationship between sub-memory spaces, and associating the list of sub-memory spaces and the rank relationship between the sub-memory spaces with the array. For example, a window of a first application can be an active window on the first device 701 and has a higher rank than an inactive window of a second application also executing on the first device 701. The active window can be the window the user has currently selected and displayed over all other windows on the display of the first device 701. Notably, there can be multiple visible windows, but one of said multiple visible windows can have a higher rank because it is currently selected by the user and the active window.

For example, two documents can be viewed in a split-screen side-by-side arrangement without any overlap of one window over another window, and a third document can be covered by the two documents in the split-screen side-by-side arrangement. In such an example, the user can have one of the two split-screen documents selected, wherein the selected document is the active window and would have a higher rank (the highest rank) than the other of the two split-screen documents since the higher (highest) ranked document is selected by the user. The third document behind the two split-screen documents would have a lower rank (the lowest rank) than both of the two split-screen documents since it is not visible to the user. Upon bringing the third document to the front of the display and on top of the two split-screen documents, the third document rank would then become the highest rank, while the two split screen documents' rank would become lower (the lowest) than the third document (and the rank of the two split screen documents can be equal).

In an example, the rank can be determined based on eye or gaze tracking of the user (consistent with or independent of whether a window is selected or has an active cursor). For example, a first window and a second window can be visible on the display, wherein the first window can include a video streaming from a streaming service and the second window can be a word processing document. The rank of the first window and the second window can be based on, for example, a gaze time that tracks how long the user's eyes have looked at one of the two windows over a predetermined time frame. The user may have the word processing document selected and active while the user scrolls through the document, but the user may actually be watching the video instead. In such a scenario, an accrued gaze time of the first window having the video can be, for example, 13 seconds out of a 15 second predetermined time frame, with the other 2 seconds in the predetermined time frame being attributed to looking at the first window having the word processing document. Thus, the rank of the first window having the video can be higher than the rank of the second window because the gaze time of the first window is higher than the gaze time of the second window. Notably, if there is only one open window, the rank of that window would be ranked as the top-ranked window (because it is the only window) regardless of/independent from other user input, such as gaze, selection, etc.

In some embodiments, the rank can be determined based on the eye tracking and a selection by the user. For example, the user can select the first window having the video and looking at a description of the video playing in the same first window. In such a scenario, both the eye tracking accruing a longer gaze time (than the second window) and the user selecting the first window to make it the active window can make the first window the top-ranked window.

Thus, the rank can be determined based on one or a number of elements. The more elements being used, the more accurate the determination of the rank. Hence, the rank can be determined by a combination of eye or gaze tracking, an input selection by a user (for example, the user clicking on an icon or a display element in a window (the first window or the second window), a user hovering a mouse or pointer over a portion of a window (without necessarily clicking or selecting anything), etc. The rank determination can also go beyond these elements/factors to include preset settings related to a particular user and/or past behavior/experiences. For example, the user can preset certain settings and/or the user's device can learn from user's past behavior/experiences about his/her preference when two or more windows are displayed at the same time side by side.

For example, a particular user may always play a video in the first window while working on a presentation in the second window. In such case, the user's device can learn from this behavior and use this knowledge to determine the rank more accurately (for example, when the first window has a video playing and the second window corresponds to a work processing document or a presentation, the active window is likely the second window). This knowledge can be paired with eye gaze direction and other factors such as mouse/cursor movement, etc. in order to determine the rank more accurately.

As further illustrated in FIG. 4A, at step 9720, the inspected main memory data can also include a reference patch therein and the first device 701 can identify the reference patch in the main memory data. In some embodiments, the first device 701 can detect and identify the reference patch in the main memory by a value, such as a known encoding, where the format of the of the data itself can indicate to the application where the reference patch is located. For example, the known encoding can be 25 bytes long and in a predetermined position within the binary bits of the main memory. In some embodiments, the first device 701 inspects the main memory data for bit data corresponding to the reference patch. For example, the bit data corresponding to the reference patch is an array of bits corresponding to pixel data making up a reference patch. In some embodiments, the presence of the reference patch is an attribute of an object or a class. In some embodiments, the reference patch is a file used by an application wherein the file is loaded into the main memory when the reference patch is displayed by the application. In some embodiments, the presence of the reference patch is indicated in metadata, e.g., with a flag. In some embodiments, the reference patch can be identified by parsing an application (e.g., a Word document), looking through the corresponding metadata in the computing memory space, and finding the reference patch in the metadata by attempting to match the metadata with a predetermined indicator indicating the presence of the reference patch, such as the unique identifier.

At step 9725, as shown in FIG. 4A, the first device 701 can determine whether the software application corresponding to the computing memory space (and sub-memory space) in which the reference patch was identified is active or in the displayed data. Referring to the example of step 9715, while the window of the first application can include the reference patch, the inactive window of the second application can become active and overlay over the window of the first application which was previously the active window. In such a scenario, the reference patch in the window of the first application can become covered by the window of the second application. As such, the digital content of the reference patch in the window of the first application need not be displayed or can cease being displayed. However, in an alternative scenario, the window of the first application, including the reference patch, can be active and the reference patch therein can be uncovered and visible. In some embodiments, the active window refers to the window with the most recent interaction, e.g., a click, a movement. In some embodiments, the first device 701 uses a priority list to determine which window is the active window. For example, digital content for a first application with higher priority than a second application will be displayed even if the second application covers the reference patch of the first application.

Still referring to FIG. 4A, at step 9730, upon determining the software application corresponding to the computing memory space (and sub-memory space) in which the reference patch was identified is active or in the displayed data, the first device 701 can decode the encoded data of the unique identifiers from the area of the reference patch, wherein the unique identifiers correspond to the surface area.

At step 9735, the first device 701 can use the unique identifiers to link the surface area with the digital content using metadata and retrieve the digital content based on the unique identifiers.

At step 9740, the first device 701 can overlay the digital content onto the surface area of the displayed data based on the unique identifiers.

Again, the method of identifying the reference patch included in the displayed data and augmenting the displayed data is described as performed by the first device 701, however, the networked device 750, the second client/user device 702, and/or the nth device 70n can alternatively or additionally perform the same functions.

In some embodiments, the first device 701 identifies the surface area corresponding to the reference patch by employing further processes. To this end, FIG. 4B is a flow chart of a sub-method of identifying the reference patch with the unique identifiers corresponding to the surface area from the stream of data, according to an embodiment of the present disclosure.

As shown in FIG. 4B, at step 9710a, the first device 701 can decode the encoded data associated with the reference patch from the main memory. The encoded data associated with the reference patch can include the unique identifiers encoded within the markers of the reference patch incorporated previously. The reference patch can also include other identifying information. The marker can be disposed within the reference patch, such as within the area of the reference patch or along a perimeter of the reference patch, or alternatively, outside of the area of the reference patch.

Again, whatever schema is used to encode data associated with the marker in the reference patch is also used in reverse operation to decode the underlying information contained within the reference patch. As stated above, in some embodiments, data can be encoded in patterns of the marker, which can be generated and decoded using the ArUco algorithm or by other algorithms that encode data according to a predetermined approach.

Similarly, as described above, and with reference back to FIG. 4B, at step 9710b, the first device 701 can also extract attributes of the surface area from the reference patch.

Further, at step 9710c, the first device 701 can also calculate a position and size of the surface area relative to the size and shape (dimensions) of the output signal from the display that is displaying the displayed data. In some examples, the first device 701 can provide information regarding the characteristics of the output video signal, such that the digital content that is later overlaid can correctly be displayed to account for various manipulations or transformations that may take place due to hardware constraints, user interaction, image degradation, or application intervention. Such manipulations and transformations may be the relocation, resizing, and scaling of the reference patch and/or the surface area, although the manipulations and transformations are not limited to those enumerated herein.

Similarly, as described above, the reference patch itself can be used as the reference for which the digital content is displayed on the surface area. In some cases, the first device 701 can determine an alternative location at which to display the digital content based on behaviors of the user.

In an example, the first device 701 employs other processes to associate the unique identifiers with the digital content. To this end, FIG. 4C is a flow chart of a sub-methods step 9720 for associating the unique identifiers with digital content, according to an embodiment of the present disclosure. At step 9720a, the first device 701 can send the unique identifiers to the second device 850 and the second device 850 can retrieve metadata that describes the digital content, the digital content being associated with the surface area through the unique identifiers. This can be done by querying a remote location, such as a database or a repository, using the unique identifiers of the surface area as the query key. In some embodiments, the first device 701 sends the unique identifiers to the second device 850 and the second device 850 associates the unique identifier of the reference patch to corresponding digital content based on the metadata. The metadata associated with the surface area's unique identifier can be transmitted to the first device 701 with the augmentation content.

As illustrated in FIG. 4C, at step 9720b, the first device 701 can assemble the digital content that is associated with the reference patch's (or a marker's thereof) unique identifier. The assembly can entail loading the necessary assets for assembling the digital content. In some embodiments, this can entail loading manipulation software or drivers in order to enable the first device 701 to process the digital content. Other assembling processes can be the loading of rendering information in order to transform and manipulate an individual portion of the digital content. Furthermore, the loaded manipulation software, drivers, or rendering information can be used to compile all the individual portions of the entire digital content together. In some embodiments, this can include adapting the file formats of the digital content, delaying the playback for the digital content, converting from one format to another, scaling the resolution up or down, converting the color space, etc.

Referring still to FIG. 4C, at step 9720c, the first device 701 can provide access control parameters for the digital content. The access control parameters can dictate whether the digital content is visible to some users, or to some geographical locations, or to some types of displays and not others, as well as the date and time or duration of time a user can access the digital content or is allowed to access. In some embodiments, visibility of the digital content can be defined for an individual. For example, the digital content can be a video that is appropriate for users over a certain age. In some embodiments, visibility of the digital content can be defined for a geographic location. For example, the digital content can be a video that is region-locked based on a location of the first device 701. In some embodiments, visibility of the digital content can be defined for a type of display displaying the displayed data. For example, the digital content can be VR-based and will only display with a VR headset. In some embodiments, visibility of the digital content can be defined for a predetermined date and a predetermined time. For example, the digital content can be a video that will only be made publicly available after a predetermined date and a predetermined time. In some embodiments, visibility of the digital content can be defined for a time period. For example, the digital content can be a video that is only available for viewing during a holiday. The first device 701 thus calculates the user's access level based on those parameters and provides an output result as to the user's ability to access the digital content, i.e., whether the digital content will be visible or invisible to the user. Note that the access control parameters can be global, for all the displayed data, or it can be localized per surface area and the underlying digital content.

Referring again to FIG. 4A, at step 9740, the first device 701 can carry on the processes of overlaying the surface area with the digital content into the displayed data in accordance with the surface area, the position, and the size identified by the unique identifier. The first device 701 can determine or adjust the size and location of the assembled digital content on the surface area relative to the size and shape of the displayed data being outputted by the display. Then, the first device 701 can render the associated digital content (or the assembled individual portions) over the surface area's shape and perimeter using the size and location information. Thus, the digital content is superimposed on top of the surface area.

The first device 701 can continuously monitor changes that are taking place at the end user's device (such as the networked device 750 of the second user) to determine whether the reference patch and/or the surface area has moved or been transformed in any way (see below for additional description). Thus, the first device 701 can continuously inspect subsequent frames of the stream of the data (for example, every 1 ms or by reviewing every new frame), displaying the displayed data, to determine these changes. The first device 701 can further continuously decode the reference patch's data from the identified reference patch. Then the first device 701 can continuously extract attributes from the data, the attributes being of size, shape, and perimeter and comparing those changes between the current frame and last frame. Further, the first device 701 can continuously calculate the size and location of the surface area and compare changes between the size and location of the surface area from the current and the last frame and then continuously overlay the digital content on the surface area by incorporating the changes in the reference patch's attributes and the changes in the size and location of the surface area. As stated above, when the user manipulates his/her display device by scaling, rotating, resizing, or even shifting the views from one display device and onto another display device, the first device 701 can track these changes and ensure that the digital content is properly being superimposed onto the surface area.

In some embodiments, the methodologies discussed with reference to FIG. 3 that use the frame buffer can be used without using the methodologies discussed with reference to FIG. 4 that use the memory space and vice-versa. In other words, in some embodiments, either the methodologies of FIG. 3 or the methodologies of FIG. 4 can be used to identifying a reference patch and overlay the digital content in displayed data.

However, in some embodiments, both the methodologies discussed with reference to FIG. 3 that use the frame buffer and the methodologies discussed with reference to FIG. 4 that use the memory space can be used together. In such embodiment, a device can use both approaches to accurately identify the same reference patch (applying both approaches can yield better results). In some embodiments, both approaches can be used to identify different reference patches. For example, if a document includes a plurality of reference patches, the first device can apply the methodologies discussed with reference to FIG. 3 to a first reference patch, while applying the methodologies discussed with reference to FIG. 4 to a second reference patch.

An illustrative example will now be discussed: a scenario where a user (for example, a user at the first device 701) receives (from another device such as the second client/user device 702) an email with the embedded reference patch in the body of the email or as an attached document. The reference patch within the displayed data (email) can show a facade of the digital content or the reference patch. The application on the first device 701 can scan the display to find the reference patch and the surface area and the attributes within the displayed data as it is being displayed. Furthermore, the first device 701 can access the digital content using the unique identifier and metadata and prepare it for overlaying. At which point, the user (i.e., the recipient) can select the digital content by various ways such as by clicking on the digital content's facade or the surface area, or otherwise indicating that it intends to access the digital content.

Thereafter, the digital content can be retrieved from the networked device 750 using the unique identifier and the metadata saved within a database that directs the networked device 750 to where the digital content is saved and can be obtained. That is, the networked device 750 can determine the digital content corresponding to the derived unique identifier and send the digital content corresponding to the unique identifier (and the metadata) to the first device 701. Then, the first device 701 can superimpose (overlay) the digital content on the surface area. While the digital content is being received and overlayed on the surface area, the first device 701 can continually monitor the location, size and/or shape of the reference patch and/or the surface area to determine movement and transformation of the reference patch and/or the surface area. If the user has moved the location of the reference patch and/or the surface area or has resized or manipulated the screen for whatever purpose, the new location, shape and/or size information of the reference patch and/or the surface area is determined in order to display the digital content properly within the bounds of the surface area. Thus, the digital content moves with the displayed data as the displayed data is moved or resized or manipulated.

In some embodiments, a user that has received the displayed data embedded with the reference patch can access the digital content on his/her first device 701, as described above. The user may want to transfer the ongoing augmenting experience from the first device 701 to another device, such as the device 70n, in a seamless fashion. In that scenario, the user is able to continue the augmenting experience on his/her smartphone, smartwatch, laptop computer, display connected with a webcam, and/or tablet pc. The user therefore can capture the embedded reference patch and therefore the encoded attributes, as the digital content is being accessed and overlaid unto the surface area. The user can capture the embedded reference patch by taking a picture of it or acquiring the visual information using an image capturing device of the second client/user device 702 as mentioned above. The user can capture the embedded reference patch by accessing the main memory of the second client/user device 702 as mentioned above.

Assuming the user also has the functionality included or the application installed or executing on the device 70n, the device 70n would recognize that an embedded reference patch and markers including encoded unique identifiers are in the captured image/video stream or in the main memory of the device 70n, such as in the corresponding computing memory space as the software application currently active on the device 70n. Once the surface area has been determined and the reference patch decoded, the digital content can be obtained from the networked device 750, using the unique identifiers and the metadata and then overlaid on the surface area within the displayed data displayed on the device 70n. In some embodiments, as soon as the device 70n superimposes the digital content onto the surface area, the networked device 750 or the backend determines that the stream has now been redirected onto the device 70n and thus pushes a signal to the first device 701 to stop playing the digital content on the first device 701. The device 70n that is overlaying the digital content therefore resumes the overlaying at the very same point that the first device 701 stopped overlaying the digital content (for instance, when the content is a video). Thus, the user is able to handoff the digital content from one device to another without noticing delay or disruption in the augmenting experience.

In some embodiments, the visibility of the digital content is dynamic and can be adjusted. For example, in one context an augmentation overlaps with another image and obscures the image by being displayed in front of the image. At a later time, the augmentation is displayed behind the image such that the image obscures the augmentation when the augmentation is no longer needed. In some embodiments, the transparency of an augmentation can be adjusted to show objects in the same location as the augmentation. In some embodiments, the interactive properties of digital content are also dynamic and can be modified. Click-ability refers to whether an object can be clicked or otherwise activated by a trigger, thus causing an action to be performed. The action includes, but is not limited to, sending data, receiving data, and/or modifying display content. When the click-ability of an object is on, the trigger causes the action to be performed. When click-ability of an object is off, the trigger does not cause the action to be performed. Touch-ability is a subset of click-ability wherein the trigger is a touch using a touch panel. The trigger can be collected by an input device, including, but not limited to, a mouse, a keyboard, a touch panel, a camera, and/or a microphone.

The click-ability of any augmentation layer and/or object of digital content can be modified. In some embodiments, the click-ability of an object in a layer can be modified independently of other objects in that layer. For example, only one button is active (clickable) while other buttons in the augmentation are not active. In addition, objects in different layers can simultaneously be clickable. For example, the original displayed data is a slide deck wherein a slide in the slide deck includes a button for proceeding to a next slide. The slide includes a reference patch, and an electronic device identifies the reference patch and displays an augmentation including a multiple-choice survey. The answers to the multiple-choice survey and the button for proceeding to the next slide are all clickable, enabling a user to interact with the augmentation as well as the original displayed data. In another embodiment, the button for proceeding to the next slide is not clickable until an answer to the multiple-choice survey has been collected. Thus, inputs and interactions on one layer can be used to affect another layer. In some embodiments, transparency and click-ability can be adjusted at a pixel level. For example, if an object is partially obscured, only the visible part of the object is clickable.

In some embodiments, click-ability and transparency can be connected. For example, a first clickable object in a first layer and a second clickable object in a second layer are located on the same surface area of a display. The click-ability of the first clickable object is on and the click-ability of the second clickable object is off for a period of time. During this period of time, the second clickable object is transparent and only the first clickable object is visible on the display. After the period of time elapses, the click-ability of the first clickable object is turned off, while the click-ability of the second clickable object is turned on. Accordingly, the first clickable object is then transparent while the second clickable object is not transparent. The transparency and click-ability of the objects can be set independently of the order in which layers are created, edited, retrieved, and/or displayed. In another example, an electronic device displays a full-screen Microsoft PowerPoint® presentation and full-screen scrolling speaker's notes at the same time in one window, wherein the click-ability of any of the pixels of the presentation and the notes can be adjusted to be on or off. The result is a multi-layered content stack experience wherein attributes such as transparency and click-ability for any layer in the stack can be adjusted at the pixel level.

In some embodiments, pixels in one layer can have click-ability on, while pixels in the remaining layers can have click-ability off. Further, portions of pixels within layers that have click-ability off can have their click-ability turned on, while the remaining pixels in that layer remain off (and vice versa). The determination of which pixels have click-ability on and off can be determined based on parameters including, but not limited to, user settings, hot spots, application settings, user input. Hot spots can refer to regions of a computer program, executed by circuitry of a device, where a high percentage of the computer program's instructions occur and/or where the computer program spends a lot of time executing its instructions. Examples of hot spots can include play/pause buttons on movies, charts on presentations, specific text in documents, etc.

Referring back to the displayed data discussed above, in an example, the displayed data can be a page of a website. The webpage may be dedicated to discussions of strategy in fantasy football, a popular online sports game where users manage their own rosters of football players and points are awarded to each team based on individual performances from each football player on the team. After reading the discussion on the website page, the reader may wish to update his/her roster of football players. Traditionally, the reader would be required to open a new window and/or a new tab and then navigate to his/her respective fantasy football platform, to his/her team, and only then may the reader be able to modify his/her team. Such a digital user experience is cumbersome and inefficient. With augmentation, however, the reader may not need to leave the original webpage as a reference patch corresponding to a fantasy football augmentation may be positioned within the viewable area of the website page. The corresponding augmentation may be, for instance, an interactive window provided by a third-party fantasy football platform that allows the reader to modify his/her roster without leaving the original website. Thus, instead of navigating to a different website and losing view of the informative fantasy football discussion, the reader can simply interact with the digital object of the augmentation in the current frame of displayed data because of the presence of the reference patch.

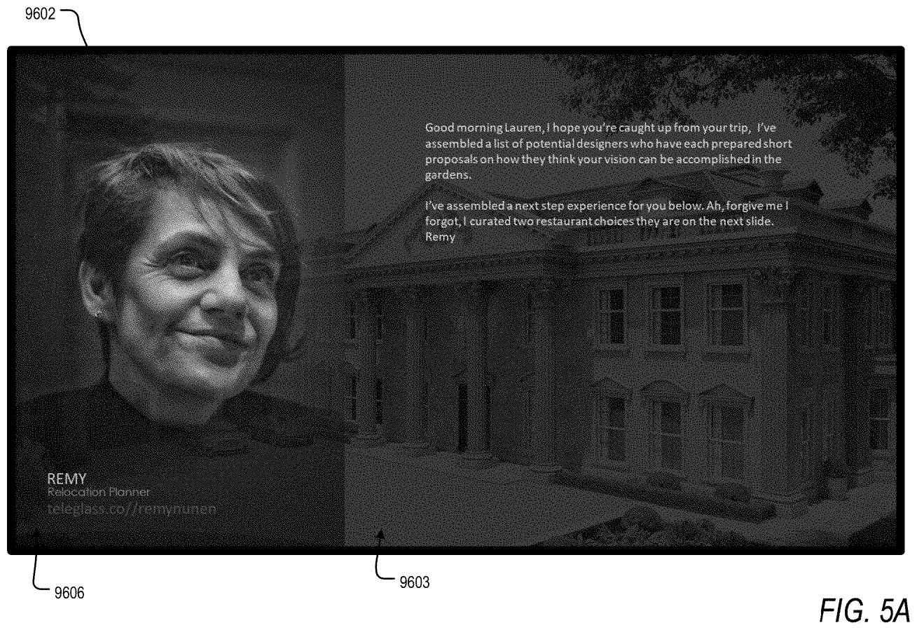

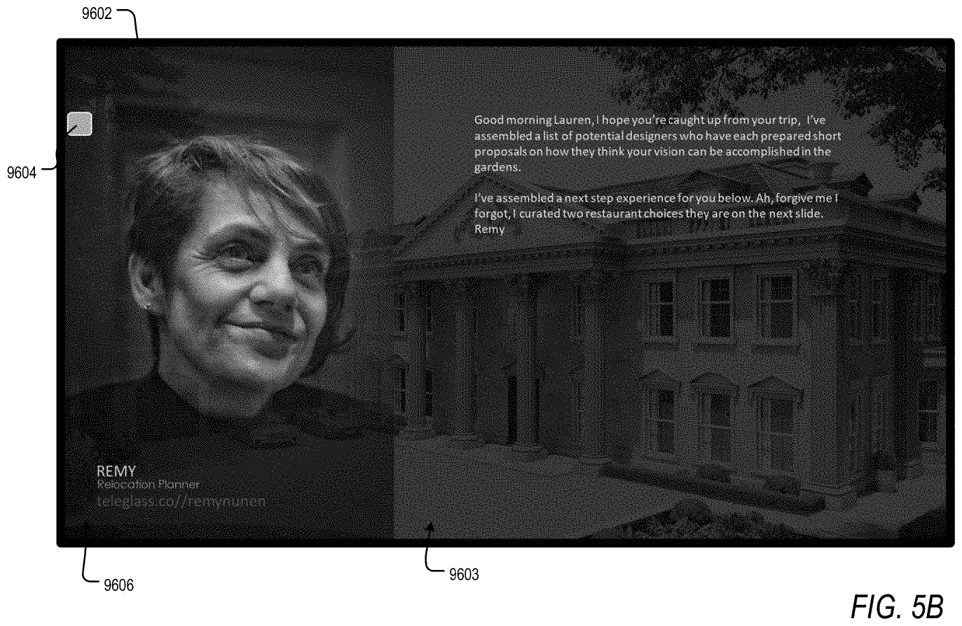

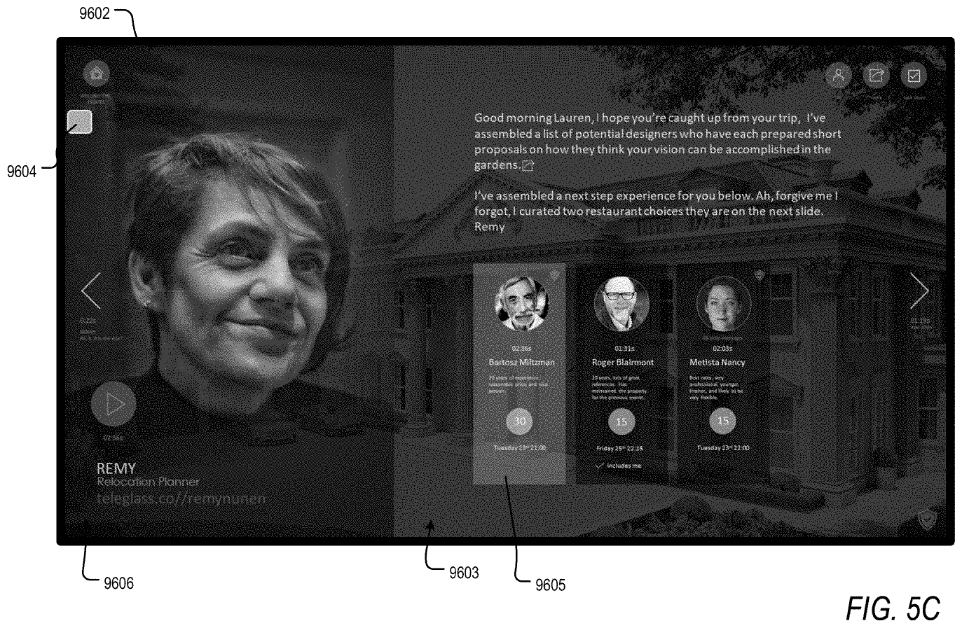

In another example, as will be described with reference to FIG. 5A through FIG. 5C, the displayed data can be a slide deck. The slide deck may be generated by a concierge-type service that seeks to connect a client with potential garden designers. As in FIG. 5A, the slide deck may be presented to the client within a viewable area 9603 of a display 9602. The presently viewable content of the slide deck within the viewable area 9603 of the display 9602 may be a current frame 9606 of displayed data. Traditionally, the slide deck may include information regarding each potential garden designer and may direct the client to third-party software applications that allow the client to contact each designer. In other words, in order to connect with one or more of the potential garden designers, the client, traditionally, may need to exit the presentation and navigate to a separate internet web browser in order to learn more about the garden designers and connect with them. Such a digital user experience is cumbersome and inefficient. With augmentation, however, the client need not leave the presentation in order to set up connections with the garden designers. For instance, as shown in FIG. 5B, a reference patch 9604 can be positioned within the slide deck so as to be in the current frame 9606 and viewable within the viewable area 9603 of the display 9602 at an appropriate moment. As shown in FIG. 5C, the reference patch 9604 may correspond to one or more augmentations 9605 and, when the reference patch 9604 is visible, the augmentations 9605 are displayed and brought to life. The one or more augmentations 9605 can include, as shown in FIG. 5C, interactive buttons, images, videos, windows, and icons, among others, that allow the client to interact with the secondary digital content and to, for instance, engage with the garden designers without leaving the presentation. In an example, the interactive augmentations 9605 may allow for scheduling an appointment with a given garden designer while still within the slide deck. In some embodiments, the augmentations are only presented when the reference patch is included in the displayed data. In some embodiments, the reference patch identifies the location of the digital content of the augmentation within the surface area at which the digital content can be located (e.g., the reference patch is associated with a unique identifier which can include or be associated with position, size, and location data for the digital content). The digital content of the augmentations is visually integrated into the displayed data.

The above-described augmentations are particularly relevant to environments where the underlying content is static. Static content may include textual documents or slide decks. Often, the static content is stored locally. A result of the static content is static augmentations that are not capable of dynamically adjusting to or being adjusted dynamically according to complex user interactions, in real-time, during a user experience. The addition of dynamic augmentations improves user experience by providing additional data and personalized, interactive elements.

Such a dynamic environment includes one where, for instance, a video conversation is occurring. A first participant of the video conversation may share his/her screen with a second participant of the video conversation and wish to remotely control an augmentation on a display of a device of the second participant. By including a reference patch within the displayed data that is being ‘shared’, which may be the video itself or another digital item, where sharing the displayed data includes transmitting the displayed data over a communication network from the first participant to the second participant, the second participant may be able to experience the augmentation when the device of the second participant receives the transmitted displayed data and processes it for display to the user.

Generally, and as introduced in the above example of a dynamic environment, a reference patch can be inserted into displayed data displayed on a first computer. The display of the first computer can be streamed to a second computer. In an example, the second computer decodes the streamed display and identifies the reference patch in the displayed data. Based on the identified presence of the reference patch, the second computer can locally augment the display of the second computer to overlay the intended augmentation on the ‘streamed’ display from the first computer. The design and the arrangement of the augmentation can be provided relative to the reference patch placed into the displayed data on the first computer. The augmentation can include a number of objects to be displayed and may be configured to display different subsets of objects based on interactions of a user with the augmentation. The objects, therefore, can be interactive. In some embodiments, the second computer can retrieve the augmentation from a server. Thus, the augmentation is not included directly in the displayed data streamed from the first computer to the second computer but is retrieved and included in the display at a later time. In some embodiments, the unique identifier included in the reference patch provides further information and/or instructions for retrieving the augmentation.

Described herein is a method, system, and apparatus that leverages visual data obtained from one or more detection devices in combination with one or more displays to generate a content viewing experience that establishes a new immersive interactive reality or reactive reality with multiple perspective adjustment. The new (visual) reality is a connection between a viewing entity such as a human, animal, or robot and a display screen. The connection between viewing entities and screens are volumetric, three-dimensional, and offer 360 degrees of viewing freedom between the viewing entity (user) and the screen.

The system can connect a human (the user) to a personal computer, screen of a smart vehicle, television, or mobile device in a way where the human can look into and immerse him/herself in the content from different perspectives, leaning to the side to look around items in the content, leading forward towards the screen and image capturing device to look closer at the content by advancing the viewing perspective of the content forward, and leaning back away from the screen to look from further away from the content by retracting the viewing perspective of the content backwards.

Additionally, the system (e.g., the system providing the immersive experience), and outputs generating the immersive experience, can be based in part on static or dynamic visual data. In some examples, the immersive experience can be responsive to objects in a field of view of the detecting devices detecting the visual data. By way of illustration, the visual data can include a clock in a field of view of the image capturing device, and the immersive experience can be responsive to a time shown on the clock (e.g., a brightness of the virtual environment can be adjusted to mirror a time of day of the user, as gathered from the clock). The immersive experience can be responsive (e.g., through a display, speaker, or any other output device) to other static visual information, such as, for example, a logo or brand symbol in a field of view of an image capturing device, which, in some cases can function as a digital marker or reference patch (e.g., similar to the reference patch described above).

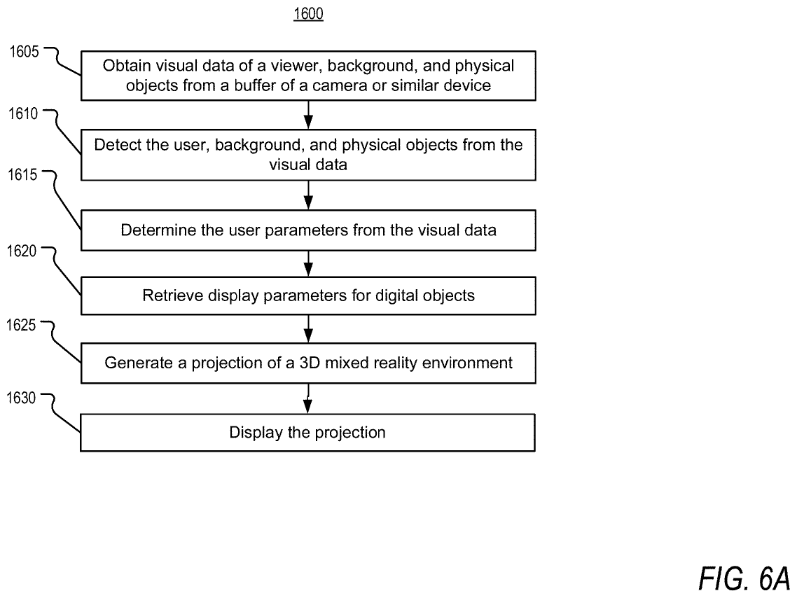

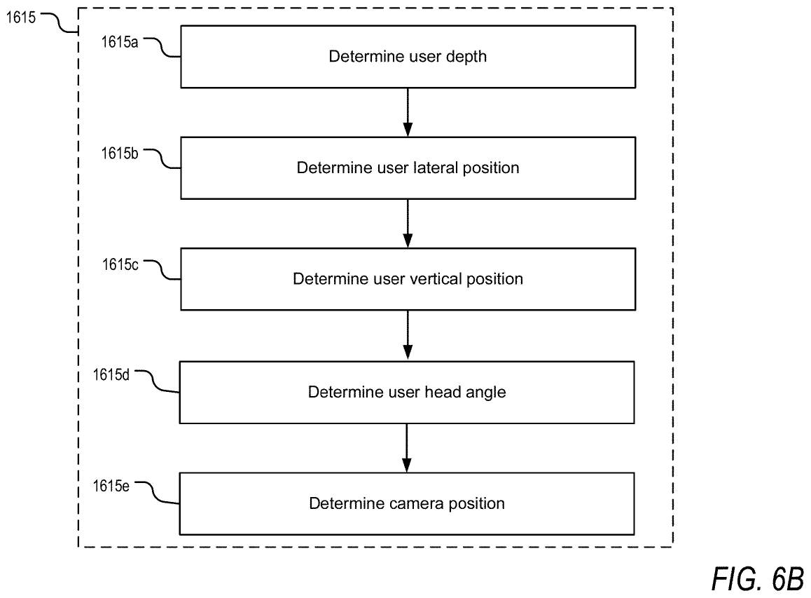

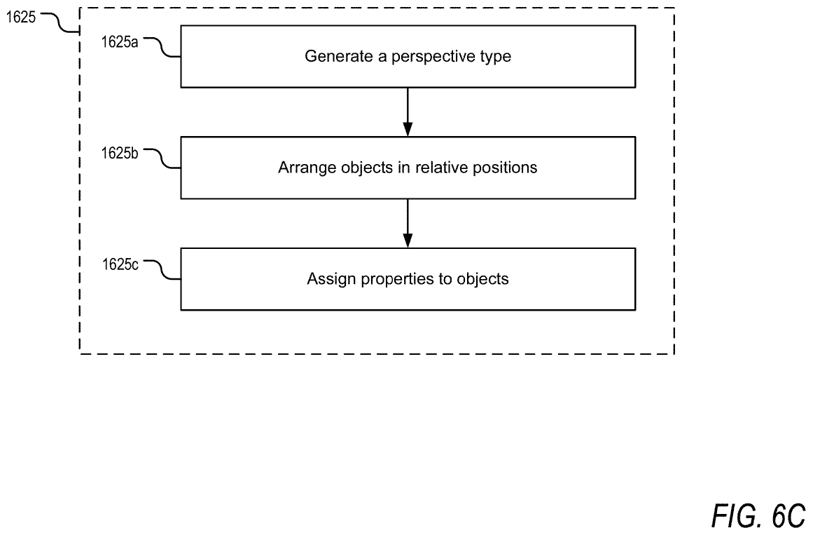

To this end, FIG. 6A is a flow chart outlining a method 1600 of generating a projection of a mixed reality environment with the perception of depth and perspective adjustment, according to an embodiment of the present disclosure. In some embodiments, the device 701 can incorporate virtual content into the projection of the environment and adjust the virtual content based on the position and perspective of a user for a more immersive experience.

At step 1605, a device can obtain visual data of the user, background, and/or a physical object (or multiple physical objects) from an image capturing device (e.g., digital camera) or similar device. For example, the buffer of the image capturing device, or the similar device can be accessed by the device 701 to inspect the visual data therein. It may be appreciated that the device 701 can include more than one image capturing device or similar device that can obtain footage of, for example, the user and the user's background. In some examples, the visual data can be obtained through devices or sensors other than image capturing devices, for example, through LiDAR scanners, motion sensors, or other devices that can collect visual data. In some embodiments, visual data can be derived from devices that can collect data through non-photonic means and could comprise RADAR scanners and the like.

At, step 1610, the device can detect the user, the background, and the physical object from the obtained visual data.

At step 1615 (discussed in more detail in FIG. 6B), the device can determine first user parameters from the obtained visual data. User parameters can include user lateral position, user vertical position, user depth or distance from the image capturing device, user head orientation which may comprise a user head yaw angle and a user head pitch angle, and user eye gaze angle. The device 701 can obtain and analyze the visual data from an embedded or connected image capturing device or similar device, such as via accessing a buffer of the connected image capturing device. In some cases, the user parameters can be dynamic parameters, and could, for example, include a lateral velocity, lateral acceleration, vertical velocity, vertical acceleration, rate of angular rotation of a user's head, velocity of a user's approach to the image capturing device, and the like. Further, user parameters can be determined using relative values, and an offset of a user's original lateral position, vertical position, or distance from an image capturing device can be measured and provided as a user parameter.

At step 1620, the device can retrieve display parameters of a digital object to be displayed as part of the virtual content. In some embodiments, the device 701 can detect the digital object (or multiple digital objects) configured to be displayed on the device 701 or receive digital objects to be displayed from another device, such as a second user's device during a teleconference. For example, the reference patch can be detected and the secondary content (including the digital object(s)) corresponding to the reference patch can be displayed as part of the environment. The device 701 can receive the digital object's display parameters from the device 701 or from another source (e.g., a server or another device connected to the device 701, such as the second user's device during the teleconference).

At step 1625 (discussed in more detail in FIG. 6C) the device generates a projection of a 3D mixed reality experience with the perception of depth and parallax compensation.

Finally, at step 1630 the device can display the projection. The steps in method 1600 are not limited to a sequential application. Different embodiments can achieve method 1600's results by executing the steps in a different sequence.

In some embodiments, steps 1605-1630 can be performed by the (user's) device 701. For a scenario where there is more than one user, each users' device can perform the steps. Each users' device (e.g., any or all of devices 702, 70n, 7001) collects the required data, analyzes it, and creates and displays the 3D mixed reality projection based on the user's positioning. In some embodiments, steps 1605, obtaining the data, and 1630, displaying the projection, can be performed by each users' device. The data obtained in step 1605 can be sent to a central, server-side device where steps 1610-1625 can be performed, and the created projection can be sent back to the user's device for display. This embodiment allows for the 3D mixed reality projection to be displayed on devices that lack the processing power to analyze and create the projection.

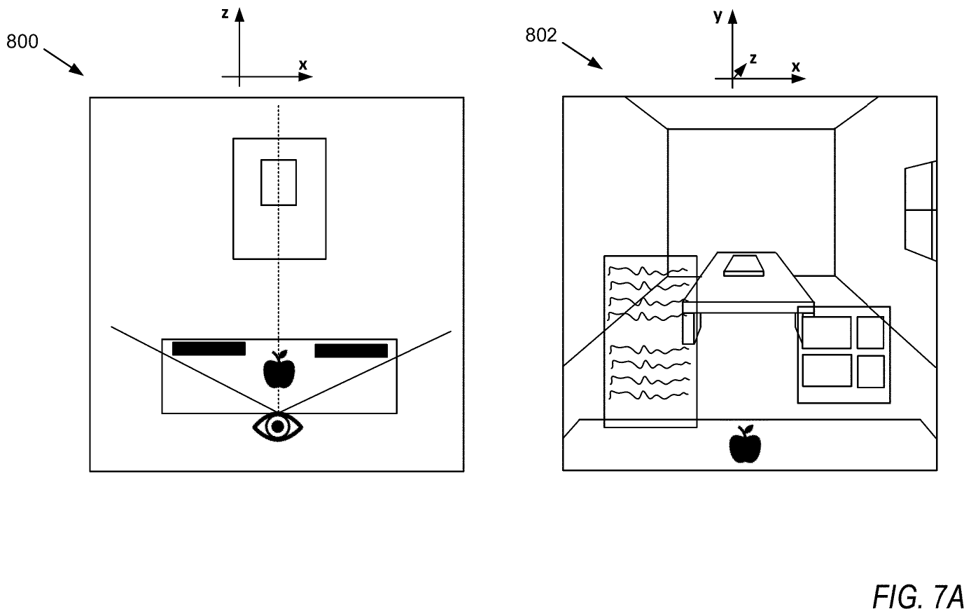

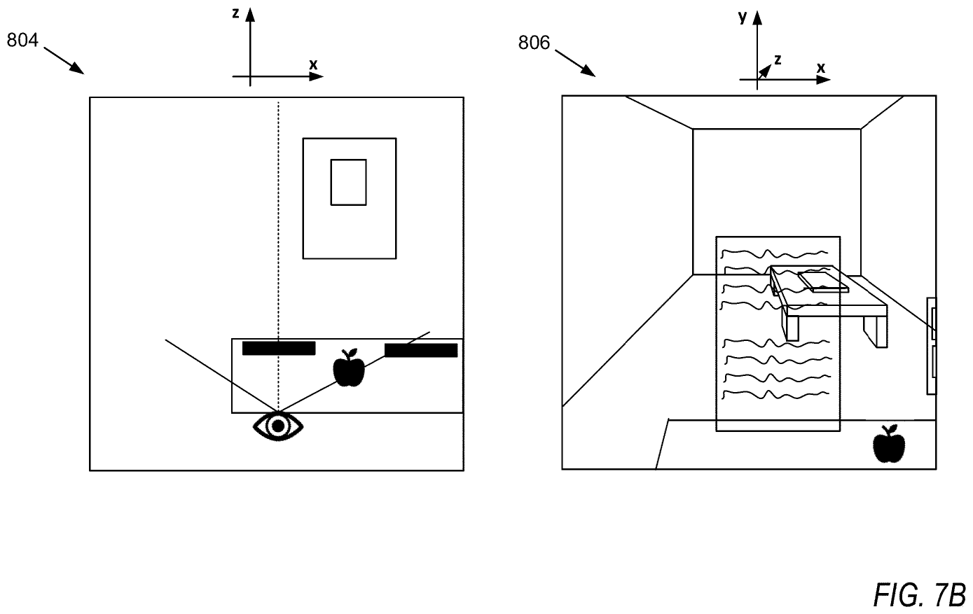

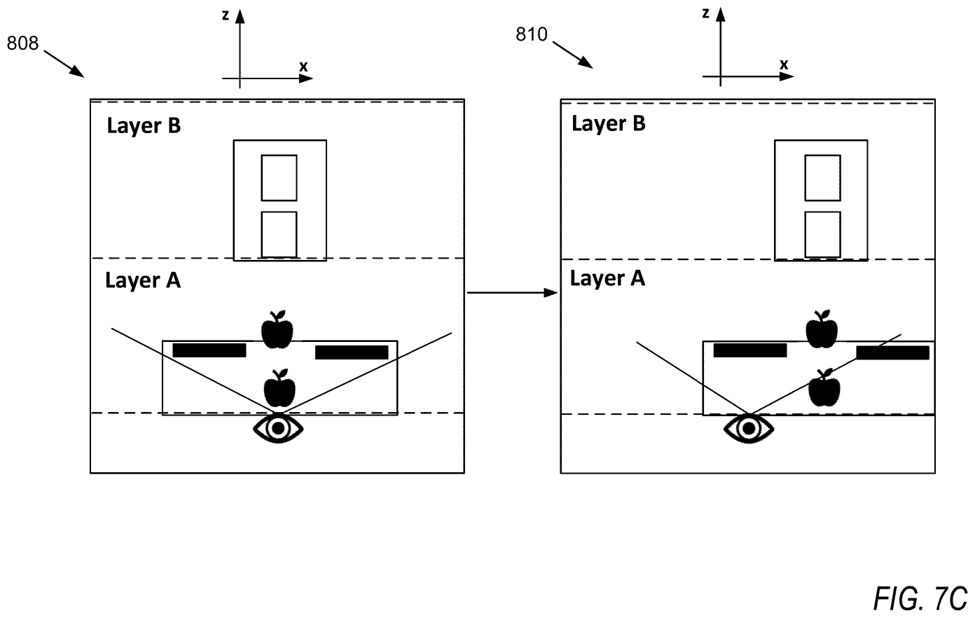

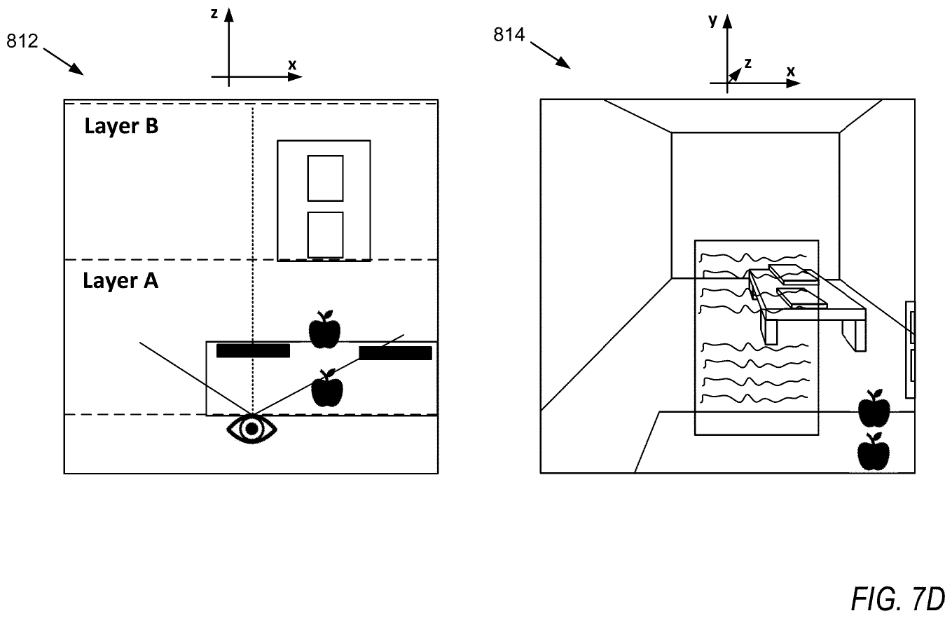

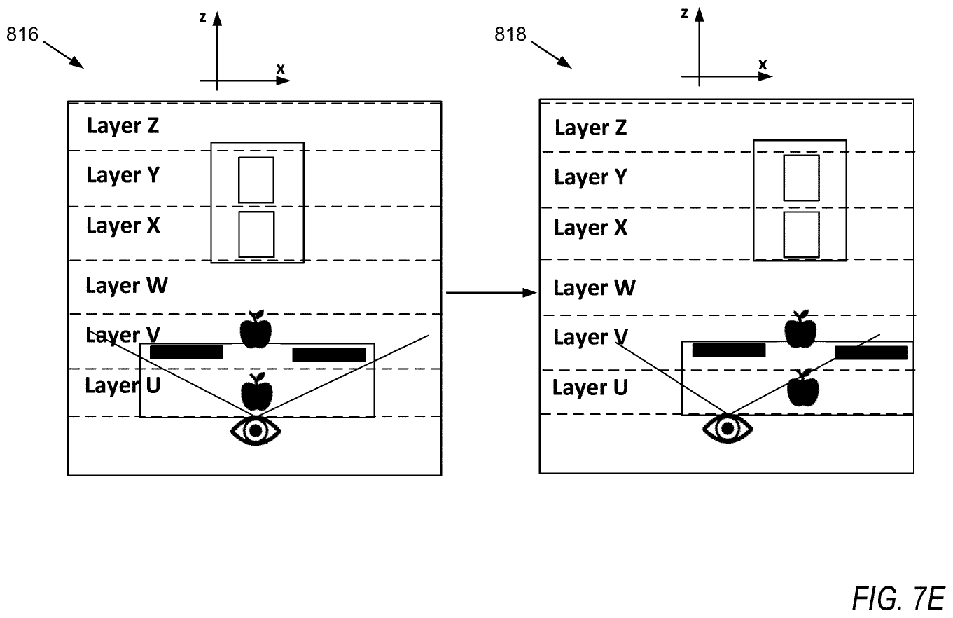

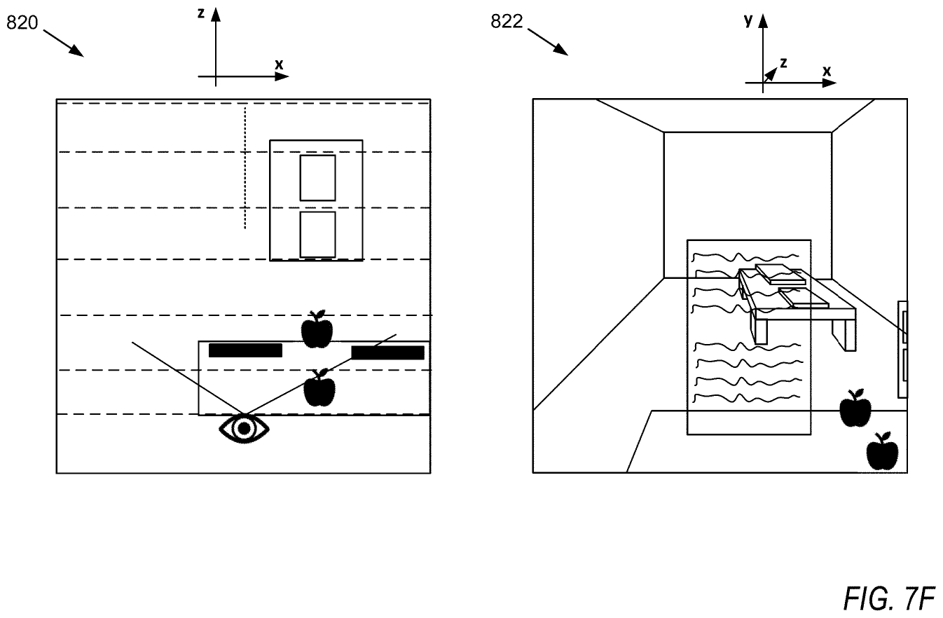

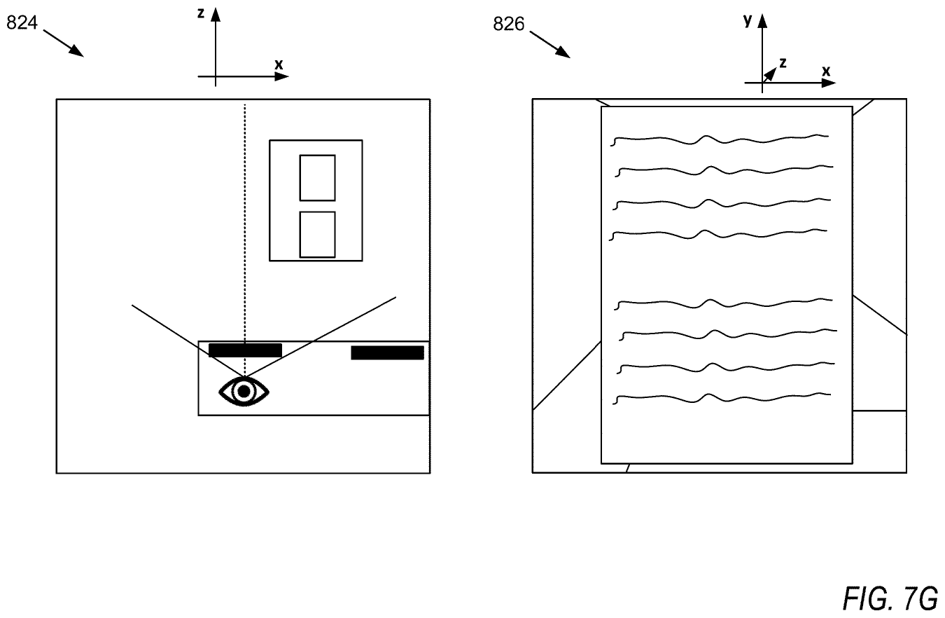

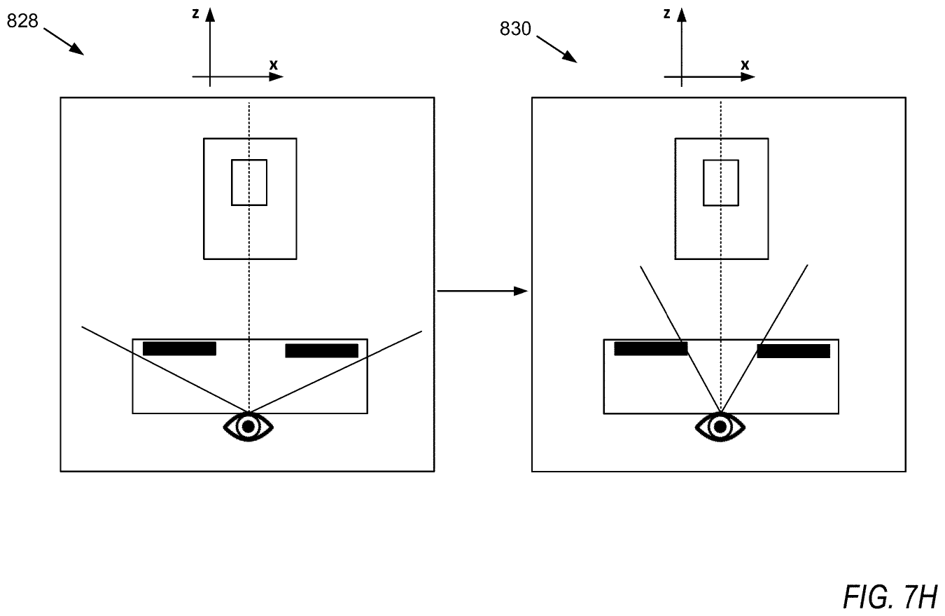

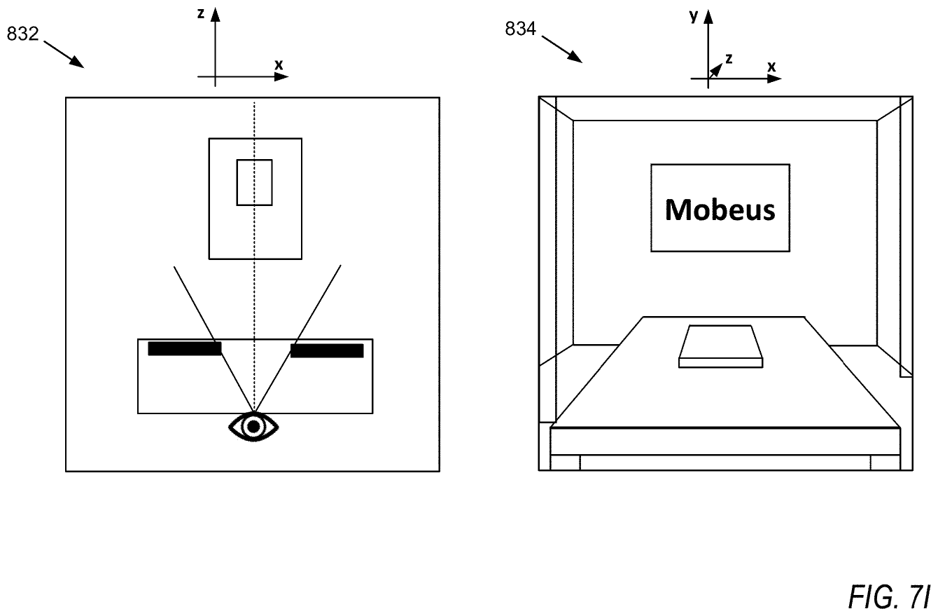

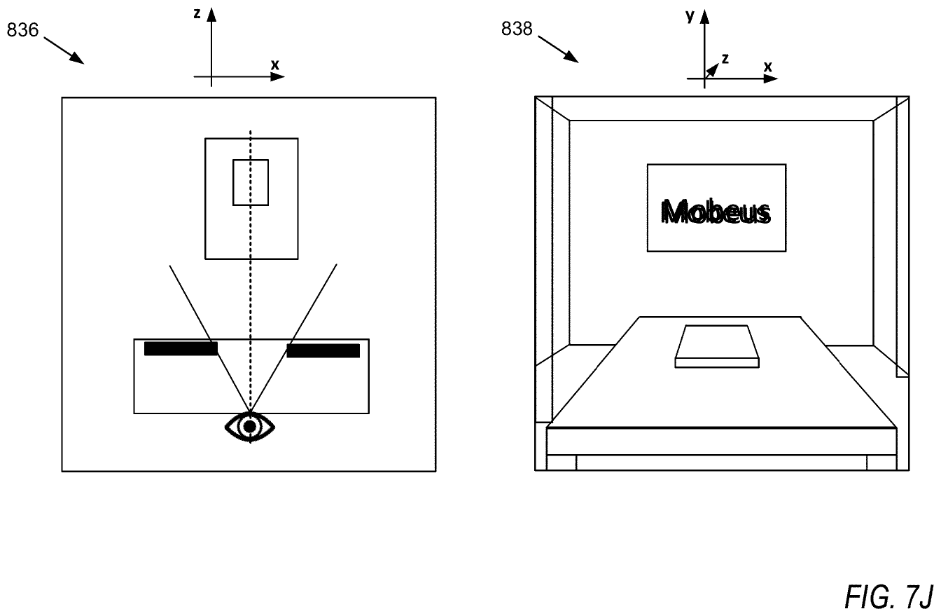

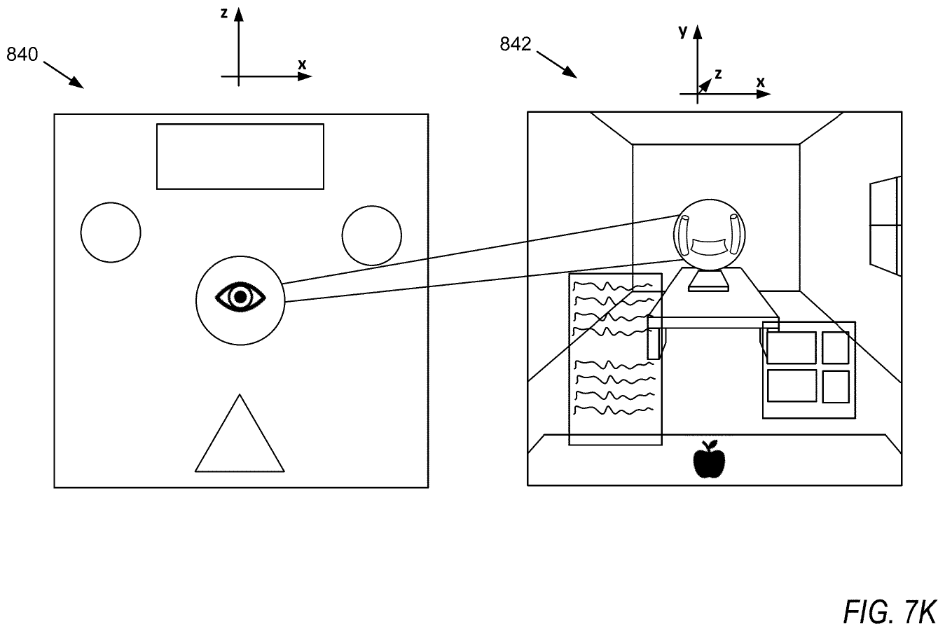

FIG. 7A-7J show schematics of an example of perception of depth and perspective adjustment in a generated 3D mixed reality experience, according to an embodiment of the present disclosure. In an example, the user (user A) can be viewing the projection of the 3D mixed reality experience, wherein the generated environment (the projection) is a room or an office and only the user is interacting with or included in the environment. User A's device can create the projection based on the position of user A relative to the image capturing device of the device 701. When user A changes positions, the projection created by user A's device can change to maintain the expected POV from the new position as detected via the image capturing device and the image capturing device buffer by the device 701.

FIG. 7A illustrates a schematic view 800 of an office as viewed from a user's perspective, according to some examples, and further illustrates a 3D projection 802 of the office, as viewed from the perspective illustrated in schematic view 800. As shown in FIG. 7A, a first object and a second object can be disposed in the environment, wherein the first object can be disposed farther from the user than the second object. For example, the user can be sitting at a desk in the office and the office can include, from the perspective of the user, a left wall, a right wall, a far or back wall set at a predetermined distance away from the user (e.g., 20 feet away from the user), and a coffee table disposed between the desk and the back wall. The first object can be an apple disposed on the desk that can be a distance of 2 feet away from the user, and the second object can be a book disposed on the coffee table that can be a distance of 15 feet away from the user. For the purposes of this example, the user, the first object, and the second object can be aligned substantially centered between the left wall and the right wall.

Notably, each object can include a z-index. As previously described, the z-index of an object can describe a third-dimensional arrangement of the objects on the display. Some objects in some applications can include a z-index, but the potential and full implementation of the z-index to generate and supplement a mixed reality environment for a user are not fully actualized yet. For example, a slide in Microsoft® PowerPoint® can include a first box and a second box overlaying the first box, wherein the z-index of the second box as compared to the z-index of the first box can describe how the second box is occluding the first box on the slide. That is, the user will not see the first box behind the second box, assuming the second box has no transparency. Here, the z-index is only used for occlusion.

For example, many websites including objects can have a built-in, dormant z-index for the objects, such as the cells, tables, text, images, etc. on the website, that describe how the website appears to the user. Again, the z-index of the objects on the website is only used for occlusion.

For example, Adobe® Photoshop® can be used to edit images including many layers and objects, wherein each object includes a z-index. A flyer being generated can include informational text and a background image, wherein the informational text's higher z-index describes how the informational text occludes the background image to convey the important event information to the viewer. However, again, the z-index is only used to describe how the objects occlude one another.

For example, windows in the Windows® operating system can include a z-index to describe windows that are visible to the user, such as Microsoft® Teams overlayed on top of Microsoft® Word® during a video conference. Again, here, the z-index is only used to describe how the windows occlude one another.

The optical lenticular viewing perspective described herein introduces a new purpose and functionality for the z-index of objects. Use of the stream of data and intelligence from the image capturing device feed (buffer) can enable calculation and determination of the optical lenticular viewing perspective of an observing entity. Now, each object having a z-index in a created mixed reality environment can be moved or adjusted with a different speed in reaction to a user's perspective shift to generate the perception of depth of all z-indices.

This experience can be generated using an optical fulcrum where the perspective shift of the user is centered. For example, a website that is normally observed as being 2D can be modified using the z-indices of the objects on the website. The website can include a slide overlaying two videos appearing behind the slide in a split-screen configuration (a first video feed on a first half of the display and a second video feed on a second half of the display), as earlier described. In a normal 2D configuration, there is no reaction of the objects to the user's head movement. However, in the generated observed 3D mixed reality environment, the video feeds and the slide can each include a z-index. As the user moves the user's head, there is an instantaneous 3D reaction. In accordance with an example, to create an example reaction, the website can include 4 layers and an optical fulcrum, wherein the optical fulcrum is positioned at the location of the user's display, a first layer is the slide at 50% transparency and disposed 0.5 inches (in.) away from the display towards the user, the second layer is the slide repeated again at 25% transparency and disposed 0.25 in. away from the display towards the user, the third layer is the layer including the video feeds at 25% transparency and disposed 0.25 in. away from the display away the user (i.e., appearing to be positioned behind the display), and the fourth layer is the layer including the video feeds repeated again at 50% transparency and disposed 0.5 in. away from the display away from the user. As the user moves, the position of the user can change relative to the optical fulcrum and the layers can react accordingly relative to the new position of the user. The observed effect to the user can be that of the objects on the slide appearing to pop out over the video feeds and shifting more relative to the shift of the video feeds. The relative shifting of layers and objects in layers is described further below. In some embodiments, a virtual environment can include more than 4 layers or less than 4 layers.

Returning to the example of the office, FIG. 7B illustrates a schematic view 804 of the office illustrated in schematic view 800, with the perspective of the user shifted left relative to the perspective shown in schematic view 800. FIG. 7B further illustrates a 3D projection 806 of the office, as viewed from the perspective shown in schematic view 804. As shown in FIG. 7B, upon the user moving laterally to the left, the parallax effect, or the change in POV of the user can result in a change in the position of the first object and the second object as viewed by the user. That is, in real life, the user can expect objects disposed closer to the user to change position more than objects disposed farther from the user when the user moves. Thus, in the 3D mixed reality experience environment, the first object (the apple) can appear to shift farther laterally away from the user than the second object's (the book's) lateral shift away from the user (and since everything is centered in the example, both the first object and the second object would shift in the same direction—to the right, relative to the user). This predetermined shift of each object in the environment can be calculated by the device 701 continually based on the position of the user and the position of the physical and digital objects. As noted above, the first object and the second object can be included in separate layers and the layers can be configured to shift in the virtual environment to simulate the expected adjustments due to the POV change in the virtual environment.

To that end, FIG. 7C shows schematic views 808, 810 of the office example above, divided into two layers: a layer A and a layer B, wherein the office additionally includes a second apple (a third object) and a second book (a fourth object) disposed proximal and aligned in the z-direction with the first apple (the first object) on the desk and the first book (the second object) on the coffee table, respectively, before any shifting of the user. Notably, because there are only two layers, both of the apples are disposed in layer A and both of the books are disposed in layer B. Plan view 810 illustrates a perspective that is shifted left relative to the perspective shown in schematic view 808. As previously shown in FIG. 7B, upon shifting to the left, the perspective shift of the user can result in the objects shifting to the right, with the apple shifting more than the book. While the same can occur in FIG. 7C, the limitation of having only two layers can result in the two apples shifting the same amount and the two books shifting the same amount when the device 701 generates the updated 3D mixed reality environment. Thus, as shown in FIG. 7D, which includes a schematic view 812 of a user shifted left relative to schematic view 808 (e.g., as also shown in schematic view 810), and a 3D projection 814 corresponding to the perspective shown in schematic view 812, the updated view for the user that has shifted left can be partially incorrect. In particular, both of the apples have shifted to the right by the same distance because both of the apples were disposed in layer A, and both of the books have shifted to the right by the same distance (with the set of apples and the set of books shifting by different distances, and the set of apples shifting farther than the set of books) because both of the books were disposed in layer B. This issue can be remedied by including additional layers. as discussed below.

To that end, FIG. 7E illustrates schematic views 816, 818 of the office example of FIG. 7C divided into six layers: a layer U, a layer V, a layer W, a layer X, a layer Y, and a layer Z. Plan view 818 illustrates a perspective that is shifted left relative to the perspective shown in schematic view 816. Notably, the two books and the two apples can each be disposed in separate layers. FIG. 7F, illustrates a schematic view 820 of a user shifted left relative to schematic view 816 (e.g., as also shown in schematic view 818), and a 3D projection 822 corresponding to the perspective shown in schematic view 820. As shown in FIG. 7F, upon shifting to the left, the perspective shift of the user can result in the objects shifting to the right, but the two apples will shift a slightly different distance compared to one another and the two books will shift a slightly different distance compared to one another in order to account for the slight off-set of the objects in the z-direction. Thus, since each individual layer shifts while also having only one object in each individual layer, a more accurate updated 3D mixed reality environment is generated depicting more accurate object adjustment in response to the user changing position and perspective.

In an example, a first user (user A) and a second user (user B) are in a video conference. User A's device can create the projection or environment based on user A's position. Similar to the previous example, when user A changes positions, the projection created by user A's device can change to maintain the expected POV from the new position. At the same time, user B's device also can create a projection based on user B's position and when user B changes positions, the projection created by user B's device can change to maintain user B's expected POV from the new position.

Additionally, since user A and user B are interacting, as user A and user B move, their positions in the virtual environment can shift so that the content processed to create the projection reflects the new positions. Depending upon the environment parameters (e.g., the number of data streams or the type of meeting or activity), the changes can occur within a layer or between layers. This means that if user A moves away from the screen, the virtual environment could change user A's location in the z-dimension of the current layer or move user A to another layer to present a projection that makes user A appear further from the screen (user A's device would simultaneously be creating a projection for user A to see that accounts for user A having moved further away from the screen like the objects furthest from view in the projection becoming less detailed to user A).

To that end, FIG. 6B is a flow chart outlining sub-methods of step 1615 for determining user parameters from obtained visual data, according to an embodiment of the present disclosure. Again, the sub-methods for step 1615 are not limited to a sequential application. Different embodiments can achieve sub-method 1615's results by executing the steps in a different sequence.

Referring again to FIG. 6B, the step 1615 can include sub-methods to determine a user lateral position, user vertical position, and/or a user depth or distance from the image capturing device. Again, the buffer of the image capturing device can be accessed by the device 701 and each frame analyzed. In some cases, user parameters can be determined using approximate known dimensions or ratios for features of a user, including facial features. For example, the user's eyes can be detected, and a machine learning motion model can be used to determine the user parameters. The approximate distance between a person's eyes can be a known value. Such a distance can be, for example, input by the user as part of a user profile, measured using a standardized measurement or reference measurement, or be a standardized value representing a mean eye-to-eye distance. Such a standardized value can be generalized for a suitable demographic, such as age, sex, ethnicity, or the like.

In some embodiments, in step 1615a, the user depth can be determined, which can be based in part on detected feature of the user, as described above. For example, using the known approximate distance between the user's eyes, the user's depth can be determined based on foreshortening. The data can be analyzed using a deep learning method. The deep learning method can analyze the image for information helpful for determining depth like distance between objects, colors, contrast, brightness, detailing, and lighting. Once trained, the deep learning method can use the gathered data to extrapolate parameters of objects in the image.

In some embodiments, in step 1615b, the same can be used to determine the lateral position of the user. For example, the user's eyes can be detected and tracked as the user changes position along a horizontal or x-direction in the captured frame. The user's eyes and their distance relative to edges of the captured frame, or the user's eyes' horizontal or x-direction coordinates can be used to determine the lateral position of the user. Notably, the distance between the user's eyes is not as needed in this instance to determine the lateral position of the user but can be used in combination with the user's eyes metrics to further hone the user's exact position.

In some embodiments, in step 1615c, the user's eyes can also be used to determine the vertical position of the user. For example, the user's eyes can be detected and tracked as the user changes position along a vertical or y-direction in the captured frame as the user goes from a sitting to standing posture. Again, here, the distance between the user's eyes is not as needed in this instance to determine the vertical position of the user but can be used in combination with the user's eyes metrics to further hone the user's exact position. Of course, it may be appreciated that other object recognition methods can be used to detect the user or other objects and the corresponding lateral or vertical position relative to the captured frame or user environment. It may be appreciated that other markers or features of the user can be used to make these determinations instead of or in addition to the user's eyes. Together with the depth determination, the lateral and horizontal position determination can be used to determine the user's POV relative to the image capturing device of the device 701.

In some embodiments, step 1615d includes determining viewer head orientation. Viewer head yaw angle can be determined using the flat method. The flat method uses geometry to calculate the angle from three points on a line: both eyes (end points) and the nose (middle point). The flat method can be particularly advantageous for use when both eyes are visible. The flat method, however, may be disadvantageous or inaccurate when one eye is not visible, for example, for extreme yaw angles, when one eye is obscured by hair or clothing, etc. Typically, the flat method is not suitable for use in determining the viewer head pitch angle. A triangle flat method may be used to determine both viewer head yaw angle and viewer head pitch angle. The triangle flat method models both eyes and the nose (typically the tip of the nose in particular) as three points arranged in a triangle. In this way, a vertical distance between the eyes and a tip of the nose may be measured and used to calculate the viewer head pitch angle. In some embodiments, the viewer head orientation can be determined with a face detection mesh machine learning algorithm. These algorithms use many facial points (usually between 6 and 32 points) to create a 3D model of the face. Such algorithms can determine the viewer head yaw angle and/or the viewer head pitch angle. As the points move or become obscured with changes in the viewer head orientation, the 3D model adjusts. The face detection mesh machine learning algorithm can model the face angle based on the points.

In some embodiments, the viewer head orientation can be determined by using computer vision (also called processor-based computer vision) to construct an artificial face and then feeding the artificial face into another algorithm like the face detection mesh machine learning algorithm. This embodiment can be used when the face is difficult to detect for reasons like lighting, facial hair, piercings, and the like. Computer vision detects colors, creates a color map which may correlate to typical coloration of the face (e.g., whites of eyes, nose typically has a light strip down the center, mouth can be dark, eyebrows typically dark), and from the color map, creates an artificial face. It may be appreciated that the device 701 can continually access the buffer of the image capturing device and analyze, frame by frame, the buffer of the image capturing device to track the eyes of the user and determine the viewing perspective of the user. Further, the physical object(s) and other entities around the user can be detected and continually tracked as well. It may be appreciated that more than one user can be detected by the image capturing device of the device 701. Thus, the device 701 can continually detect sets of eyes that correspond to respective users' heads, the gaze of the eyes and corresponding head, and a pose of the body of the corresponding user to which the head is attached.

In some embodiments, when more than one set of eyes are disposed in the frame (i.e., there are multiple users in front of the image capturing device), the device 701 can determine the primary viewing set of eyes for each frame. For example, the device 701 can determine the primary set of eyes based on the user profile already input by the primary user. A priority can be set to track the primary set of eyes upon detecting and determining the primary set of eyes belong to the user and not another secondary user.

In some embodiments, the image capturing device of the device 701 may not be centered with a display of the device 701, which can affect calculations for adjusting the digital and physical objects in the 3D mixed reality environment relative to the user's movement. To this end, in step 1615e, the position of the image capturing device relative to the display of the device 701 can be determined in order to accurately generate the 3D mixed reality environment. For example, the user can input the image capturing device position offset relative to the center of the display of the device 701. For example, the image capturing device position offset can be determined and set based on the hardware of the device 701, such as the device's manufacturer-set dimensions (e.g., a smart phone front- or user-facing image capturing device can be off-center by 0.5 in.). The image capturing device position offset coupled with the detected user parameters from the visual data can be used to improve the realism and experience for the user in the generated projection of the 3D mixed reality environment. It may be appreciated that the device 701 can include multiple image capturing devices, and only one image capturing device may be centered with the display of the device 701, and therefore the relative position of each image capturing device can be determined for generating the projection.

In some embodiments, as shown in FIG. 7G, the user can perform a predetermined gesture or motion using the user's head to perform a corresponding action. To that end, FIG. 7G illustrates a schematic view 824 of an office, with a user's perspective shifted forward relative to the perspectives shown in schematic view 820, for example. FIG. 7G further illustrates a 3D projection 826 corresponding to the perspective illustrated in schematic view 824. As illustrated, the user can lean forward towards the image capturing device after shifting over to the left in order to zoom in and read the text document. The device 701 can track the user's eyes and other features to determine that the user is leaning toward the image capturing device via a rapidly changing parameter or metric, such as a rapidly increasing distance between the detected user's eyes, which can result in the device 701 enlarging the text document on the display for the user to read. Similarly, upon the user leaning back away from the image capturing device, the device 701 can, for example, determine that the distance between the user's eyes is rapidly decreasing and the device 701 can zoom out of the text document.

Referring again to FIG. 6C, a flow chart is shown that outlines sub-methods of step 1625 for generating a projection of a 3D mixed reality experience with the perception of depth and perspective adjustment, according to some embodiments of the present disclosure. That is to say, the environment that the user is viewing can be created taking into account the POV of the user based on the user position as well as the field of view (FOV) and simulated focal length of the user's vision in the environment. Notably, the FOV and focal length of the user's vision can be pre-set or adjusted by the user during the 3D mixed reality experience. The sub-methods of step 1625 are not limited to a sequential application. Some embodiments can achieve sub-method 1625's results by executing the steps in a different sequence.

In some embodiments, in step 1625a, a perspective type is generated. The environment can have one perspective type or multiple observed perspective types within a single environment. The perspective type can be 1-point (or frontal), 2-point (or angular), 3-point (or oblique), hemispherical, global/orbital, or seesaw, or a combination thereof. For example, in a 1-point environment, when a person shifts left, objects in front of the point move right, but objects behind the point move left. In the seesaw perspective type, when the user moves, the corresponding movement in the environment changes depending on where objects are in the environment—objects in view can move against the user as the user moves (or can move with the user). For example, the environment can be a 1-point perspective but also have a global perspective included inside the 1-point perspective environment. This can appear as the global perspective globe disposed inside a room generated (e.g., rendered or drawn) according to the 1-point perspective. The global perspective globe can show the user viewing the global perspective globe a view inside a second room or environment, wherein an entirety of the second room or environment, or a 360-degree view of the second room or environment, is captured and displayed by the global perspective globe to the user whose perspective is positioned in the 1-point perspective environment. To the user viewing the global perspective globe, however, the user would only be able to see half, or 180 degrees, of the second room or environment at a time from the 1-point perspective environment (with the other side of the globe displaying the other half of the second room or environment).

In some embodiments, in step 1625b, the objects (physical and digital) can be arranged in relative positions to one another and the user in the environment. Returning to the previous example of the office including the apple and the book in FIG. 7A, the apple can be arranged on the desk at the distance of 2 feet away from the user and the book can be arranged on the coffee table at a distance of 15 feet away from the user, wherein both are centered with the user. Furthermore, the digital objects, such as a text document and a slide deck presentation can be arranged in the environment. For example, the text document can be arranged further back than the apple and to the left of the apple, such as 3 feet away from the user and 2 feet to the left of the apple. For example, the slide deck presentation can be arranged also 3 feet away from the user and 2 feet to the right of the apple. As noted above, based on the perspective type and the relative position of the objects in the FOV of the user, the position of the objects can change in response to a change in the position of the user.

In some embodiments, the slide deck presentation (and/or the text document) can include the reference patch 9604 (see FIG. 5B). For example, the reference patch 9604 can be disposed in slide 3 of the slide deck presentation and configured to retrieve secondary content including a digital object for displaying to the user. While the user is interacting with the slide deck presentation, the user can progress to slide 3 and the reference patch 9604 can be visible. Notably, the device 701 can be continually searching for and detecting the reference patch 9604. For example, using computer vision, the device 701 can be accessing and analyzing the frame buffer of the GPU using method 9800. For example, the device 701 can be accessing and analyzing the memory buffer of the device 701 using method 9700. When the user advances the slide deck presentation to slide 3 and the device 701 detects the reference patch 9604, the device 701 can obtain the secondary content corresponding to the reference patch 9604 and the digital object included with the secondary content. The digital object for displaying to the user can include display parameters, such as object properties (see step 1625c below). In a regular display, the digital object can appear relatively flat while displaying augmented data and not provide a mixed 3D reality experience for the user. In the mixed 3D reality environment with optical lenticular multi-perspective reaction and perception of depth, the device 701 can display the refence patch's 9604 digital object based on the display parameters and the object properties in such a way that the digital object appears 3D and adjusts position in response to the movement of the user in the same environment.

For example, the slide deck presentation can be related to a new vehicle production and the reference patch 9604 in the slide deck presentation can result in the display of a 3D model of the new vehicle. Upon the slide deck presentation progressing to the slide including the reference patch, the 3D model of the new vehicle can be displayed at a predetermined position relative to the slide deck presentation. The predetermined position can take into account a FOV of the user as well. For example, the user can be viewing, in the user's FOV, the slide deck presentation in the center of the user's FOV with the text document occupying a left portion of the user's FOV (i.e., the text document is visible to the left of the slide deck presentation). As such, the predetermined position for displaying the 3D model of the vehicle can be centered vertically and in a right portion of the user's FOV (i.e., the 3D model of the vehicle is positioned to the right of the slide deck presentation). Upon the user adjusting position while viewing the slide deck presentation, the device 701 can adjust the position and rendering of the new digital object—the 3D model of the vehicle—to be accurate relative to the new user's perspective.

For example, the user can lean in to view the slide deck presentation with a zoomed view and the geometry of the 3D model of the vehicle can adjust accordingly upon relocating farther to the edge of the user's FOV. Further, the 3D model of the vehicle can be in motion while disposed next to the slide deck presentation. For example, the 3D model of the vehicle can be slowly rotating to provide the user with a 360-degree view of the vehicle over a predetermined frequency (e.g., one full rotation per minute). Of course, while the user is stationary or upon leaning into the slide deck presentation, the geometry of the 3D model of the vehicle can be adjusted by the device 701 to always be geometrically accurate relative to the position of the user, including clipping out portions of the 3D model of the vehicle when the 3D model of the vehicle is determined to be outside the FOV of the user.

Further, while the user is viewing the slide deck presentation, the user can look to the right at the 3D model of the vehicle and center the user's FOV on the 3D model of the vehicle. In response to determining the gaze of the user is centered on the 3D model of the vehicle, the device 701 can update the 3D model of the vehicle to stop rotating. Notably, the rotation of the vehicle can be slowed considerably instead. Using other gestures with the user's head, the user can additionally manipulate the view of the 3D model of the vehicle. For example, a quick turn of the user's head to one direction can rotate the 3D model of the vehicle in the same direction. Of course, as the user adjusts position or leans in towards the 3D model of the vehicle, the device 701 can reactively adjust the position and rendering of the 3D model of the vehicle based on the new perspective of the user.

Referring to FIG. 6C, in step 1625c, properties can be assigned to the objects. That is, the objects in the 3D environment are not static and instead can be adjustable. To mimic this real-world experience in the 3D environment, properties or parameters can be assigned to the objects that change based on the position of the user. For example, the properties can include rotation, material and surface reflectivity, and object appearance change in response to perspective adjustments, among others. As such, the objects can react to the movement of the user. In an example, the object can rotate to follow the gaze of the user. That is, the object can be a picture of another person's head (e.g., another person's video feed in a window arranged in the environment) and the person's head can always face the user no matter where the user moves. Notably, while simultaneously rotating to face the user, the person's head, which can be arranged at a predetermined location in the environment relative to other objects, can be continually updated to be located at the new, expected location relative to other objects in the environment based on the new location and perspective of the user.

For example, the object can be a person presenting to the user plus additional viewers in the same environment, but for each viewer (e.g., user A and user B), the person presenting can always be facing the viewer. That is, for user A, the presenter will appear like the presenter is facing user A while simultaneously, for user B, the presenter will appear like the presenter is facing user B. This is opposed to the alternative where user A would see the presenter facing user B, or vice versa. As such, the presenter is always facing each viewer despite the number of viewers present. For example, the object can be a board (e.g., a chalkboard, a whiteboard, a smart board, etc.) for the presenter to draw on, and the board can be facing each viewer in addition to the presenter. In real life, the presenter may have to orient the board facing the presenter in order to draw on the board, which may disengage the viewers. In the 3D mixed reality environment, the presenter can still orient the board toward him/herself and easily draw on the board while still appearing to face each viewer. As such, the viewer does not see the back of the board and instead can see the content on the board being drawn in real-time. For a change in the object material, such as when looking at a pane of broken glass, the visual of what is behind the glass can change based on the user's perspective. The object transparency can also be adjusted. For example, objects farther away from the user can appear opaque while objects closer to the user can appear more transparent. In some embodiments, the property of the object can relate to sound.

To further describe the user's adjustable FOV and focal length, FIG. 7H shows a schematic of the narrowing field of view (FOV) of the user. The FOV shown in schematic view 828 is similar to the FOV shown in schematic view 800, and thus similarly positioned objects in the offices illustrated in schematic views 800, 828 would be similarly sized in corresponding projections. In some embodiments, the FOV and the focal length of the user can be adjusted. For example, the user can adjust the FOV or the focal length setting. By narrowing the FOV (as shown), the user can view less content along the lateral (x) and vertical (y) direction. As shown, the user's view can narrow to see in between the text document and the slide deck presentation and only have the coffee table and book in view (the apple has been removed for simplicity). Concomitantly, the user can also then experience a zoomed in view due to the narrower FOV. FIG. 7I shows a schematic view 832 of the office, wherein the FOV of the user corresponds to the FOV of schematic view 830 and is thus narrower than the FOVs shown in schematic view 800 and 828. FIG. 7I further shows a 3D projection 834 corresponding to the user perspective and FOV shown in schematic view 832. As shown in FIG. 7I, the coffee table appears much larger in the user's FOV as compared to the table shown in projection 802 of FIG. 7A.

Still referring to FIG. 7I, the focal length can be adjusted by the user as well. The focal length can be represented by the dotted line in the z-direction originating at the user's position. As shown in FIG. 7I, the focal length of the user can extend to the back wall, which allows a picture disposed on the back wall to be in focus along with anything in between the user and the back wall. Referring now to FIG. 7J, a schematic view 836 is shown of an office (e.g., similar to the office illustrated in schematic view 832 of FIG. 7I), wherein the focal length is shortened relative to the focal length illustrated in schematic view 832. FIG. 7J further illustrates a 3D projection 838 corresponding to the perspective illustrated in schematic view 836. As shown in FIG. 7J, a shorter focal length can terminate at the end of the coffee table. The shorter focal length can result in the same picture on the back wall appearing out of focus. Similarly, objects very close to the user can also have a blurriness, as is true in the real world. To differentiate between an object too close or an object too far that are both blurry, the updated location of the blurred objects and the distance the objects move in response to the user adjusting POV can inform the user of which objects are close and which objects are far away.

For example, a virtual pane of broken glass can have shards of glass disposed far away from the user and also shards of glass disposed very close to the user, wherein both sets of shards are blurry. As the user moves, any blurry shards of glass disposed very close to the user will appear to shift a greater distance as compared to any blurry shards of glass disposed very far away from the user, similar to how the apple in the office example will move a greater distance than the book when the user shifts to the left. Thus, the generation of the 3D mixed reality environment with accurate calculations or physics for object movement based on user perspective change can help further immerse the user in the environment. Additionally, the simple blurriness effect of the objects (or the out-of-focus appearance of the objects) farther away or extremely near to the user in the 3D mixed reality environment can help to bring the experience in the 3D mixed reality environment closer to what the user experiences in real life, thereby further immersing the viewer in the generated environment. It may be appreciated that a progressive blur intensity can be applied to objects at varying distances away from or close to the user as well.

As previously described with respect to step 1625a of FIG. 6C wherein multiple perspectives can be included in the environment, FIG. 7K shows a schematic 840 of global perspective globe's view (left) and the global perspective globe disposed in a 3D projection 842 of the 1-point perspective environment (right), according to an embodiment of the present disclosure. In some embodiments, since the global perspective globe can have a 360-degree view, no FOV lines are shown. A rectangular object and two cylindrical objects on either side of the rectangular object can be disposed in a room where the global perspective globe provides vision. Upon including the global perspective globe in the 1-point perspective office, the global perspective globe can be viewed by the user, but notably, the user can only view 180 degrees of the global perspective globe's view at a time. As shown in FIG. 7K, the global perspective globe can be displaying a predetermined half of the room where the rectangular object and the cylindrical objects are arranged. Thus, the user is able to see, in the global perspective globe, the rectangular object and the cylindrical objects in the projection 842. The other half of the room including a triangular object may not be visible to the user. To view the other half of the room, the global perspective globe can be spun to display the other half of the room towards the user. Alternatively, the user can move the POV of the user to the other side of the global perspective globe and rotate the POV of the user to view the global perspective globe from said other side.

In some examples, physical objects in a background of a user can be associated with digital objects. A digital object associated with physical objects can present a user with additional functionality within the virtual environment with respect to the digital object. In some cases, the virtual object can be individually manipulable, and the user can reposition the virtual object in the virtual environment without repositioning the associated physical object in the physical environment. For example, and referring again to FIG. 7E, a virtual apple can be generated corresponding to the physical apple shown at layer U and could be displayed to the user and other users in a communications session with the user. The user, or other users in a communications session could move (e.g., through hand motions, gestures, a mouse, a keyboard, touchpad etc.) the virtual apple from layer U to layer Y, creating the illusion that the apple is positioned on the coffee table. Thus, when a user or users change head position or viewing angle, the virtual apple could shift along with other elements in Layer Y, thus creating the illusion that the apple is positioned at that layer.

In some embodiments, sound that is associated with a virtual object moved within a virtual environment can also be adjusted to correspond to a layer or depth at which the object is positioned (e.g., a virtual distance from the user). For example, if the apple is moved from layer U to layer Y, a sound can be generated upon placing the apple on the table which could create an audible illusion of depth corresponding to the visual illusion of depth of the apple. In some examples, when a virtual object is repositioned (e.g., moved in any or all of the x, y, or z axes), the physical object can be removed from view, creating an illusion that the physical object has been moved. It should be understood that any output can be responsive to visual data, or the manipulation thereof. For example, smart lighting elements in an environment of the user can correspond to lighting in a virtual environment, so that when a virtual environment, or a portion thereof is brightened, smart lighting elements in the user's environment are also brightened to further create an illusion of continuity between the virtual environment and the user's environment. Correspondingly, a brightness of the virtual environment, and shadowing therein can be adjusted to enhance an illusion of depth of the virtual environment and create an illusion of continuity between the virtual environment and the user's environment.

In further examples, visual data of a user or the user's environment can be inputs into the virtual environment and can enhance an augmentation thereof. The system can identify elements within visual data, and the virtual environment can be responsive to those elements. For example, if a diploma is identified in the background of a user, the diploma can be brought to a forefront (e.g., a front layer), and the system can identify a school name or logo on the diploma. All or a portion of the diploma can be converted into a button or a hyperlink, and users in the virtual environment can select or click the diploma to access information about the school (e.g., a website of the school). Virtual objects associated with physical objects can be identified as products or could be associated with functionalities in the virtual environment. For example, a virtual environment can be configured to recognize an apple (e.g., as shown in FIGS. 7A-7F) and could display nutritional information associated with the apple. In some examples, if a coffee cup is positioned in the FOV, a virtual coffee cup can be associated therewith, and the virtual coffee cup can include a pourable function, allowing a user to virtually pour coffee from the virtual coffee cup. In some examples, the system can identify a book in a background of the user (e.g., as shown in FIG. 7A), and the book can be associated with a virtual book. The virtual book can include functionalities common to books, and, if information about the book (e.g., a title, an author, etc.) is visible, the information can be presented to the user, including, for example, a price of the book. In some cases, a virtual book can be manipulated by users through handling, opening, or reading pages thereof, which can be populated with the contents of the physical book.

In some examples, objects in a user's environment can function as reference patches, and when within the FOV, can produce augmentations and cause additional information to be displayed the users to whom the object is visible (e.g., as described in FIGS. 2A-5C). For example, a reference patch can be printed on an object (e.g., a picture, a book, a wall, a shirt, a coffee mug, etc.), and digital content corresponding to the reference patch can be retrieved and displayed within the virtual environment, or in a layer thereof. In some examples, a logo can be a reference patch, and if the logo is visible, content associated with the logo can be displayed to users of the virtual environment. In an example, a coffee cup can include a logo associated with a coffee vendor (e.g., Dunkin® Donuts), and when the logo is visible, a clickable “Order” button can be displayed to a user, which can provide the user the ability to order coffee from the vendor. In some examples, an object can be a reference patch, and does not need a reference patch displayed thereon. In some examples, an analog clock can be a reference patch, and different digital content can be displayed when different times are visually identified on the analog clock.

In some examples, any visual pattern or object identified in a FOV can be associated with functionality of a virtual environment, and outputs (e.g., visual display elements, or sound produced from speakers). In some examples, multiple output devices (e.g., screens, speakers, etc.) can operate to create a single virtual environment, with corresponding illusion of depth and optical lenticular parallax implementations. For example, a first screen can be behind the user, and can display a first portion of a virtual environment, and a second screen can be in front of the user and can display a second portion of a virtual environment. As the user moves closer to the second screen, and thus farther from the first screen, objects of the second screen can appear closer to and objects of the second screen can appear farther from the user. The screens could be associated with speakers, and in some examples, a viewing angle of the user can determine a relative volume of each speaker. For example, a video can be playing on a first screen, and a meeting can be displayed on a second screen, the first and second screens each having a corresponding speaker. When a user is viewing the video on the first screen, the volume of the speaker associated with the first screen can be increased, and the volume of the meeting displayed on the second screen can be diminished. If the user turns to view the meeting on the second screen, the volume of the video shown on the first screen can be diminished, and the volume of the meeting shown on the first screen can be increased. In some cases, websites can be programmed to present content thereof to the user at varying depths to produce desired behavior or visually prompt a user. For example, when a user is viewing a selection of products on a website, a “Buy” or “Check Out” button can appear at a layer of the screen appearing closer to the user relative to other visual elements of the website.

Additional examples of a reactive optical lenticular multi-perspective environment are described herein.

In an example, a cat can be viewing a 3D render of a toy on a website for purchasing pet supplies. For example, an owner of the cat can be encouraging the cat to view a selection of multiple cat toys to determine which cat toy would interest the cat the most. To provide an enhanced experience for the cat and the owner, the device 701 can track the eyes of the cat, a position of the cat's head, and a rotation of the cat's head to adjust the displayed cat toy as the cat moves. Notably, the device 701 can also detect and track the same features of the owner, but a higher priority can be assigned to the cat and therefore the adjustment of the cat toy can be firstly in response to the cat's movement. For example, the device 701 can detect features of an animal to distinguish from a human, such as a shape of the cat's ears, a shape of the cat's face, a shape of the cat's irises, etc. Upon determining the cat is no longer in view of the image capturing device, the highest priority can be reassigned to the owner while the owner, for example, completes review and purchase of the cat toy.

In an example, a child can be viewing a movie on a television (the device 701) including an image capturing device and processing circuitry configured to detect and monitor the eyes of a viewer, a position of the viewer's heads, and a rotation of the viewer's head. Further, the television can be configured to determine demographics of the viewer, such as the viewer's likely age group. For example, the television can determine that a first viewer is a child and that a second viewer is an adult and, while the television is configured to display a children's movie, the television can be configured to prioritize tracking of the child. As the child watches the movie, the child can look around a scene being displayed on the television by adjusting the position of the child's head, the rotation of the child's head, and/or a gaze of the child's eyes. In response to detecting the adjustment of the child, the television can change the POV of the scene being displayed.

In an example, a viewer can be watching a Formula 1 (F1) race from any perspective as the F1 race is being replicated realistically with real-time data of all cars in the F1 race in a 3D gaming engine.

In an example, a viewer can be a business executive watching a recording of a meeting, wherein the meeting was recorded from any perspective. As such, the executive can review the recording from multiple perspectives to look for additional information the executive may have missed during the meeting, such as attendee facial reactions, body language, etc. that may have been obscured or not noticed.

In an example, a display disposed at the end of a runway at an airport can change as an airplane approaches the end of the runway. The display can be configured to adjust based on a position of the airplane. From any distance, the information on the display can be readable, but the content on the display can be changed as the airplane approaches. For example, from miles away the display can be just displaying all green, while close up the display can tell the pilot his/her new gate number to taxi towards.

In an example, a person can be walking by or being transported by an ad at an airport and see the text/font positioned in the appropriate real-time keystone for the text to be the most readable. As the person continues walking or moving, the text/font is adjusted based on the constantly changing perspective of the person. Upon the person moving beyond a predetermined distance from the ad, the ad can adjust the text/font for a new person moving by the ad.

In an example, a left-hand sided driver operating a vehicle including an image capturing device obtaining visual data on a right-hand side of the vehicle can look to the right of the driver's windshield to see a transparent video feed from the right-hand sided image capturing device on the car to see additional perspective around the vehicle. As the driver adjusts position in the car or for a different driver seated at a different position, the transparent video feed display can adjust accordingly to allow the user the best viewing angle. The transparent video feed can also be displayed to a passenger in the right-most seat of the vehicle upon determining the driver, who has the highest priority for viewing the transparent video feed, is no longer viewing the transparent video feed.

In an example, a group of shoppers can investigate a clothing store through a glass window of the building. A primary viewer in the group of shoppers can be determined, and as the primary viewer adjusts position and gaze, the content of the store being displayed can be changed. Additionally, prices for the clothing can appear on the clothing that he/she is looking exactly at in the store.

In an example, a banker can lean into a chart being displayed on a display. As the banker's head approaches the display, the quarter that is being displayed on the chart can become larger or expand and more data for the target quarter can populate in the chart.

In an example, a patient can be viewing a disease awareness document, and as the patient looks to the left side of the page, conversations from the patient's patient community group can peek out from the side of the screen. As the patient looks on the other side of the screen, the patient's doctor's report peeks out on the right side.

In an example, a surround sound system can be provided to create an audible illusion of different instruments being played from different locations in a room. The sound from the surround sound system can create the audible illusion that a guitar is being played from a first side of a room, drums are being played in a second side of the room, and an oboe is being played from a third side of the room. When a user moves closer to the third side of the room, as detected by visual detection devices, the sound of the system can be responsive to the visual data, and the volume and direction of the oboe, drums, and guitar can be adjusted to provide the audible illusion that the user is closer to the oboe. Additionally or alternatively, the visual data can indicate a viewing angle of the user, and when a user looks in the direction a corresponding instrument can be partially amplified (e.g., when the user looks toward the second side of the room, the volume of the drums can be increased).

In another example, a virtual environment can be programmed to identify (e.g., through machine learning and artificial intelligence image processing and identification) a writing implement (e.g., a pen, a pencil, a marker, etc.) in visual data collected from detecting devices. When a pen is identified in visual data, the writing implement can be used to draw in the virtual environment. Drawing in the virtual environment can be two-dimensional, with all lines and shapes drawn by the writing implement displayed in the same layer, and at the same point along the z axis. In some examples, a writing implement identified in visual data can write in three dimensions in the virtual environment and moving the writing implement toward or away from the screen can allow the user to draw along the z axis, producing a three-dimensional drawing. In some examples, the virtual environment can assign sequential depth to strokes produced by a writing implement, such that each segment drawn by the user is displayed at a progressively greater or lesser depth along the z axis, which may be linear, exponential, or based on an algorithm.

In some examples, the systems and methods described herein can be used to allow a user to immersively and interactively experience media (e.g., a three-dimension movie, or a video game, or a metaverse). For example, a user could view a movie, and an angle of viewing can be dependent on a view angle of the user's eyes, as determined from visual data obtained from detection devices. When the user looks in a first direction (e.g., rightward), the scene in the movie being viewed can shift accordingly to create the illusion of depth as described above in FIGS. 6A-7K. Sound and lighting outputs can correspondingly be adjusted to augment the user's experience of the movie and establish a perceived continuity between the user's environment and the movie (e.g., the virtual environment). For example, if a portion of a scene the user is viewing is brighter, smart lights of a user's environment can be adjusted to match the lighting of the portion being viewed. If a user looks toward a darker portion of a scene, smart lighting elements of the user's environment can correspondingly be dimmed. In some embodiments, other smart features of a home may be activated or adjusted to augment the user's experience. For example, a smart thermostat may be adjusted to vary a temperature, fan speed, or humidity within a particular room to achieve a higher or lower temperature, fan speed, or humidity.

In an example, a user can play a car racing game and steer the car by looking in the direction of the screen that the user wants to car to steer/drive.

Embodiments of the subject matter and the functional operations described in this specification can be implemented by digital electronic circuitry, in tangibly embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of data processing apparatus. The computer storage medium can be a machine-readable storage device, a machine-readable storage substrate, a random or serial access memory device, or a combination of one or more of them.

The term “data processing apparatus” refers to data processing hardware and may encompass all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, Subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

It should be understood that the examples provided here are not limiting, and that the disclosed invention can be practiced in any number of contexts. For example, the functionalities described herein to create an illusion of depth, and otherwise provide functionality for making a virtual environment responsive to visual data can be provided in a library of a programmable language (e.g., an SDK) or through an API, which can be used by developers to define immersive properties of a given virtual environment. For example, a developer could thus define, for a particular virtual environment (e.g., a game, or a website, or an interactive movie) what visual patterns (e.g., a QR code, an object, a text pattern, an image, an article of clothing, etc.) can comprise reference patches, that, when visually identified in a FOV of detection devices, can produce a reaction in the virtual environment or display content to a user. Individual virtual environments can be coded to respond to visual data differently. For example, a first virtual environment could include only two layers, as shown in FIG. 7D and a second virtual environment could include six layers, as shown in FIG. 7E, according to the preference of the respective developer for each environment. Similarly, in a first environment, if a user approaches the screen, objects can appear closer to the user, while in a second environment, objects can appear further away from the user the closer the user approaches to the screen. Thus, responsiveness, including perceived depth, a speed of responsiveness of UI elements to visual data, reference patch definitions and content to be displayed therewith, control of non-visual outputs (e.g., sound from speakers), responsiveness to motions of a user, etc. can be defined individually for given virtual environments, according to some examples.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA an ASIC.

Computers suitable for the execution of a computer program include, by way of example, general or special purpose microprocessors or both, and any other kind of central processing unit. Generally, a CPU will receive instructions and data from a read-only memory or a random-access memory or both. Elements of a computer are a CPU for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few. Computer-readable media suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more Such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients (user devices) and servers. A client and server are generally remote from each other and typically interact through a communication network. The relationship of client and server arises by virtue of computer programs executing on the respective computers and having a client-server relationship to each other. In some embodiments, a server transmits data, e.g., an HTML page, to a user device, e.g., for purposes of displaying data to and receiving user input from a user interacting with the user device, which acts as a client. Data generated at the user device, e.g., a result of the user interaction, can be received from the user device at the server.

Electronic user device 20 shown in FIG. 8 can be an example of one or more of the devices shown in FIG. 1. In some embodiments, the electronic user device 20 may be a smartphone. However, the skilled artisan will appreciate that the features described herein may be adapted to be implemented on other devices (e.g., a laptop, a tablet, a server, an e-reader, an image capturing device, a navigation device, etc.). The exemplary user device 20 of FIG. 8 includes processing circuitry, as discussed above. The processing circuitry includes one or more of the elements discussed next with reference to FIG. 8. The electronic user device 20 may include other components not explicitly illustrated in FIG. 8 such as a CPU, GPU, frame buffer, etc. The electronic user device 20 includes a controller 410 and a wireless communication processor 402 connected to an antenna 401. A speaker 404 and a microphone 405 are connected to a voice processor 403.

The controller 410 may include one or more processors/processing circuitry (CPU, GPU, or other circuitry) and may control each element in the user device 20 to perform functions related to communication control, audio signal processing, graphics processing, control for the audio signal processing, still and moving image processing and control, and other kinds of signal processing. The controller 410 may perform these functions by executing instructions stored in a memory 450. Alternatively, or in addition to the local storage of the memory 450, the functions may be executed using instructions stored on an external device accessed on a network or on a non-transitory computer readable medium.

The memory 450 includes but is not limited to Read Only Memory (ROM), Random Access Memory (RAM), or a memory array including a combination of volatile and non-volatile memory units. The memory 450 may be utilized as working memory by the controller 410 while executing the processes and algorithms of the present disclosure. Additionally, the memory 450 may be used for long-term storage, e.g., of image data and information related thereto.

The user device 20 includes a control line CL and data line DL as internal communication bus lines. Control data to/from the controller 410 may be transmitted through the control line CL. The data line DL may be used for transmission of voice data, displayed data, etc.

The antenna 401 transmits/receives electromagnetic wave signals between base stations for performing radio-based communication, such as the various forms of cellular telephone communication. The wireless communication processor 402 controls the communication performed between the user device 20 and other external devices via the antenna 401. For example, the wireless communication processor 402 may control communication between base stations for cellular phone communication.

The speaker 404 emits an audio signal corresponding to audio data supplied from the voice processor 403. The microphone 405 detects surrounding audio and converts the detected audio into an audio signal. The audio signal may then be output to the voice processor 403 for further processing. The voice processor 403 demodulates and/or decodes the audio data read from the memory 450 or audio data received by the wireless communication processor 402 and/or a short-distance wireless communication processor 407. Additionally, the voice processor 403 may decode audio signals obtained by the microphone 405.

The exemplary user device 20 may also include a display 420, a touch panel 430, an operation key 440, and a short-distance communication processor 407 connected to an antenna 406. The display 420 may be a Liquid Crystal Display (LCD), an organic electroluminescence display panel, or another display screen technology. In addition to displaying still and moving image data, the display 420 may display operational inputs, such as numbers or icons which may be used for control of the user device 20. The display 420 may additionally display a GUI for a user to control aspects of the user device 20 and/or other devices. Further, the display 420 may display characters and images received by the user device 20 and/or stored in the memory 450 or accessed from an external device on a network. For example, the user device 20 may access a network such as the Internet and display text and/or images transmitted from a Web server.

In some examples, the user device 20 may have insufficient compute resources to generate and render visual elements which produce the illusion of depth, and are generated in accordance with the methods for rendering based on an optical lenticular parallax, as described above with respect to FIGS. 6A-7J. Accordingly, rendering can be performed on the external device on the network (e.g., a server hosted in a cloud), and generated images can be provided to the user device 20. In some cases, images can be pre-rendered based on a predicted range of motion of a user's head, and a subset of all possible renderings can be provided to the user device 20, based on the predicted range of motion. For example, a machine learning or artificial intelligence model can predict that, within a given time period, a user is likely to deviate from a current viewing angle by a given angular offset in either direction (e.g., in the next second, the user is likely to change viewing angle by up to 10 degrees in either direction). The external device can thus generate renderings of the virtual environment corresponding to each viewing angle in the predicted range of motion of the user's head, and the renderings can be provided to the user's device to increase a speed of rendering of the virtual environment on the user's device.

Referring again to FIG. 8, the touch panel 430 may include a physical touch panel display screen and a touch panel driver. The touch panel 430 may include one or more touch sensors for detecting an input operation on an operation surface of the touch panel display screen. The touch panel 430 also detects a touch shape and a touch area. Used herein, the phrase “touch operation” refers to an input operation performed by touching an operation surface of the touch panel display with an instruction object, such as a finger, thumb, or stylus-type instrument. In the case where a stylus or the like is used in a touch operation, the stylus may include a conductive material at least at the tip of the stylus such that the sensors included in the touch panel 430 may detect when the stylus approaches/contacts the operation surface of the touch panel display (similar to the case in which a finger is used for the touch operation).

In certain aspects of the present disclosure, the touch panel 430 may be disposed adjacent to the display 420 (e.g., laminated) or may be formed integrally with the display 420. For simplicity, the present disclosure assumes the touch panel 430 is formed integrally with the display 420 and therefore, examples discussed herein may describe touch operations being performed on the surface of the display 420 rather than the touch panel 430. However, the skilled artisan will appreciate that this is not limiting.

For simplicity, the present disclosure assumes the touch panel 430 is a capacitance-type touch panel technology. However, it should be appreciated that aspects of the present disclosure may easily be applied to other touch panel types (e.g., resistance-type touch panels) with alternate structures. In certain aspects of the present disclosure, the touch panel 430 may include transparent electrode touch sensors arranged in the X-Y direction on the surface of transparent sensor glass.

The touch panel driver may be included in the touch panel 430 for control processing related to the touch panel 430, such as scanning control. For example, the touch panel driver may scan each sensor in an electrostatic capacitance transparent electrode pattern in the X-direction and Y-direction and detect the electrostatic capacitance value of each sensor to determine when a touch operation is performed. The touch panel driver may output a coordinate and corresponding electrostatic capacitance value for each sensor. The touch panel driver may also output a sensor identifier that may be mapped to a coordinate on the touch panel display screen. Additionally, the touch panel driver and touch panel sensors may detect when an instruction object, such as a finger is within a predetermined distance from an operation surface of the touch panel display screen. That is, the instruction object does not necessarily need to directly contact the operation surface of the touch panel display screen for touch sensors to detect the instruction object and perform processing described herein. For example, in some embodiments, the touch panel 430 may detect a position of a user's finger around an edge of the display panel 420 (e.g., gripping a protective case that surrounds the display/touch panel). Signals may be transmitted by the touch panel driver, e.g., in response to a detection of a touch operation, in response to a query from another element based on timed data exchange, etc.

The touch panel 430 and the display 420 may be surrounded by a protective casing, which may also enclose the other elements included in the user device 20. In some embodiments, a position of the user's fingers on the protective casing (but not directly on the surface of the display 420) may be detected by the touch panel 430 sensors. Accordingly, the controller 410 may perform display control processing described herein based on the detected position of the user's fingers gripping the casing. For example, an element in an interface may be moved to a new location within the interface (e.g., closer to one or more of the fingers) based on the detected finger position.

Further, in some embodiments, the controller 410 may be configured to detect which hand is holding the user device 20, based on the detected finger position. For example, the touch panel 430 sensors may detect a plurality of fingers on the left side of the user device 20 (e.g., on an edge of the display 420 or on the protective casing) and detect a single finger on the right side of the user device 20. In this exemplary scenario, the controller 410 may determine that the user is holding the user device 20 with his/her right hand because the detected grip pattern corresponds to an expected pattern when the user device 20 is held only with the right hand.

The operation key 440 may include one or more buttons or similar external control elements, which may generate an operation signal based on a detected input by the user. In addition to outputs from the touch panel 430, these operation signals may be supplied to the controller 410 for performing related processing and control. In certain aspects of the present disclosure, the processing and/or functions associated with external buttons and the like may be performed by the controller 410 in response to an input operation on the touch panel 430 display screen rather than the external button, key, etc. In this way, external buttons on the user device 20 may be eliminated in lieu of performing inputs via touch operations, thereby improving watertightness.

The antenna 406 may transmit/receive electromagnetic wave signals to/from other external apparatuses, and the short-distance wireless communication processor 407 may control the wireless communication performed between the other external apparatuses. Bluetooth, IEEE 802.11, and near-field communication (NFC) are non-limiting examples of wireless communication protocols that may be used for inter-device communication via the short-distance wireless communication processor 407.

The user device 20 may include a motion sensor 408. The motion sensor 408 may detect features of motion (i.e., one or more movements) of the user device 20. For example, the motion sensor 408 may include an accelerometer to detect acceleration, a gyroscope to detect angular velocity, a geomagnetic sensor to detect direction, a geo-location sensor to detect location, etc., or a combination thereof to detect motion of the user device 20. In some embodiments, the motion sensor 408 may generate a detection signal that includes data representing the detected motion. For example, the motion sensor 408 may determine a number of distinct movements in a motion (e.g., from start of the series of movements to the stop, within a predetermined time interval, etc.), a number of physical shocks on the user device 20 (e.g., a jarring, hitting, etc., of the electronic device), a speed and/or acceleration of the motion (instantaneous and/or temporal), or other motion features. The detected motion features may be included in the generated detection signal. The detection signal may be transmitted, e.g., to the controller 410, whereby further processing may be performed based on data included in the detection signal. The motion sensor 408 can work in conjunction with a Global Positioning System (GPS) section 460. The information of the present position detected by the GPS section 460 is transmitted to the controller 410. An antenna 461 is connected to the GPS section 460 for receiving and transmitting signals to and from a GPS satellite.

The user device 20 may include an image capturing device (e.g., a camera) section 409, which includes a lens and shutter for capturing photographs of the surroundings around the user device 20. In some embodiments, the image capturing device section 409 captures surroundings of an opposite side of the user device 20 from the user. The images of the captured photographs can be displayed on the display panel 420. A memory section saves the captured photographs. The memory section may reside within the image capturing device section 109, or it may be part of the memory 450. The image capturing device section 409 can be a separate feature attached to the user device 20 or it can be a built-in image capturing device feature.

An example of a type of computer is shown in FIG. 9. The computer 500 can be used for the operations described in association with any of the computer-implement methods described previously, according to one implementation. For example, the computer 500 can be an example of devices 701, 702, 70n, 7001, or a server (such as networked device 750). The computer 700 includes processing circuitry, as discussed above. The networked device 750 may include other components not explicitly illustrated in FIG. 9 such as a CPU, GPU, frame buffer, etc. The processing circuitry includes one or more of the elements discussed next with reference to FIG. 9. In FIG. 9, the computer 500 includes a processor 510, a memory 520, a storage device 530, and an input/output device 540. Each of the components 510, 520, 530, and 540 are interconnected using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the computer 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the computer 500. In one implementation, the storage device 530 is a computer-readable medium. In various different implementations, the storage device 530 may be a floppy disk device, a hard disk device, an optical disk device, or a tape device.

The input/output device 540 provides input/output operations for the computer 500. In one implementation, the input/output device 540 includes a keyboard and/or pointing device. In another implementation, the input/output device 540 includes a display unit for displaying graphical user interfaces.

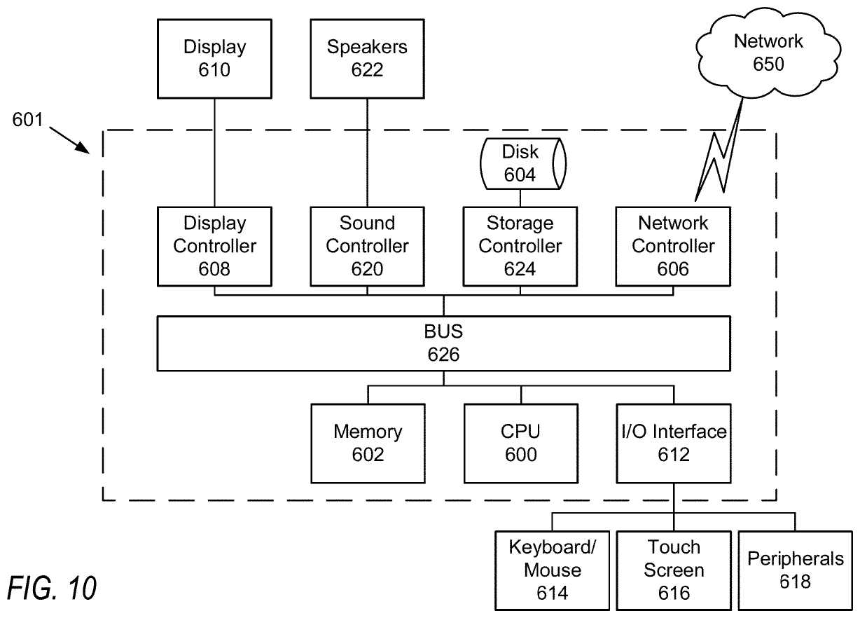

Next, a hardware description of a device 601 according to exemplary embodiments is described with reference to FIG. 10. In FIG. 10, the device 601, which can be the above-described devices of FIG. 1, includes processing circuitry, as discussed above. The processing circuitry includes one or more of the elements discussed next with reference to FIG. 10. The device 701, may include other components not explicitly illustrated in FIG. 10 such as a CPU, GPU, frame buffer, etc. In FIG. 10, the device 701 includes a CPU 600 which performs the processes described above/below. The process data and instructions may be stored in memory 602. These processes and instructions may also be stored on a storage medium disk 604 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the device 601 communicates, such as a server or computer.

Further, the claimed advancements may be provided as a utility application, background daemon, or component of an operating system, or combination thereof, executing in conjunction with CPU 600 and an operating system such as Microsoft Windows, UNIX, Solaris, LINUX, Apple MAC-OS, and other systems known to those skilled in the art.

The hardware elements in order to achieve the device 601 may be realized by various circuitry elements, known to those skilled in the art. For example, CPU 600 may be a Xenon or Core processor from Intel of America or an Opteron processor from AMD of America or may be other processor types that would be recognized by one of ordinary skill in the art. Alternatively, the CPU 600 may be implemented on an FPGA, ASIC, PLD or using discrete logic circuits, as one of ordinary skill in the art would recognize. Further, CPU 600 may be implemented as multiple processors cooperatively working in parallel to perform the instructions of the processes described above. CPU 600 can be an example of the CPU illustrated in each of the devices of FIG. 1.

The device 601 in FIG. 10 also includes a network controller 606, such as an Intel Ethernet PRO network interface card from Intel Corporation of America, for interfacing with network 650 (also shown in FIG. 1), and to communicate with the other devices of FIG. 1. As can be appreciated, the network 650 can be a public network, such as the Internet, or a private network such as an LAN or WAN network, or any combination thereof and can also include PSTN or ISDN sub-networks. The network 650 can also be wired, such as an Ethernet network, or can be wireless such as a cellular network including EDGE, 3G, 4G and 5G wireless cellular systems. The wireless network can also be Wi-Fi, Bluetooth, or any other wireless form of communication that is known.

The device 601 further includes a display controller 608, such as a NVIDIA GeForce GTX or Quadro graphics adaptor from NVIDIA Corporation of America for interfacing with display 610, such as an LCD monitor. A general purpose I/O interface 612 interfaces with a keyboard and/or mouse 614 as well as a touch screen panel 616 on or separate from display 610. General purpose I/O interface also connects to a variety of peripherals 618 including printers and scanners.

A sound controller 620 is also provided in the device 601 to interface with speakers/microphone 622 thereby providing sounds and/or music.

The general-purpose storage controller 624 connects the storage medium disk 604 with communication bus 626, which may be an ISA, EISA, VESA, PCI, or similar, for interconnecting all of the components of the device 601. A description of the general features and functionality of the display 610, keyboard and/or mouse 614, as well as the display controller 608, storage controller 624, network controller 606, sound controller 620, and general purpose I/O interface 612 is omitted herein for brevity as these features are known.

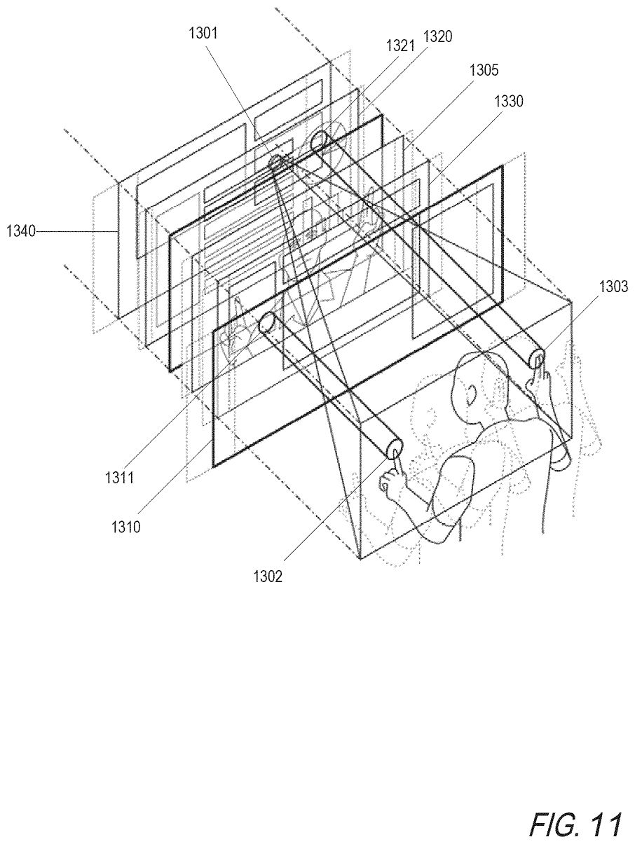

As shown in FIG. 11, in some embodiments, one or more of the disclosed functions and capabilities may be used to enable a volumetric composite of content-activated layers of transparent computing, content-agnostic layers of transparent computing and/or camera- or other sensor-captured layers of transparent computing placed visibly behind 2-dimensional or 3-dimensional content displayed on screens, placed in front of 2-dimensional or 3-dimensional content displayed on screens, placed inside of 3-dimensional content displayed on screens and/or placed virtually outside of the display of screens. Users can interact via touchless computing with any layer in a volumetric composite of layers of transparent computing wherein a user's gaze, gestures, movements, position, orientation, or other characteristics observed by an image capturing device are used as the basis for selecting and interacting with objects in any layer in the volumetric composite of layers of transparent computing to execute processes on computing devices. In some embodiments of the disclosure, machines can replace users in interacting with one or more layers of a volumetric composite of layers of transparent computing where a sensed movement is used as the basis for selecting and interacting with objects in any layer.

An example of a machine, without limitation, may be a robotic arm that replaces the human hands, another possibility is an interactive peripheral, such as a digital camera, coupled to or incorporated in the device (e.g., first device 701) with the display screen. In the case of the latter, the digital camera may point to and capture images of a scene of the environment surrounding the back of the display (opposite direction to which the user is shown pointing in FIG. 11) and the interaction with the layers of transparent computing may be based on the captured images/scene. In an example, the camera may capture images of a part of a room initially without an individual located in the captured part of the room. Next, an individual may walk into the line of sight of the camera in the relevant part of the room and based on detecting the individual, one of more of the layers of the display may display a blurred screen to prevent the individual from viewing the displayed content.

In some embodiments, one or more image capturing or sensor devices, such as an image capturing device 1301 can be used to capture image or video data of a user (or machine) interacting with the volumetric composite. The image capturing device 1301 can be integrated into or connected to a device displaying the layers of the volumetric composite. Sensor devices can include, but are not limited to, LiDAR devices, radar devices, or sensors operating outside of the visible light spectrum (e.g., infrared sensors). In some embodiments, the volumetric composite can include a camera-captured layer 1305, wherein the camera-captured layer 1305 can include the image or video data of the user captured by the image capturing device 1301. In the illustrative example of FIG. 11, the camera-captured layer 1305 can be placed visibly behind a first layer 1310 and in front of a second layer 1320. The first layer 1310 can be a content-activated layer or a content-agnostic layer. The second layer 1320 can be a content-activated layer or a content-agnostic layer. In some embodiments, the camera-captured layer 1305 can be partially transparent. In some embodiments, the first layer 1310 can be partially transparent to enable the visibility of the camera-captured layer 1305 and the second layer 1320 behind the first layer 1310. In some embodiments, the image or video data captured by the image capturing device 1301 and displayed in the camera-captured layer 1305 can be used to interact with content on the first layer 1310 and/or the second layer 1320. For example, the first layer 1310 and the second layer 1320 can include 2-dimensional or 3-dimensional content. In some embodiments, the 3-dimensional content can include content from more than one layer.

In some embodiments, content in the camera-captured layer 1305 can be used to trigger actions in the first layer 1310 and/or the second layer 1320. In some embodiments, the first layer 1310 and the second layer 1320 can be content-activated layers. As an example, the image capturing device 1301 can capture video data of a user at a first location 1302. In some embodiments, the first location 1302 can be a location in three-dimensional space. In some embodiments, the first location 1302 can be located in a frame of the camera-captured layer 1305. In some embodiments, the action in the video data can be identified via inspection of the frame buffer, as is described in greater detail herein. The action of the user at the first location 1302 can be used to trigger an interaction with the first layer 1310, wherein the interaction with the first layer 1310 can be executed at a target location 1311 in the first layer 1310. In some embodiments, the target location 1311 can be determined based on the first location 1302 of the action. In some embodiments, the target location 1311 can be determined based on the 2-dimensional or 3-dimensional in the first layer 1310.

In some embodiments, the target location 1311 can be determined based on the image or video data captured by the image capturing device 1301, including, but not limited to, a user location, a user gaze, or a user action. In some embodiments, the video data captured by the image capturing device 1301 can include video data of a user at a second location 1303. In some embodiments, the second location 1303 can be a location in three-dimensional space. In some embodiments, the second location 1303 can be located in a frame of the camera-captured layer 1305. The action of the user at the second location 1303 can be used to trigger an interaction with the second layer 1320, wherein the interaction with the second layer 1320 can be executed at a target location 1321 in the second layer 1320. In some embodiments, the interaction with the second layer 1320 can be executed without an effect on the first layer 1310. In some embodiments, the target location 1321 can be based on the second location 1303. For example, the interaction can be a selection of a graphic at the target location 1321 in the second layer 1320.

In some embodiments, the volumetric composite can include additional layers, including, but not limited, to a third layer 1330 and a fourth layer 1340. In some embodiments, the layers in the volumetric composite can be placed in any order. For example, the third layer 1330 can be in between the first layer 1310 and the second layer 1320, while the fourth layer 1340 can be behind the second layer 1320. According to some embodiments, the third layer 1330 and the fourth layer 1340 can be content-agnostic layers. The 2-dimensional or 3-dimensional content in the third layer 1330 and the fourth layer 1340 may not be affected by actions identified in the video data and the camera-captured layer. In some embodiments, the order of the layers can change in the volumetric composite. In some embodiments, the order of the layers may affect the transparency and/or visibility of 2-dimensional or 3-dimensional content in one or more of the layers. In some embodiments, a layer can become a content-activated layer, a content-agnostic layer, or a camera-captured layer. For example, the third layer 1330 can become a content-activated layer and the second layer 1320 can become a content-agnostic layer. The combination of content-activated layers and content-agnostic layers can create an interactive volumetric composite.

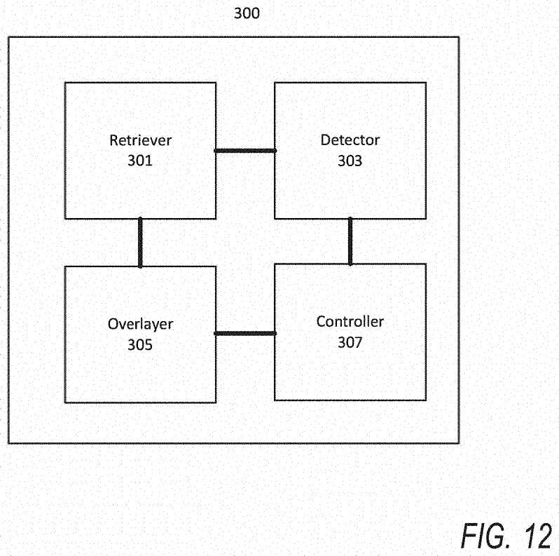

In some embodiments, one or more of the disclosed functions and capabilities may be used to enable users to see a volumetric composite of layers of transparent computing from a 360-degree optical lenticular perspective wherein a user's gaze, gestures, movements, position, orientation, or other characteristics observed by image capturing devices are a basis to calculate, derive and/or predict the 360-degree optical lenticular perspective from which users see the volumetric composite of layers of transparent computing displayed on screens. Further, users can engage with a 3-dimensional virtual environment displayed on screens consisting of layers of transparent computing placed behind the 3-dimensional virtual environment displayed on screens, placed in front of a 3-dimensional virtual environment displayed on screens, and/or placed inside of the a 3-dimensional virtual environment displayed on screens wherein users can select and interact with objects in any layer of transparent computing to execute processes on computing devices while looking at the combination of the 3-dimensional virtual environment and the volumetric composite of layers of transparent computing from any angle of the 360-degree optical lenticular perspective available to users. In some embodiments, the generating and/or overlaying can be achieved through the use of an overlay apparatus comprising processing circuitry configured to create a multi-layer computing experience. This overlay apparatus may be part of a first device 101 or another device 102, 10n as described above. FIG. 12 is a block diagram for an exemplary overlay apparatus 300 that can be utilized for creating a multi-layer computing experience. The overlay apparatus 300 includes processing circuitry that can be configured to perform the functions of the retriever 301, detector 303, overlayer 305, and controller 307.

The retriever 301 retrieves layers from memory. For example, a first layer, represented by a first set of pixels, is retrieved from a first portion of memory, while a second layer, represented by a second set of pixels, is retrieved from a second portion of memory. The first and second layers can be any type of virtual content. For example, the first layer can be a display of a desktop obtained from a video/graphics card, while the second layer can be a live video of a user from a webcam. In some embodiments, the first portion of memory is a first frame buffer, and/or the second portion of memory is a second frame buffer. Of course, more than two layers can be retrieved from more than two portions of memory to create the perception of depth.

The detector 303 detects specific pixels and/or patterns of pixels (i.e., objects) in the first layer and/or second layer. Any detection technique appropriate for detecting a specific object can be used, such as convolutional neural networks. Examples of objects can include text, a play/pause button, volume button, and record button. Though the detector 303 is not always mandatory, it can be useful for turning on click-ability of objects in a layer that otherwise has click-ability turned off (or vice versa), highlighting certain objects, performing snap-to-grid functionalities, etc. The objects to be detected can be automatically detected based on various parameters made known to the detector 303, such as commonly selected objects and/or specific object requests made by a software application. Furthermore, in some embodiments, the detector 303 can also crop detected objects from their frame buffer, create another layer containing those detected objects, and display that additional layer over all the existing layers. The optical effect is that the object seems to have been “cut out” and “lifted” from its original layer. Thereafter, those objects can be altered to rotate, resize, and/or move based on inputs from a user via processing circuitry.

The detector 303 can also function to identify markers, using a computer vision approach, memory vision approach, or a combination thereof. Details of how to identify and utilize such markers are described in U.S. provisional patent applications 63/213,326 and 63/068,878 and U.S. patent application Ser. No. 17/408,065, which are incorporated by reference herein in their entirety.

In some embodiments, a convolutional neural network (CNN) encoder adds a CCN-readable marker into any digital content (documents, video streams, etc.). This marker is associated with a unique identifier. The document including the reference patch with data encoded into a marker thereof is sent to (or screen shared with) a computer vision or memory vision device (e.g., the first device 101) configured to perform the computer vision and/or memory vision techniques discussed in U.S. provisional patent applications 63/213,326 and 63/068,878 and U.S. patent application Ser. No. 17/408,065. The first device continuously scans for markers using the computer vision and/or memory vision techniques. If a marker is detected, the first device decodes the unique identifier from the marker. The first device, which has previously been securely authenticated, sends a secured session token and the unique identifier (obtained from the marker) to a remote, secured SaaS server. The server identifies the first device from the session token and determines if the first device is authorized to retrieve the specific data that the marker's unique identifier refers to. If the first device is authorized to retrieve the augmentation content, it is delivered electronically to the first device. The augmentation content is then added to the first device, where it visually “floats above” the operating system display and is never directly added to the operating system display layer or original digital content.

The overlayer 305 overlays the layers retrieved by the retriever 301 over one another and adjusts pixel characteristics for one or more pixels of one or more layers. Adjusting pixel characteristics include adjusting the transparency (from anywhere between 0% to 100% translucency) of the pixels in each layer to create a semi-translucent effect, though other characteristics can also be adjusted, including but not limited to: brightness, vibrance, contrast, and color. The transparency levels of pixels can vary between different layers and/or within layers. For example, if three layers are being displayed at once, all the pixels in one layer can have no transparency, all the pixels in a second layer can have 50% transparency, and all the pixels in a third layer can have 80% transparency. Adjusting the transparency levels can affect depth perception by making certain layers and/or groups of pixels seem closer or further relative to others.

The controller 307 controls click-ability of pixels in the layers. For example, all the pixels in a layer, or pixels present in a portion the layer, can have their click-ability turned on or off. Having click-ability on refers to being able to interact with a pixel that is clicked, whereas having click-ability off refers to pixels not being affected by a click. In some embodiments, the controller 307 can turn click-ability on or off for specific pixels (e.g., utilizing an operating system executed by the circuitry of apparatus 300) based on parameters such as pixel color, pixel transparency, pixel location, etc.

In some embodiments, pixels in one layer have click-ability on, while pixels in the remaining layers have click-ability off. Further, portions of pixels within layers that have click-ability off can have their click-ability turned on, while the remaining pixels in that layer remain off (and vice versa). The determination of which pixels have click-ability on and off can be determined based on parameters such as user settings, hot spots, application settings, user input, etc. Hot spots can refer to regions of a computer program, executed by circuitry of device 101, where a high percentage of the computer program's instructions occur and/or where the computer program spends a lot of time executing its instructions Examples of hot spots can include play/pause buttons on movies, charts on presentations, specific text in documents, etc.

The overlayer 305 and controller 307 can work in tandem to “move” pixels between layers, where pixels in layers that otherwise look to be in the background can be brought to the forefront (or vice versa). Though the pixels themselves do not physically move, by controlling characteristics such as transparency, size, location, click-ability, color, etc., the end effect is a multi-layered experience, where a user interacting with such a system can view and interact with any pixel across any layer.

Apparatus 300 can operate continuously to account for changes that can occur. For example, adding/removing layers or making selections within a layer can affect the presence of detectable objects, transparency levels of pixels, click-ability of pixels, color of pixels, and so on. Additional details on exemplary method of overlaying display layers and systems for creating a multi-layer computing experience are described in U.S. provisional patent application 63/222,757, which is incorporated by reference herein in its entirety.

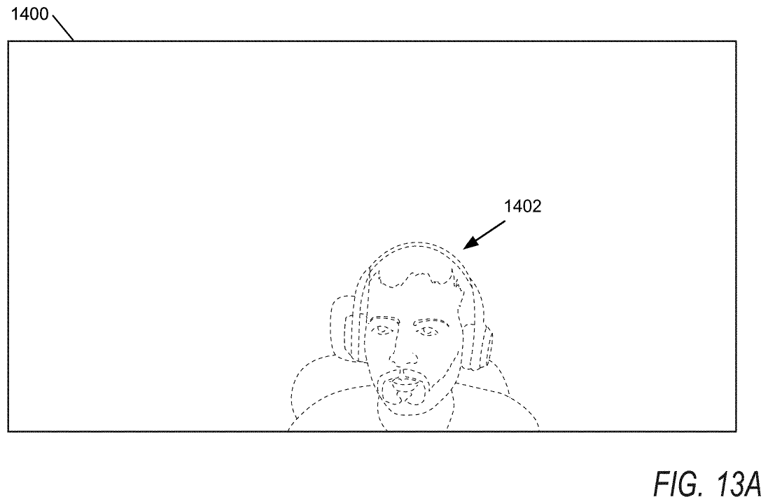

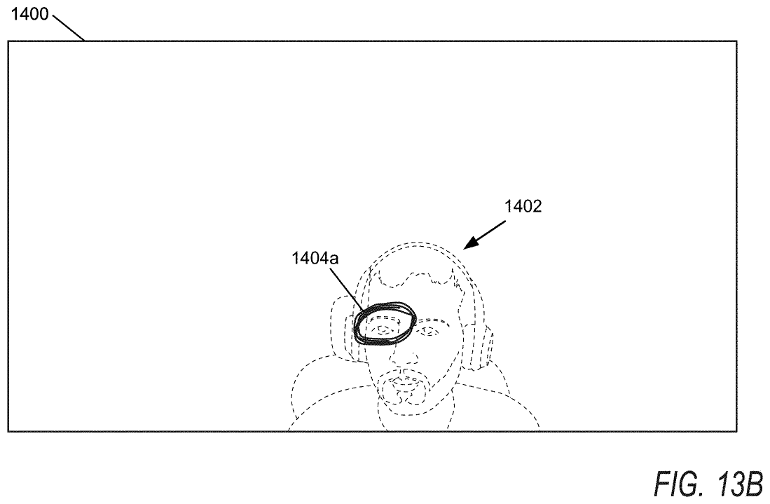

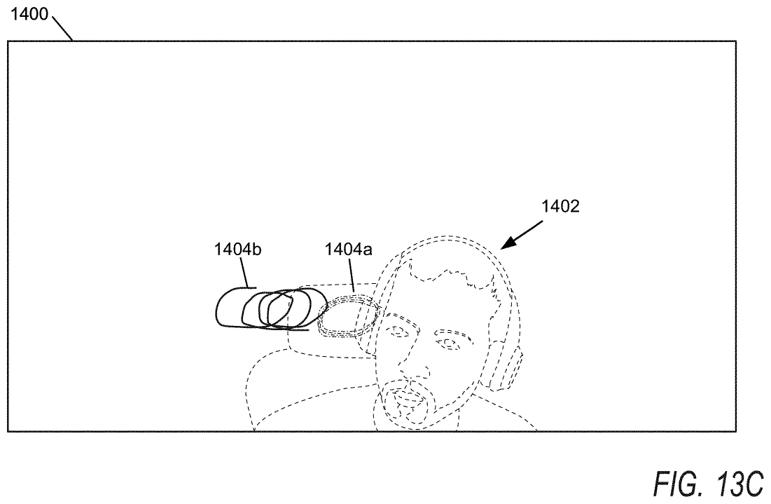

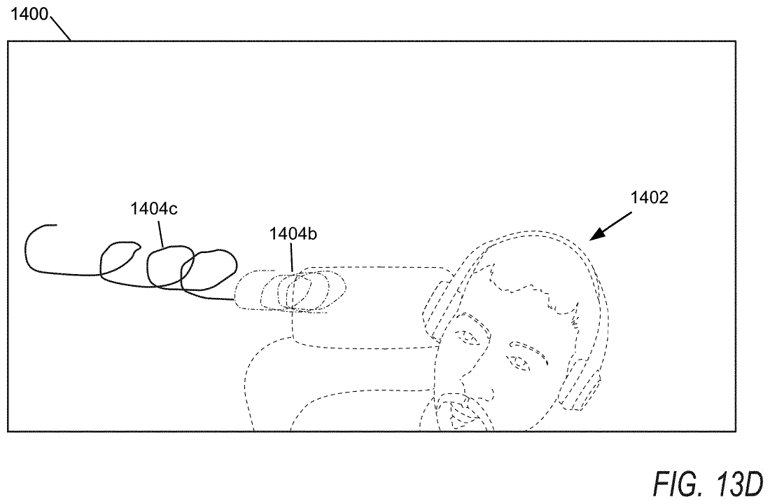

In some embodiments, as discussed above, digital content can be positioned at multiple layers within a virtual environment, and the digital content within a respective layer can shift in response to a shift in a user's perspective. For example, FIGS. 13A-13D illustrate a user 1402 positioned relative to a display 1400 displaying a virtual environment, which can include a document, a virtual meeting, a video game, a portion of a metaverse, a web page, etc. The user 1402 is shown in a first position relative to the screen 1400 in FIGS. 13A and 13B. The display may be a part of or coupled to a user device, such as without limitation, device 701 (FIG. 1).

Referring to FIG. 13B, a digital object 1404a is shown on the screen 1400. In the illustrated embodiment, the digital object 1404a spans multiple layers within the virtual environment, so that portions of the digital object can displace differently relative to other portions of the digital object in response to a shift in the user's perspective. As shown, the digital object 1404a is in a first position, and is generally shaped as an oval.

Referring to FIG. 13C, the user 1402 is shown in a second position relative to the screen 1400. In the second position, as shown, the user's 1402 head is shifted right relative to the position of the user's 1402 head in the first position. In some embodiments, when the user's 1402 perspective shifts, the digital object 1404b shifts in response. As shown, the digital object 1404b can be shifted relative to the original position of the digital object 1404a (e.g., represented by the outline of the first position of the digital object 1404a shown in FIG. 13C). Because portions of the digital objects are located in different layers, the digital object 1404b does not shift uniformly relative to the position of digital object 1404a, but portions of the digital object 1404b are displaced more than other portions of the digital object 1404b relative to their respective original position positions (i.e., relative to corresponding portions of the digital object 1404a). Thus, for example, a cumulative displayed width of the digital object 1404b is greater than a cumulative displayed width of the digital object 1404a in the original position.

Referring to FIG. 13D, the user 1402 is shown in a third position relative to the screen 1400, with the user's 1402 head shifted right and downward relative to the second position of the user's head. The digital object 1404c is shown in a third position, with portions of the digital object 1404c shifted leftward and upward relative to the second position of the digital object 1404b. In some embodiments, a digital object can be at only one layer, and all portions of the digital object can translate uniformly in response to a change of perspective of the user. In some embodiments, as discussed above, a digital object can move in different directions in response to a change in position or orientation of a user. For example, a digital object, or portions of a digital object can shift leftward, upward, or downward when a user's head shifts leftward. In some embodiments, a user can configure a degree of responsiveness of a digital object within a virtual environment.

While this specification contains many specific implementation details, these should not be construed as limitations on the scope of what may be claimed, but rather as descriptions of features that may be specific to particular embodiments.

Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

Thus, the foregoing discussion discloses and describes merely exemplary embodiments of the present disclosure. As will be understood by those skilled in the art, the present disclosure may be embodied in other specific forms without departing from the spirit thereof. Accordingly, the disclosure of the present disclosure is intended to be illustrative, but not limiting of the scope of the disclosure, as well as other claims. The disclosure, including any readily discernible variants of the teachings herein, defines, in part, the scope of the foregoing claim terminology such that no inventive subject matter is dedicated to the public.

In some examples, visual data obtained from one or more detection devices in combination with one or more displays can be leveraged to generate a content viewing experience that is responsive to a physical orientation of a subject. For example, an immersive virtual environment can arrange digital objects within layers and digital objects within the respective layers can move in response to movement or change in orientation of the subject (e.g., as described with respect to FIGS. 7A-7K and 13A-13C). The subject can be a physical object such as, for example, a car, a mobile device, an airplane, a watercraft, a screen, a pen, or any physical object that can be moved relative to a visual detection device. In some embodiments, a subject can be an animal such as a dog, a cat, a monkey, a horse, or any other animal. The connection between a subject and screens are volumetric, three-dimensional, and offer 360 degrees of viewing freedom between the subject and the screen. The system can connect the subject to a display which can include a display of a personal computer, screen of a smart vehicle, television, a screen, a projection, or a mobile device. The perspective displayed at the display can change in response to a change in position or orientation of the subject, as when the subject moves to a side, moves forward, moves backwards, rotates, etc. In some embodiments, the display can be displayed toward the subject. For example, when the subject is an airplane, a pilot of the airplane located within the airplane can view the display providing the projection or immersive experience. In some examples, the display providing the projection that is responsive to movement of the subject can be viewable by a user not in proximity to the subject.

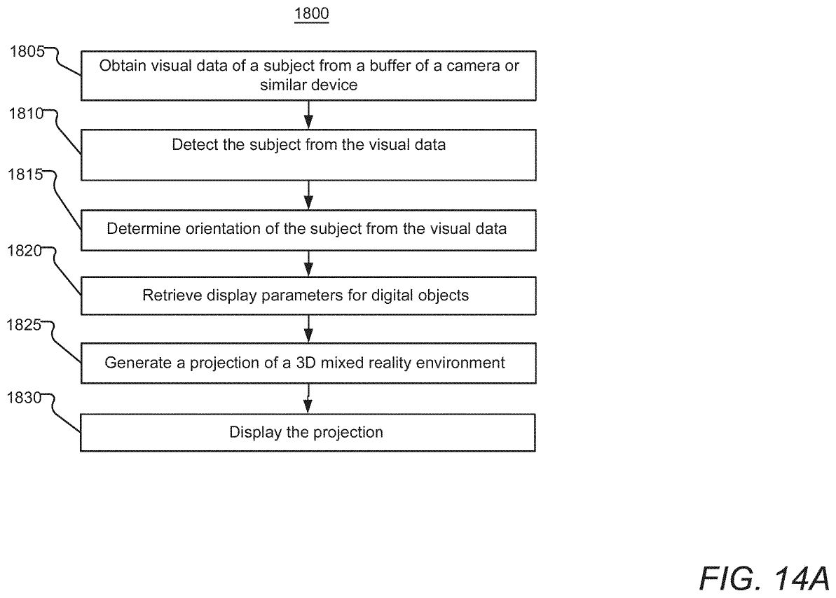

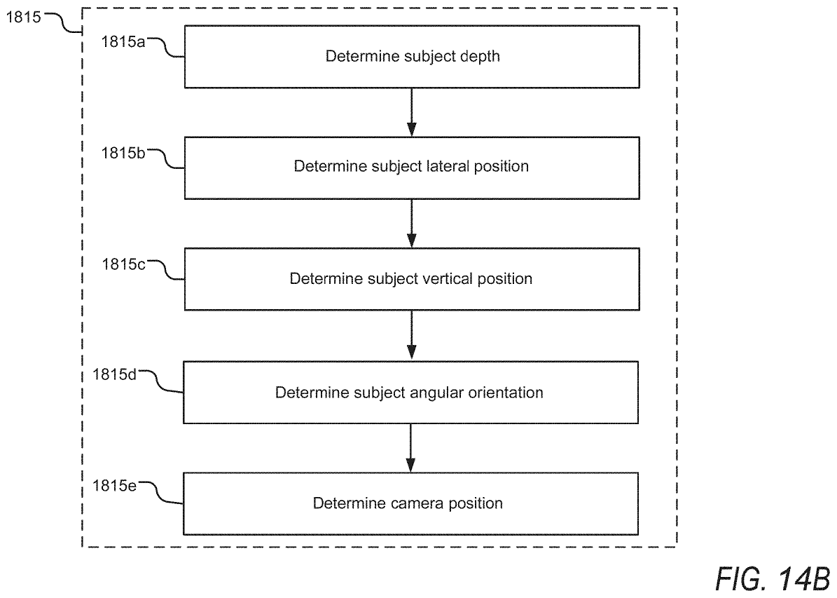

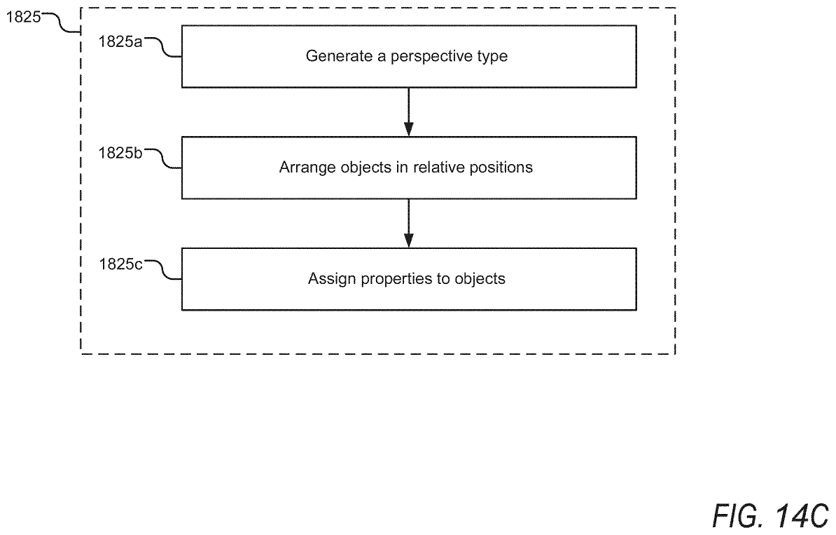

To this end, FIG. 14A is a flow chart outlining a method 1800 of generating a projection of a mixed reality environment with the perception of depth and perspective adjustment, according to an embodiment of the present disclosure. In some embodiments, the device 701 can incorporate virtual content into the projection of the environment and adjust the virtual content based on the position and perspective of a subject for a more immersive experience.

At step 1805, a device can obtain visual data of the subject from an image capturing device (e.g., digital camera) or similar device. For example, the buffer of the image capturing device, or the similar device can be accessed by the device 701 to inspect the visual data therein. It may be appreciated that the device 701 can include more than one image capturing device or similar device that can obtain footage of, for example, the user and the user's background. In some examples, the visual data can be obtained through devices or sensors other than image capturing devices, for example, through LiDAR scanners, motion sensors, or other devices that can collect visual data. In some embodiments, visual data can be derived from devices that can collect data through non-photonic means and could comprise RADAR scanners and the like. As discussed above, the subject can be any detectable physical object or animal. For example, the subject can be a car, and the image capturing device can be a camera located on another car.

At, step 1810, the device can detect the subject from the obtained visual data. In some examples, a developer can use libraries (e.g., a SDK) of a programming language to define a subject to be detected from visual data. A developer can define a subject for a given virtual environment. For example, a library can allow a developer to define a subject as a car, an airplane, a dog, a cat, etc. In some embodiments, machine learning techniques can be used to define a subject and identify the subject in visual data.

At step 1815 (discussed in more detail in FIG. 14B), the device can determine orientation parameters for the subject from the obtained visual data. User parameters can include subject lateral position, subject vertical position, subject depth or distance from the image capturing device, subject angular orientation which may comprise a yaw angle and a pitch angle, or angular orientation of any portion of the subject (e.g., a head orientation of a dog, an orientation of a nose of an airplane, an orientation of a windshield of a car, etc.). In some cases, the subject parameters can be dynamic parameters, and could, for example, include a lateral velocity, lateral acceleration, vertical velocity, vertical acceleration, rate of angular rotation, velocity of a subject's approach to the image capturing device, and the like. Further, subject parameters can be determined using relative values, and an offset of a user's original lateral position, vertical position, or distance from an image capturing device can be measured and provided as a subject parameter.

At step 1820, the device can retrieve display parameters of a digital object to be displayed as part of the virtual content. In some embodiments, the device 701 can detect the digital object (or multiple digital objects) configured to be displayed on the device 701 or receive digital objects to be displayed from another device, such as a second user's device during a teleconference. For example, the reference patch can be detected and the secondary content (including the digital object(s)) corresponding to the reference patch can be displayed as part of the environment. The device 701 can receive the digital object's display parameters from the device 701 or from another source (e.g., a server or another device connected to the device 701, such as the second user's device during the teleconference). In some examples, the subject can include a reference patch that can be used to retrieve digital content. For example, a car logo or license plate can be a reference patch and can cause digital objects associated with the car to be retrieved.

At step 1825 (discussed in more detail in FIG. 14C) the device generates a projection of a 3D mixed reality experience with the perception of depth and parallax compensation (e.g., as described above).

Finally, at step 1830 the device can display the projection. The steps in method 1800 are not limited to a sequential application. Different embodiments can achieve method 1800's results by executing the steps in a different sequence.

FIG. 14B is a flow chart outlining sub-methods of step 1815 for determining orientation parameters of the subject from obtained visual data, according to an embodiment of the present disclosure. Again, the sub-methods for step 1815 are not limited to a sequential application. Different embodiments can achieve sub-method 1815's results by executing the steps in a different sequence.

Still referring to FIG. 14B, the step 1815 can include sub-methods to determine a subject lateral position, subject vertical position, and/or a subject depth or distance from the image capturing device. Again, the buffer of the image capturing device can be accessed by the device 701 and each frame analyzed. In some cases, orientation parameters of the subject can be determined using approximate known dimensions or ratios for features of a subject. For example, when a subject is a car, orientation parameters can be determined from a distance between headlights, or between known physical features of the car. Such a standardized value can be generalized for any subject, including, for example, different makes and models of cars, airplanes, watercraft etc.

In some embodiments, in step 1815a, the subject depth can be determined, which can be based in part on detected feature of the subject, as described above.

In some embodiments, in step 1815b, the same can be used to determine the lateral position of the subject. For example, a point along the subject can be detected and tracked as the subject changes position along a horizontal or x-direction in the captured frame. The point along the subject and relative distances to edges of the captured frame, or the point's horizontal or x-direction coordinates can be used to determine the lateral position of the subject.

In some embodiments, in step 1815c, the point can also be used to determine the vertical position of the subject. For example, the point along the subject can be detected and tracked as the subject changes position along a vertical or y-direction in the captured frame as the subject goes from a sitting to standing posture. Object recognition methods can be used to detect the subject or other objects and the corresponding lateral or vertical position relative to the captured frame or subject environment. It may be appreciated that any markers or features of the subject can be used to make these determinations. Together with the depth determination, the lateral and horizontal position determination can be used to determine the subject's POV relative to the image capturing device of the device 701.

In some embodiments, step 1815d includes determining angular orientation. In some embodiments, a subject yaw angle can be determined using machine learning algorithms. These algorithms can use detected points (usually between 6 and 32 points) to create a 3D model of the subject. Such algorithms can determine the yaw angle and/or a subject pitch angle. As the points move or become obscured with changes in the subject's orientation, the 3D model adjusts. The machine learning algorithm can model the angular orientation of the subject based on the points.

In some embodiments, steps 1805-1830 can be performed by the device 701. For a scenario where there is more than one subject, each subjects' device can perform the steps. Each device (e.g., any or all of devices 702, 70n, 7001) collects the required data, analyzes it, and creates and displays the 3D mixed reality projection based on the subject's positioning. In some embodiments, steps 1805, obtaining the data, and 1830, displaying the projection, can be performed by each device. The data obtained in step 1805 can be sent to a central, server-side device where steps 1810-1825 can be performed, and the created projection can be sent back to the subject's device for display. This embodiment allows for the 3D mixed reality projection to be displayed on devices that lack the processing power to analyze and create the projection.

### Further Examples Having a Variety of Features

The disclosure may be further understood by way of the following examples:

Example 1: An apparatus, comprising: processing circuitry, including a processing unit configured to: collect visual data from a visual detection device, detect, in the visual data, an image of a subject; analyze the image of the subject and obtain orientation data from the analyzed image of the subject; retrieve, based on the visual data, one or more digital objects; generate, based at least in part on the visual data and the orientation data, a projection comprising one or more layers, the one or more digital objects being disposed within the one or more layers; and cause the projection to be displayed.

Example 2: The apparatus according to Example 1, wherein the processing unit is further configured to: detect, in the visual data, a physical object; generate, based on the physical object, a corresponding digital object, the corresponding digital object including visual characteristics corresponding to the visual characteristics of the physical object; assign the corresponding digital object to a first layer of the one or more layers; wherein causing the projection to be displayed includes causing the corresponding object to be displayed within the projection.

Example 3: The apparatus according to Example 1 or 2 wherein obtaining the orientation data includes determining, from the image of the subject, a distance of the subject from the visual detection device.

Example 4: The apparatus according to any of Examples 1-3 wherein obtaining the orientation data includes determining, from the image of the subject, an angular rotation of the subject.

Example 5: The apparatus according to any of Examples 1-4 wherein the processing unit is further configured to: collect additional visual data from the visual detection device; detect, in the additional visual data, a second image of the subject; determine, from the second image, a second angular rotation of the subject; generate a second projection, based at least in part on the second angular rotation; and cause the second projection to be displayed.

Example 6: The apparatus according to any of Examples 1-5, wherein a first digital object of the one or more digital objects is disposed within a first layer of the one or more layers, and wherein the first digital object is visually shifted by a first distance in the second projection relative to the first projection.

Example 7: The apparatus according to any of Examples 1-6, wherein a second digital object of the one or more digital objects is disposed within a second layer of the one or more layers, and wherein the second digital object is visually shifted by a second distance in the second projection relative to the first projection, the second distance being different than the first distance.

Example 8: The apparatus according to any of Examples 1-7, wherein the projection comprises a three-dimensional environment, and wherein each layer of the one or more layers is associated with a corresponding depth of the three-dimensional environment.

Example 9: A method for generating and displaying a mixed reality computing experience with the perception of depth, comprising: collecting visual data from a visual detection device; identifying, within the visual data, a first image of a first subject; determining, from the first image, first orientation data for the first subject; retrieving, based on the visual data, display data of one or more digital objects; generating a projection comprising one or more layers; and causing the projection to be displayed, wherein each of the one or more layers includes visual content, and wherein the visual content of each of the one or more layers is at least partially determined by the visual data, first orientation data, and the display data for the one or more digital objects.

Example 10: The method of Example 9 wherein the projection includes a three-dimensional environment, and wherein the one or more layers include a first layer and a second layer, the first layer being associated with a first depth of the three-dimensional environment and the second layer being associated with a second depth of the three-dimensional environment, the first depth being different than the second depth.

Example 11: The method of Example 9 or 10, further comprising: receiving second visual data; identifying, within the second visualization, a first image of a second subject; and determining, from the first image of the second subject, first orientation data for the second subject, wherein generation of the projection is further based, at least in part, on the first orientation data for the second subject.

Example 12: The method of any of Examples 9-11 wherein a first digital object is displayed within the first layer.

Example 13: The method of any of Examples 9-12, further comprising: receiving a first input, and based on the first input, moving the first digital object from the first layer to the second layer.

Example 14: The method any of Examples 9-13, wherein the first orientation data comprises a first lateral position of the first subject, a first distance of the first subject from the visual detection device, and an angular rotation of the first subject.

Example 15: A non-transitory computer-readable storage medium for storing computer-readable instructions that, when executed by a computer, cause the computer to perform a method for generating and displaying a mixed reality computing experience with the perception of depth, the method comprising: collecting visual data from a visual detection device; identifying, within the visual data, a first image of a subject; determining, from the first image, first orientation data; retrieving, based in part on the visual data, display data of one or more digital objects; generating, based at least in part on the first orientation data, a projection comprising one or more layers, and causing the projection to be displayed, wherein visual content of the one or more layers is at least partially determined by the visual data.

Example 16: The non-transitory computer-readable storage medium of Example 15, wherein the first orientation data is a first lateral position of the subject.

Example 17: The non-transitory computer-readable storage medium of Example 15 or 16, the method further comprising collecting additional visual data from the visual detection device; detecting, in the additional visual data, a second image of the subject; determining, from the second image, a second lateral position of the subject; generating a second projection, based at least in part on the second lateral position of the subject; and causing the second projection to be displayed.

Example 18: The non-transitory computer-readable storage medium of any of Examples 15-17 wherein a first digital object within a first layer of the one or more layers is displayed in a first position in the projection, and a second position in the second projection.

Example 19: The non-transitory computer-readable storage medium of any of Examples 15-18 wherein a second digital object within a second layer of the one or more layers is displayed in a third position in the projection, and a fourth position in the second projection, wherein a distance between the third and fourth position is different than a distance between the first and second position.

Example 20: The non-transitory computer-readable storage medium of any of Examples 15-19, the method further comprising: identifying, within the visual data, a visual pattern; receiving first digital content associated with the visual pattern; associating the digital content with a layer of the one or more layers; causing the digital content to be displayed within the projection.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

1. An apparatus, comprising:
processing circuitry, including a processing unit configured to:
collect visual data from a visual detection device,
detect, in the visual data, a first image of a subject,
analyze the first image of the subject and obtain orientation data from the first image of the subject,
retrieve, based on the visual data, one or more digital objects,
generate, based at least in part on the visual data and the orientation data, a first projection comprising one or more layers, the one or more digital objects being disposed within the one or more layers, and
cause the first projection to be displayed,
wherein obtaining the orientation data includes determining, from the first image of the subject, an angular rotation of the subject,
wherein the processing unit is further configured to:
collect additional visual data from the visual detection device;
detect, in the additional visual data, a second image of the subject;
determine, from the second image, a second angular rotation of the subject;
generate a second projection, based at least in part on the second angular rotation; and
cause the second projection to be displayed,
wherein a first digital object of the one or more digital objects is disposed within a first layer of the one or more layers,
wherein the first digital object is visually shifted by a first distance in the second projection relative to the first projection,
wherein a second digital object of the one or more digital objects is disposed within a second layer of the one or more layers, and wherein the second digital object is visually shifted by a second distance in the second projection relative to the first projection, the second distance being different than the first distance.

2. The apparatus of claim 1, wherein the processing unit is further configured to:
detect, in the visual data, a physical object;
generate, based on the physical object, a corresponding digital object, the corresponding digital object including visual characteristics corresponding to the visual characteristics of the physical object;
assign the corresponding digital object to a first layer of the one or more layers;
wherein causing the first projection to be displayed includes causing the corresponding digital object to be displayed within the first projection.

3. The apparatus of claim 1, wherein obtaining the orientation data includes determining, from the first image of the subject, a distance of the subject from the visual detection device.

4. (canceled)

5. (canceled)

6. (canceled)

7. (canceled)

8. The apparatus of claim 1, wherein the first projection comprises a three-dimensional environment, and wherein each layer of the one or more layers is associated with a corresponding depth of the three-dimensional environment.

9. A method for generating and displaying a mixed reality computing experience with a perception of depth, comprising:
collecting visual data from a visual detection device;
identifying, within the visual data, a first image of a first subject;
determining, from the first image, first orientation data for the first subject, wherein the first orientation data is a first lateral position of the first subject;
retrieving, based on the visual data, display data of one or more digital objects;
generating, based at least in part on the first orientation data, a first projection comprising one or more layers; and
causing the first projection to be displayed,
collecting additional visual data from the visual detection device;
detecting, in the additional visual data, a second image of the subject;
determining, from the second image, a second lateral position of the subject;
generating a second projection, based at least in part on the second lateral position of the subject; and
causing the second projection to be displayed,
wherein visual content of the one or more layers is at least partially determined by the visual data,
wherein a first digital object within a first layer of the one or more layers is displayed in a first position in the first projection, and a second position in the second projection, and
wherein a second digital object within a second layer of the one or more layers is displayed in a third position in the first projection, and a fourth position in the second projection, wherein a distance between the third position in the first projection and the fourth position in the second projection is different than a distance between the first position in the first projection and the second position in the second projection.

10. The method of claim 9, wherein the projection includes a three-dimensional environment, and wherein the one or more layers includes a first layer and a second layer, the first layer being associated with a first depth of the three-dimensional environment and the second layer being associated with a second depth of the three-dimensional environment, the first depth being different than the second depth.

11. The method of claim 9, further comprising:
receiving second visual data;
identifying, within the second visual data, a second image of a second subject; and
determining, from the second image of the second subject, second orientation data for the second subject,
wherein generation of the projection is further based, at least in part, on the second orientation data for the second subject.

12. The method of claim 10, wherein a first digital object is displayed within the first layer.

13. The method of claim 12, further comprising:
receiving a first input, and based on the first input, moving the first digital object from the first layer to the second layer.

14. The method of claim 13, wherein the first orientation data comprises a first lateral position of the first subject, a first distance of the first subject from the visual detection device, and an angular rotation of the first subject.

15. A non-transitory computer-readable storage medium for storing computer-readable instructions that, when executed by a computer, cause the computer to perform a method for generating and displaying a mixed reality computing experience with the perception of depth, the method comprising:
collecting visual data from a visual detection device;
identifying, within the visual data, a first image of a subject;
determining, from the first image, first orientation data, wherein the first orientation data is a first lateral position of the first subject;
retrieving, based in part on the visual data, display data of one or more digital objects;
generating, based at least in part on the first orientation data, a first projection comprising one or more layers,
causing the first projection to be displayed;
collecting additional visual data from the visual detection device;
detecting, in the additional visual data, a second image of the subject;
determining, from the second image, a second lateral position of the subject;
generating a second projection, based at least in part on the second lateral position of the subject; and
causing the second projection to be displayed,
wherein visual content of the one or more layers is at least partially determined by the visual data,
wherein a first digital object within a first layer of the one or more layers is displayed in a first position in the first projection, and a second position in the second projection, and
wherein a second digital object within a second layer of the one or more layers is displayed in a third position in the first projection, and a fourth position in the second projection, wherein a distance between the third position in the first projection and the fourth position in the second projection is different than a distance between the first position in the first projection and the second position in the second projection.

16. (canceled)

17. (canceled)

18. (canceled)

19. (canceled)

20. The non-transitory computer-readable storage medium of claim 15, the method further comprising:
identifying, within the visual data, a visual pattern;
receiving first digital content associated with the visual pattern;
associating the first digital content with a layer of the one or more layers; and
causing the first digital content to be displayed within the first projection.
